(19) United States
(12) Patent Application Publication
(10) Pub. No.: US 2025/0313254 A1
(43) Pub. Date: Oct. 9, 2025

(54) LIMITING DEVICE, CANOPY MOUNTING STRUCTURE, AND CHILD CARRIER

(71) Applicant: WONDERLAND SWITZERLAND AG, Steinhausen (CH)

(72) Inventor: Tao YANG, Dongguan (CN)

(21) Appl. No.: 18/864,665

(22) PCT Filed: May 11, 2023
(86) PCT No.: PCT/EP2023/062630

§ 371 Date: Nov. 11, 2024

(30) Foreign Application Priority Data
May 11, 2022 (CN) 202210536960.4
Jul. 4, 2022 (CN) 202210786117.1
Sep. 30, 2022 (CN) 202211216650.0
Oct. 13, 2022 (CN) 202211253970.3

(51) Int. Cl. B62B 7/08; B62B 9/14

(52) U.S. Cl. CPC B62B 7/08; B62B 9/14

(57) ABSTRACT

A child carrier including a limiting device and a canopy mounting structure is disclosed. The limiting device is configured to operably limit an angle of rotation of a first object relative to a second object. The limiting device includes: a housing arranged between the first object and the second object including at least one limiting groove; and a limiting member arranged between the first object and the second object and capable of moving, through the limiting groove, between a limit position and a non-limit position relative to the housing. The limiting member can, when being at the limit position, prevent the first object from rotating relative to the second object in a first rotation direction, and allow the first object to rotate relative to the second object in a second rotation direction opposite to the first rotation direction.

### CROSS-REFERENCES TO RELATED APPLICATIONS

This application is the national phase under 35 U.S.C. § 371 of PCT International Application No. PCT/EP2023/062630, which has an international filing date of May 11, 2023 and claims priority of Chinese patent application No. 202210536960.4 filed May 11, 2022, Chinese patent application No. 202210786117.1 filed Jul. 4, 2022, Chinese patent application No. 202211216650.0 filed Sep. 30, 2022, and Chinese patent application No. 202211253970.3 filed Oct. 13, 2022. The contents of the above identified PCT international application and Chinese patent applications are hereby incorporated in their entireties by reference for all purposes.

### TECHNICAL FIELD

The present disclosure relates to the field of child carrier technologies, and in particular, to a limiting device, a canopy mounting structure, and a child carrier.

### BACKGROUND

A child carrier generally includes a handle frame, a back frame, a seat, and wheels. In some existing child carriers, the back frame is provided so as to be angularly adjustable with respect to the seat. That is, the back frame can be adjusted with respect to the seat to lean forward and back. However, excessive forward leaning of the back frame may pose a safety hazard, which may cause the child to fall off from the baby carrier.

### SUMMARY

A first aspect of the present disclosure provides a limiting device for operably limiting an angle of rotation of a first object relative to a second object. The limiting device includes: a housing arranged between the first object and the second object and including at least one limiting groove; and a limiting member arranged between the first object and the second object and capable of moving, through the at least one limiting groove, between a limit position and a non-limit position relative to the housing. When the limiting member is at the limit position, the limiting member is capable of preventing the first object from rotating relative to the second object in a first rotation direction, and allowing the first object to rotate relative to the second object in a second rotation direction opposite to the first rotation direction.

In the first aspect of the present disclosure, an actuating device is further arranged between the first object and the second object, and the limiting device further includes a first reset member configured to bias the limiting member toward the limit position. The limiting member is drivably connected to the actuating device, and the actuating device is operable to actuate the limiting member to the non-limit position.

In the first aspect of the present disclosure, the limiting device further includes a first traction member having an end connected to the limiting member and another end connected to the actuating device. The actuating device is operable to actuate the limiting member to the non-limit position through the first traction member.

In the first aspect of the present disclosure, the limiting device further includes: an engaging pin arranged on the first object, the engaging pin being pivotable with the first object and lockable in the at least one limiting groove. The limiting member is arranged on a side of the at least one limiting groove, and the limiting member, when being at the limit position, is capable of preventing disengagement of the engaging pin from the at least one limiting groove.

In the first aspect of the present disclosure, the housing is mounted to the second object and is pivotally connected to the first object. On a side surface of the housing adjacent to the first object, a plurality of limiting grooves are continuously provided around a pivot axis of the first object along a pivot direction thereof. The engaging pin has an end inserted into the plurality of limiting grooves from the side surface of the housing and another end inserted into the first object. The engaging pin is movable between a low position where the engaging pin is locked in one of the plurality of limiting grooves and a high position where the engaging pin is positioned beyond the one of the plurality of limiting grooves relative to the housing.

In the first aspect of the present disclosure, each of the plurality of limiting grooves has an arc-shaped wall, and the arc-shaped walls of the plurality of limiting grooves are connected. Each of the arc-shaped walls has a rearward surface with a concave arc surface on a side away from the limiting member, and a forward surface with an inclined surface or a convex arc surface on another side facing the limiting member.

In the first aspect of the present disclosure, the engaging pin extends parallel to the pivot axis.

In the first aspect of the present disclosure, the first object is in a shape of a hollow tube and has an elongated groove facing the limiting device, and includes: a slider arranged in the first object, the engaging pin being inserted in the slider and being drivable by the slider to move between the low position and the high position; a second traction member having an end connected to the slider and another end connected to a back frame operating member arranged on the first object, the back frame operating member being operable to drive, through the second traction member and the slider, the engaging pin to move to the high position; and a second reset member arranged in the first object and biasing the slider to drive the engaging pin to the low position.

In the first aspect of the present disclosure, the housing includes: a first housing fastened to the first object and provided with the at least one limiting groove; and a second housing fastened to the second object and arranged opposite to the first housing along a rotation axis, the first housing being rotatable around the rotation axis relative to the second housing. The limiting member is arranged in the second housing.

In the first aspect of the present disclosure, an actuating device is further arranged between the first object and the second object, and the limiting device further includes: a driving member joined to the limiting member and capable of driving the limiting member to the limit position or the non-limit position; and a first reset member biasing the driving member to actuate the limiting member to the limit position. The limiting member is drivably connected to the driving member, and the actuating device is operable to actuate the limiting member to the non-limit position through the driving member.

In the first aspect of the present disclosure, the limiting device further includes: a first traction member, the actuating device being connected to the driving member through the first traction member.

In the first aspect of the present disclosure, the driving member includes a driving groove. The limiting device further includes a driving pin fastened to the limiting member and slidably inserted into the driving groove, and the limiting member is movable between the limit position and the non-limit position through the sliding of the driving pin.

In the first aspect of the present disclosure, the limiting groove is formed radially inward from a circumferential side wall of the first housing and has a radially outward opening.

In the first aspect of the present disclosure, the limiting member includes: a first limiting member end facing the first housing and having a limiting head forward surface inclined rearward relative to the first rotation direction; and a second limiting member end opposite to the first limiting member end and away from the first housing.

In the first aspect of the present disclosure, the limiting device further includes: a locking member arranged between the first housing and the second housing and movable between a lock position and an unlock position. The locking member prevents relative rotation between the first housing and the second housing when the locking member is at the lock position, and the locking member allows relative rotation between the first housing and the second housing when the locking member is at the unlock position.

In the first aspect of the present disclosure, the first housing includes a sliding groove formed on an inner side of the first housing and extending radially, and the locking member is located in the sliding groove and rotates around rotation axis together with the first housing.

In the first aspect of the present disclosure, the first housing includes: a first shaft hole penetrating the first housing along the rotation axis; and a first shaft hole wall rising from an axial direction of the first housing to form a columnar wall. The locking member includes: an elongated hole arranged in the locking member, the elongated hole sleeving the first shaft hole wall. The limiting device further includes: a locking reset member arranged in the elongated hole, two ends of the locking reset member respectively abutting against the first shaft hole wall and an end of the elongated hole to bias the locking member toward the lock position.

In the first aspect of the present disclosure, the second housing includes: a second disc portion; a second shaft hole arranged in the second disc portion; at least one first locking groove arranged on an inner side of a periphery of the second disc portion; and at least one second locking groove located between the periphery of the second disc portion and the second shaft hole. The locking member includes: a first locking portion located at a first end of the locking member; and a second locking portion located at a second end of the locking member, positions of the first end and the second end being different. When the locking member is at the lock position, the first locking portion and the second locking portion are respectively engaged with the first locking groove and the second locking groove.

In the first aspect of the present disclosure, the first end and the second end are arranged opposite to each other.

In the first aspect of the present disclosure, a plurality of first locking grooves are arranged circumferentially. A plurality of second locking grooves are arranged circumferentially. Positions of the first locking groove and the second locking groove are arranged such that, when the first object is at a first rotation position and when the first object is at at least one second rotation position in the second rotation direction relative to the first rotation position, the first locking portion and the second locking portion are capable of being respectively engaged with the first locking groove and the second locking groove that are different.

In the first aspect of the present disclosure, the first locking portion includes at least one first locking tooth. The second locking portion includes at least one second locking tooth. When the locking member is at the lock position, the first locking tooth is inserted into the at least one first locking groove, and the second locking tooth is inserted into the at least one second locking groove.

In the first aspect of the present disclosure, the first locking tooth and the second locking tooth are respectively formed as ratchet teeth and respectively have a first forward surface and a second forward surface inclined rearward along the first rotation direction.

In the first aspect of the present disclosure, the first locking groove is arranged on the inner side of the periphery of the second disc portion, and the second locking groove is located between the periphery of the second disc portion and the second shaft hole and is substantially radially opposite to the first locking groove.

In the first aspect of the present disclosure, the first housing further includes: a first disc portion formed in a shape of a disc with an axial end closed; and a first rod portion extending from a periphery of the first disc portion and connected to the first object. The second housing includes: a second disc portion formed in a shape of a disc with an axial end closed; and a second rod portion extending from a periphery of the second disc portion and connected to the second object. The first disc portion and the second disc portion are rotatably fastened to each other around the rotation axis to form a cylindrical box-shaped structure with two closed axial ends.

In the first aspect of the present disclosure, the first housing is provided with the limiting groove, and when the first object is at a first rotation position relative to the second object, the limiting groove is aligned with the limiting member, so as to allow the limiting member to extend into the limiting groove to enter the limit position and then be engaged with the first housing.

In the first aspect of the present disclosure, when the first object is not at the first rotation position relative to the second object, the limiting groove is not aligned with the limiting member, so as not to allow the limiting member to extend into the limiting groove to enter the limit position.

In the first aspect of the present disclosure, when the first object is not at the first rotation position relative to the second object, the limiting member abuts against a periphery of the first housing.

In the first aspect of the present disclosure, the limiting member moves linearly along a first sliding direction perpendicular to the rotation axis, and the driving member moves in the second object along a second sliding direction, the second sliding direction being perpendicular to the rotation axis and forming an angle with the first sliding direction.

In the first aspect of the present disclosure, the driving groove is arranged at an end of the driving member close to the limiting member and extends perpendicular to the second sliding direction, and the driving pin extends parallel to the rotation axis.

A second aspect of the present disclosure provides a child carrier. The child carrier includes: a vehicle frame; a seat frame arranged on the vehicle frame; a back frame joined to a rear end of the seat frame; and the limiting device according to the first aspect of the present disclosure. The limiting device is joined between the seat frame and the back frame. The first object is the back frame, and the second object is the seat frame.

In the second aspect of the present disclosure, the back frame is pivotally connected to the seat frame and is pivotable between a first position away from the seat frame and a second position toward the seat frame around a back frame pivot axis relative to the seat frame, and the limiting member limits excessive forward leaning of the back frame toward the second position.

In the second aspect of the present disclosure, the first rotation direction is a forward leaning rotation direction of the back frame, the second rotation direction is a rearward leaning rotation direction of the back frame, and the first rotation position is a maximum forward leaning position of the back frame in a use state.

In the second aspect of the present disclosure, the vehicle frame further includes a seat tube, and the seat frame is arranged on the seat tube in such a way that the seat frame is slidable back and forth.

In the second aspect of the present disclosure, the vehicle frame further includes: an armrest frame arranged on two outer sides of the back frame; and a handle frame located on an outer side of the armrest frame, pivotally connected to the armrest frame, and pivotable relative to the seat frame around a handle pivot axis substantially parallel to the back frame pivot axis. The child carrier further includes: a first sliding sleeve sleeving a lower end of the handle frame and close to the handle pivot axis; and a handle frame operating member operatively connected to the first sliding sleeve and operable to pull the first sliding sleeve to slide away from the handle pivot axis, thereby driving the limiting member to move to the limit position.

In the second aspect of the present disclosure, a linkage member is arranged on a side of the armrest frame facing the handle frame, the linkage member being slidable on the armrest frame, the first sliding sleeve is joined to the linkage member, and the sliding of the first sliding sleeve away from the handle pivot axis is capable of driving the linkage member to slide, thereby bringing the limiting member to the non-limit position.

In the second aspect of the present disclosure, the first sliding sleeve includes a first sliding sleeve protrusion extending toward the armrest frame, and the linkage member includes a linkage member protrusion extending toward the handle frame, the first sliding sleeve protrusion abutting against the linkage member protrusion.

In the second aspect of the present disclosure, the armrest frame further includes: a connector fastened to the linkage member and inserted into the armrest frame. The linkage member protrusion extends from the connector toward the handle frame, and a fourth reset member is arranged between the connector and the armrest frame, so that the linkage member protrusion always keeps abutting against the first sliding sleeve protrusion.

In the second aspect of the present disclosure, the vehicle frame further includes a seat tube, and the seat frame is arranged on the seat tube in such a way that the seat frame is slidable back and forth. The limiting device is fastened to the seat frame so as to longitudinally slide on the seat tube together with the seat frame.

In the second aspect of the present disclosure, the handle frame further includes: a third traction member arranged inside the handle frame and having two ends respectively connected to the first sliding sleeve and the handle frame operating member. The handle frame operating member is arranged outside the handle frame, and the handle frame operating member is operable to drive, through the third traction member, the first sliding sleeve to move along the handle frame.

In the second aspect of the present disclosure, the armrest frame is joined to a side of the seat frame and is pivotable between an unfold position and a collapse position relative to the seat frame, and two ends of the first traction member are respectively connected to the limiting member and the armrest frame.

In the second aspect of the present disclosure, the child carrier further includes: a connecting seat arranged at an end portion of the seat frame close to the back frame. The connecting seat includes: a connecting seat body; a traction member groove arranged on a side of the connecting seat body facing away from the seat frame, the first traction member passing through the traction member groove and connected to the armrest frame; and a traction member sleeve accommodating portion arranged at an end of the traction member groove, a width of the traction member sleeve accommodating portion being greater than that of the traction member groove.

In the second aspect of the present disclosure, the first traction member includes a cable sleeve and a cable slidably threaded in the cable sleeve. Two ends of the cable are respectively connected to the limiting member and the armrest frame through the connecting seat, and two ends of the cable sleeve are respectively connected to the housing and the connecting seat. The armrest frame, when pivoting from the unfold position to the collapse position, drives the limiting member to the non-limit position through the first traction member.

In the second aspect of the present disclosure, the child carrier further includes: a limiting block fastened to the vehicle frame. The seat frame is arranged on the vehicle frame and movable relative to the limiting block, the back frame is pivotally connected to the seat frame, and the back frame has a movable end located between the seat frame and the limiting block, so that the movable end is limited and fixed when the vehicle frame is in an unfolded state.

In the second aspect of the present disclosure, the child carrier further includes: a limiting block fastened to the vehicle frame. The back frame is pivotably mounted on the vehicle frame, the back frame has a movable end, and the limiting block is arranged adjacent to the movable end, so as to push against the movable end when the vehicle frame switches from an unfolded state to a folded state and assist the back frame to pivot relative to the vehicle frame and be collapsed.

In the second aspect of the present disclosure, the child carrier further includes: a canopy, including a main canopy frame; and a canopy mounting structure configured to mount the canopy on the vehicle frame or the back frame. The canopy mounting structure includes: a mounting seat arranged on the vehicle frame or the back frame; and a connecting seat arranged on the main canopy frame. The connecting seat is detachably connected to the mounting seat by magnetic attachment.

A third aspect of the present disclosure provides a child carrier. The child carrier includes: a vehicle frame; a limiting block fastened to the vehicle frame; a seat frame arranged on the vehicle frame and movable relative to the limiting block; and a back frame pivotally connected to the seat frame and having a movable end. The movable end is located between the seat frame and the limiting block, so that the movable end is limited and fixed when the vehicle frame is in an unfolded state.

In the third aspect of the present disclosure, the seat frame has a clamping portion, two sides of the movable end respectively abut against the limiting block and the clamping portion when the vehicle frame is in the unfolded state, and during switching of the vehicle frame from the unfolded state to a folded state, the movable end is separated from the clamping portion, and the limiting block pushes against the movable end to pivot relative to the seat frame.

In the third aspect of the present disclosure, the vehicle frame includes a seat tube, the limiting block is fastened to the seat tube, and the seat frame is slidably arranged on the seat tube.

In the third aspect of the present disclosure, the limiting block has a bulge extending toward the movable end, and during switching of the vehicle frame from the unfolded state to a folded state, the bulge pushes against the movable end to drive the back frame to pivot.

In the third aspect of the present disclosure, when the vehicle frame is in a folded state, the seat frame is separated from the movable end, and the limiting block abuts against the movable end to limit rotation of the back frame.

In the third aspect of the present disclosure, the limiting block has a first end face and a second end face, a side of the first end face and a side of the second end face meet to form a bulge, the first end face abuts against the movable end when the vehicle frame is in the unfolded state, and the second end face abuts against the movable end when the vehicle frame is in a folded state.

In the third aspect of the present disclosure, the vehicle frame includes a seat tube, and the child carrier further includes a tie-down member. Two ends of the tie-down member are respectively connected to the back frame and the vehicle frame, so that the tie-down member is capable of limiting pivoting of the back frame in a direction close to the seat tube when the vehicle frame is in the unfolded state.

In the third aspect of the present disclosure, the tie-down member is a webbing.

In the third aspect of the present disclosure, the vehicle frame further includes a seat tube and a handle frame. The handle frame is pivotally connected to the seat tube, and the handle frame is operable to drive overall folding of the vehicle frame.

In the third aspect of the present disclosure, the child carrier further includes a linkage assembly, and the vehicle frame includes a handle frame. The linkage assembly is connected between the handle frame and the seat frame to drive the seat frame to slide relative to the limiting block when the handle frame rotates.

In the third aspect of the present disclosure, the child carrier further includes a linkage assembly, the vehicle frame includes a seat tube and a handle frame, the limiting block is fastened to the seat tube, and the seat frame is movably arranged on the seat tube, rotation of the handle frame in a direction close to the seat tube being capable of driving, through the linkage assembly, the seat frame to move in a direction away from the limiting block along the seat tube.

In the third aspect of the present disclosure, the child carrier further includes a linkage assembly. The linkage assembly includes a first connecting rod and a second connecting rod. An end of the first connecting rod is connected to the vehicle frame and rotatable with rotation of the handle frame, another end of the first connecting rod is pivotally connected to an end of the second connecting rod, and another end of the second connecting rod away from the first connecting rod is pivotally connected to the seat frame.

In the third aspect of the present disclosure, the linkage assembly further includes a pivot pin, the handle frame is connected to an end of the pivot pin, and an end of the first connecting rod is fixedly connected to the pivot pin.

In the third aspect of the present disclosure, the child carrier further includes a locking mechanism. The vehicle frame further includes a handle frame, an auxiliary frame, a linkage frame, and a rear leg support frame, the auxiliary frame being fixedly connected to the handle frame. The linkage frame has an end pivotally connected to the rear leg support frame and another end pivotally connected to the auxiliary frame. The locking mechanism is arranged between the auxiliary frame and the linkage frame, the linkage frame is rotatable relative to the auxiliary frame when the locking mechanism is in an unlocked state, and the linkage frame is fixed relative to the auxiliary frame when the locking mechanism is in a locked state.

In the third aspect of the present disclosure, the child carrier further includes a linkage assembly and a pivot pin. The linkage assembly includes a first connecting rod and a second connecting rod. An end of the first connecting rod is connected to the vehicle frame and rotatable with rotation of the handle frame, another end of the first connecting rod is pivotally connected to an end of the second connecting rod, and another end of the second connecting rod away from the first connecting rod is pivotally connected to the seat frame. Both the auxiliary frame and the linkage frame are pivotally connected to the vehicle frame through the pivot pin, and an end of the first connecting rod is fixedly connected to the pivot pin.

A fourth aspect of the present disclosure provides a child carrier. The child carrier includes: a vehicle frame; a limiting block fastened to the vehicle frame; and a back frame pivotally mounted on the vehicle frame and having a movable end. The limiting block is arranged adjacent to the movable end, so as to push against the movable end during switching of the vehicle frame from an unfolded state to a folded state and assist the back frame to pivot relative to the vehicle frame and be collapsed.

In the fourth aspect of the present disclosure, the child carrier further includes a seat frame arranged on the vehicle frame and movable relative to the limiting block. The seat frame is movable relative to the limiting block, and the movable end is held between the limiting block and the seat frame when the vehicle frame is in the unfolded state.

In the fourth aspect of the present disclosure, the child carrier further includes a seat frame arranged on the vehicle frame and movable relative to the limiting block. The seat frame is movable relative to the limiting block, the back frame being pivotally connected to the seat frame, and during the switching of the vehicle frame from the unfolded state to the folded state, the movable end is separated from the seat frame, and the limiting block pushes against the movable end to pivot relative to the seat frame.

In the fourth aspect of the present disclosure, when the vehicle frame is in the folded state, the limiting block abuts against the movable end to limit rotation of the back frame.

In the fourth aspect of the present disclosure, when the vehicle frame is in the unfolded state and the folded state, the movable end abuts against different parts of the limiting block respectively.

In the fourth aspect of the present disclosure, the child carrier further includes a backrest plate and an adjustment harness. The backrest plate is arranged in a manner of being rotatable relative to the back frame. The back frame includes two back frame vertical portions located on two sides of the vehicle frame. An end of the adjustment harness is fastened to one of the back frame vertical portions, and another end of the adjustment harness bypasses the backrest plate and is fastened to the other of the back frame vertical portions. The adjustment harness has an adjustable length.

A fifth aspect of the present disclosure provides a canopy mounting structure for mounting a canopy on a carrier. The canopy includes a main canopy frame. The canopy mounting structure includes: a mounting seat arranged on the carrier; and a connecting seat arranged on the main canopy frame. The connecting seat is detachably connected to the mounting seat by magnetic attachment.

In the fifth aspect of the present disclosure, the connecting seat is movable in a transverse direction to be magnetically attached to the mounting seat or detached from the mounting seat.

In the fifth aspect of the present disclosure, the mounting seat includes a first positioning portion. The first positioning portion is provided with a first magnetic member. The connecting seat includes a second positioning portion. The second positioning portion is configured to be joined to the first positioning portion, the second positioning portion is provided with a second magnetic member, the first magnetic member and the second magnetic member are attached to each other, so that the first positioning portion and the second positioning portion remain joined.

In the fifth aspect of the present disclosure, one of the first positioning portion and the second positioning portion is a recess, and the other is a lug, the recess being engaged with the lug.

In the fifth aspect of the present disclosure, the first magnetic member and the mounting seat are attached together or are joined together by overmolding, and the second magnetic member and the connecting seat are attached together or are joined together by overmolding.

In the fifth aspect of the present disclosure, an accommodating cavity is arranged on an end face of the lug facing the recess, one of the first magnetic member and the second magnetic member is located in the recess, and the other of the first magnetic member and the second magnetic member is located in the accommodating cavity.

In the fifth aspect of the present disclosure, both the recess and the lug extend along a transverse direction, and a rotation limiting structure is arranged between the recess and the lug.

In the fifth aspect of the present disclosure, the rotation limiting structure includes a guide rib and a guide groove fitting each other, one of the guide rib and the guide groove being arranged on an inner peripheral wall of the recess, and the other of the guide rib and the guide groove being arranged on an outer peripheral wall of the lug.

In the fifth aspect of the present disclosure, the mounting seat is fastened to the vehicle frame and the back frame through a first fastener, and the first magnetic member is attached to the mounting seat through the first fastener.

In the fifth aspect of the present disclosure, the canopy further includes an auxiliary canopy frame, and the auxiliary canopy frame having a pivot seat. The pivot seat is pivotally connected to the connecting seat through a second fastener, and the second magnetic member is attached to the connecting seat through the second fastener.

In the fifth aspect of the present disclosure, a pivot adjustment structure is arranged between the connecting seat and the pivot seat, and the pivot adjustment structure is configured to adjust a relative position between the main canopy frame and the auxiliary canopy frame. And/or a swing limiting structure is arranged between the connecting seat and the pivot seat, and the swing limiting structure is configured to limit a pivot angle between the main canopy frame and the auxiliary canopy frame.

In the fifth aspect of the present disclosure, one of the connecting seat and the pivot seat is provided with an annular groove, and the other of the connecting seat and the pivot seat is provided with an annular wall, a side wall of the annular groove being opposite to the annular wall. The pivot adjustment structure includes: one or more slots arranged on one of the side wall of the annular groove and the annular wall; and one or more protrusions arranged on the other of the side wall of the annular groove and the annular wall. The one or more slots are selectively engaged with the one or more protrusions.

In the fifth aspect of the present disclosure, the annular wall is arranged on a lock ring detachably joined to the connecting seat, the lock ring being connected to the connecting seat without relative rotation therebetween.

In the fifth aspect of the present disclosure, the swing limiting structure includes: a first arc-shaped block arranged on one of the connecting seat and the pivot seat; and a second arc-shaped block arranged on the other of the connecting seat and the pivot seat. When the auxiliary canopy frame rotates relative to the main canopy frame, the first arc-shaped block selectively abuts against the second arc-shaped block.

A sixth aspect of the present disclosure provides a child carrier. The child carrier includes a carrier and a canopy. The canopy is mounted on the carrier through the canopy mounting structure according to the fifth aspect of the present disclosure.

### BRIEF DESCRIPTION OF THE DRAWINGS

FIG. 1 and FIG. 2 are side views of a child carrier according to a first embodiment of the present disclosure, with a back frame being at a first position in FIG. 1 and at a second position in FIG. 2.

FIG. 3 is a perspective view showing a second traction member in the back frame, in which the back frame is drawn diagonally to show an internal structure thereof and the back frame is at a rearward leaning position.

FIG. 4 is an enlarged view of an area A in FIG. 3.

FIG. 5 is a perspective view showing the second traction member in the back frame, with the back frame being illustrated in an obliquely cut state to show an internal structure thereof, and the back frame being at an approximately upright position.

FIG. 6 is an enlarged view of an area B in FIG. 5.

FIG. 7 is a perspective view showing a limiting device, with part of the housing being removed to show an internal structure of the limiting device, and a limiting member being at a limit position.

FIG. 8 is a perspective view showing the limiting device, with part of the housing being removed to show an internal structure of the limiting device, and the limiting member being at a non-limit position.

FIG. 9A is a perspective view showing the limiting device at another angle, with part of the housing being removed to show an internal structure of the limiting device, and the limiting member being at the limit position.

FIG. 9B is an enlarged view of an area C in FIG. 9A.

FIG. 10A is a perspective view showing the limiting device at another angle, with part of the housing being removed to show an internal structure of the limiting device, and the limiting member being at the non-limit position.

FIG. 10B is an enlarged view of an area D in FIG. 10A.

FIG. 11 is a perspective view of the limiting device, showing a certain position relationship between a slider, a limiting member, and an engaging pin.

FIG. 12 and FIG. 13 are perspective views of the back frame at different angles.

FIG. 14 and FIG. 15 are exploded perspective views of the back frame at different angles.

FIG. 16 and FIG. 17 are exploded perspective views of an operating member, a linkage member, and related components on the back frame at different angles.

FIG. 18 is a side view of a handle frame and an auxiliary frame, with part of the handle frame and the auxiliary frame being removed to show inner sides of the handle frame and the auxiliary frame.

FIG. 19 is a side view of the handle frame, the auxiliary frame, and the limiting device, with part of the handle frame, the auxiliary frame, and the limiting device being removed to show inner sides of the handle frame, the auxiliary frame, and the limiting device.

FIG. 20A is a perspective view showing the child carrier, showing a connection of a first traction member between the limiting device and the auxiliary frame, with a connecting seat on the left being removed.

FIG. 20B and FIG. 20C are partial enlarged views of areas E and F in FIG. 20A respectively.

FIG. 21 is a perspective view of the connecting seat.

FIG. 22 to FIG. 24 are perspective views of a second embodiment of the child carrier according to the present disclosure.

FIG. 25 is an enlarged view of an area G in FIG. 24.

FIG. 26 is a perspective view showing a third embodiment of the child carrier according to the present disclosure.

FIG. 27 is an enlarged view of an area H in FIG. 26.

FIG. 28 and FIG. 29 are side views of the child carrier according to another embodiment of the present disclosure, with the back frame being at one position in FIG. 28 and at another position in FIG. 29.

FIG. 30 and FIG. 31 are respectively perspective views at two different angles showing the seat frame, the back frame, and the limiting device as a whole.

FIG. 32 is a perspective view showing the seat frame, the back frame, and the limiting device as a whole, with the limiting device being shown in a partially sectioned state.

FIG. 33 is a partially sectioned view showing side surfaces of the seat frame, the back frame, and the limiting device as a whole, with the limiting member being at the limit position.

FIG. 34 is a partially sectioned view showing side surfaces of the seat frame, the back frame, and the limiting device as a whole, with the limiting member being at the non-limit position.

FIG. 35 is a perspective view showing a first housing and a locking member.

FIG. 36 is a perspective view of a second housing.

FIG. 37 is a schematic diagram showing relative movement and rotation between the locking member and the second housing.

FIG. 38 and FIG. 39 are respectively perspective exploded views of the operating member and the related components.

FIG. 40 is a schematic structure diagram of the child carrier according to yet another embodiment of the present disclosure, with the child carrier being in an unfolded state.

FIG. 41 is a schematic structure diagram of the child carrier shown in FIG. 40 from another perspective.

FIG. 42 is an enlarged view of an area I in FIG. 41.

FIG. 43 is a sectional view of the child carrier shown in FIG. 40, with a limiting block abutting against a movable end.

FIG. 44 is an enlarged view of an area J in FIG. 43.

FIG. 45 is a sectional view of the child carrier shown in FIG. 40 in a half-folded state.

FIG. 46 is an enlarged view of an area K in FIG. 45.

FIG. 47 is a sectional view of the child carrier in a folded state.

FIG. 48 is an enlarged view of an area L in FIG. 47.

FIG. 49 is another sectional view of the child carrier shown in FIG. 40, with the limiting block not abutting against the movable end.

FIG. 50 is an enlarged view of an area O in FIG. 49.

FIG. 51 is a schematic structure diagram of the child carrier shown in FIG. 40 from another perspective.

FIG. 52 is an enlarged view of an area P in FIG. 51.

FIG. 53 is a partial schematic exploded view of the child carrier in FIG. 51 after removal of the handle frame.

FIG. 54 is a schematic structure diagram of the child carrier shown in FIG. 40 from another perspective.

FIG. 55 is an exploded view of an area Q in FIG. 54.

FIG. 56 is a sectional view of part of a vehicle frame, a locking mechanism, and an operating mechanism of the child carrier shown in FIG. 40, with the locking mechanism being in a locked state.

FIG. 57 is an enlarged view of an area R in FIG. 56.

FIG. 58 is a sectional view of part of the vehicle frame, the locking mechanism, and the operating mechanism of the child carrier shown in FIG. 40, with the locking mechanism being in an unlocked state.

FIG. 59 is an enlarged view of an area S in FIG. 58.

FIG. 60 is a schematic structure diagram of the child carrier shown in FIG. 40 in the folded state.

FIG. 61 is a perspective view showing the child carrier according to still another embodiment of the present disclosure, including a canopy mounting structure according to an embodiment of the present disclosure.

FIG. 62 is a perspective view showing the back frame of the child carrier according to another embodiment of the present disclosure, with a mounting seat, a first magnetic member, and a first fastener on a side of the back frame being shown in an exploded form.

FIG. 63 is a perspective view showing a main canopy frame of a canopy of the child carrier according to another embodiment of the present disclosure, with a connecting seat, a second magnetic member, and a second fastener on a side of the main canopy frame being shown in an exploded form.

FIG. 64 is a perspective view showing an auxiliary canopy frame of the canopy of the child carrier according to another embodiment of the present disclosure.

FIG. 65 is a sectional view of the canopy mounting structure according to another embodiment of the present disclosure, with the canopy being in a mounted state.

FIG. 66 is a sectional view of the canopy mounting structure according to another embodiment of the present disclosure, with the canopy being in a disassembled state.

### REFERENCE SIGNS

1: child carrier, 100: limiting device, 101: rotation axis, 102: first rotation direction, 103: second rotation direction, 104: locking direction, 105: unlocking direction, 106: first rotation position, 107: second rotation position, 108: first sliding direction, 109: second sliding direction, 110: housing, 111: limiting groove, 111a: forward surface, 111b: rearward surface, 111c: limiting groove slope, 112: accommodating grooves, 114: first housing, 1141: first shaft hole, 1141a: first shaft hole wall, 1142: sliding groove, 1143: first disc portion, 1144: first rod portion, 115: second housing, 1151: second shaft hole, 1152: first locking groove, 1153: second locking groove, 1154: second disc portion, 1155: second rod portion, 120: limiting member, 121: first limiting member end, 121a: limiting head forward surface, 122: second limiting member end, 130: engaging pin, 140: connecting seat, 141: connecting seat body, 142: traction member groove, 143: traction member sleeve accommodating portion, 150: locking member, 151: first locking portion, 151a: first locking tooth, 151b: first forward surface, 151c: first rearward surface, 152: second locking portion, 152a: second locking tooth, 152b: second forward surface, 152c: second rearward surface, 153: elongated hole, 154: fixed portion, 161: locking reset member, 162: driving member, 1621: driving groove, 164: driving pin, 191: first traction member (traction member between the limiting device and the auxiliary frame), 191a: cable sleeve, 191b: cable, 191c: fixed head, 194: first reset member,
200: seat frame (second object), 230: clamping portion,
300: vehicle frame, 310: seat tube, 320: handle frame, 321: handle vertical frame, 3211: first pushing portion, 3212: second pushing portion, 322: handle transverse frame, 323: first sliding sleeve, 3231: sleeve protrusion, 324: handle operating member, 325: handle pivot axis, 326: third traction member (traction member in the handle frame), 327: second sliding sleeve, 3271: engaging groove, 3281: first sliding sleeve reset member, 3282: second sliding sleeve reset member, 329: limiting boss, 330: auxiliary frame, 331: linkage member, 3311: linkage member protrusion, 3312: linkage member sliding portion, 332: connector, 333: fourth reset member (reset member in the auxiliary frame), 334: cable fixing portion, 335: arrow (collapse direction of the auxiliary frame), 336: sliding groove, 337: abutment portion, 340: front leg support frame, 341: first front leg support rod, 342: second front leg support rod, 350: rear leg support frame, 351: first rear leg support rod, 352: second rear leg support rod, 370: armrest frame, 371: armrest connector, 372: armrest body, 380: linkage frame,
400: back frame (first object), 401: back frame pivot axis, 410: back frame vertical portion, 4100: central hole, 4101: mounting hole, 4102: positioning hole, 411: elongated groove, 412: mounting seat, 4121: first positioning portion, 4122: cam follower, 4123: first annular protrusion, 413: movable end, 420: back frame transverse portion, 430: back frame operating member, 431: lug, 440: linkage member, 441: fixed portion, 442: recess, 450: operating member shaft, 460: third reset member (reset member in the back frame), 465: second traction member (traction member in the back frame), 4651: first end of the second traction member, 4652: second end of the second traction member, 470: end portion member, 480: operating member housing, 490: slider, 495: second reset member (slider reset member),
500: limiting block, 510: first end face, 520: second end face, 530: bulge,
610: backrest plate, 620: adjustment harness, 630: adjustment buckle, 640: tie-down member, 650: linkage assembly, 651: first connecting rod, 652: second connecting rod, 653: pivot pin, 660: seat body,
700: locking mechanism, 740: locking groove, 750: engaging block, 751: limiting stopping sheet,
M: first rotating shaft, N: second rotating shaft.
910: canopy, 911: main canopy frame, 9110: through hole, 9111: connecting seat, 9111a: accommodating cavity, 9111b: second positioning portion, 9111c: second annular protrusion, 9119: stopper, 912: auxiliary canopy frame, 9120: through hole, 9121: pivot seat, 9122: annular groove, 919: lock ring, 9190: central hole, 9191: annular wall, 9192: hole, 9193: lightening hole, 920: magnetic device, 921: first magnetic member, 9210: central hole, 9211: first concave portion, 922: second magnetic member, 9220: central hole, 9221: second concave portion, 930: rotation limiting structure, 931: guide rib, 932: guide groove, 941: first fastener, 9412: nut, 9413: retaining ring, 942: second fastener, 9422: nut, 9423: retaining ring, 950: pivot adjustment structure, 951: protrusion, 952: slot, 960: swing limiting structure, 961: first arc-shaped block, 962: second arc-shaped block.

### DETAILED DESCRIPTION OF THE EMBODIMENTS

In order to make the objectives, technical solutions, and advantages of the present disclosure clearer, the present disclosure is described below in further detail with reference to the accompanying drawings and specific implementations. It should be understood that the specific implementations described herein are intended only to interpret the present disclosure and not intended to limit the protection scope of the present disclosure.

It should be noted that when one element is referred to as “fastened to” another element, it may be directly disposed on the other element or an intermediate element may exist. When one element is considered to be “connected to” another element, it may be directly connected to the another element or an intermediate element may co-exist. The terms “vertical”, “horizontal”, “left”, “right” and similar expressions used herein are for illustrative purposes only, and are not intended to represent unique implementations.

Unless defined otherwise, all technical and scientific terms used herein have the same meanings as would generally understood by those skilled in the technical field of the present disclosure. The terms used herein in the specification of the present disclosure are for the purpose of describing specific implementations only, and are not intended to limit the present disclosure. The term “and/or” used herein includes any and all combinations of one or more related listed items.

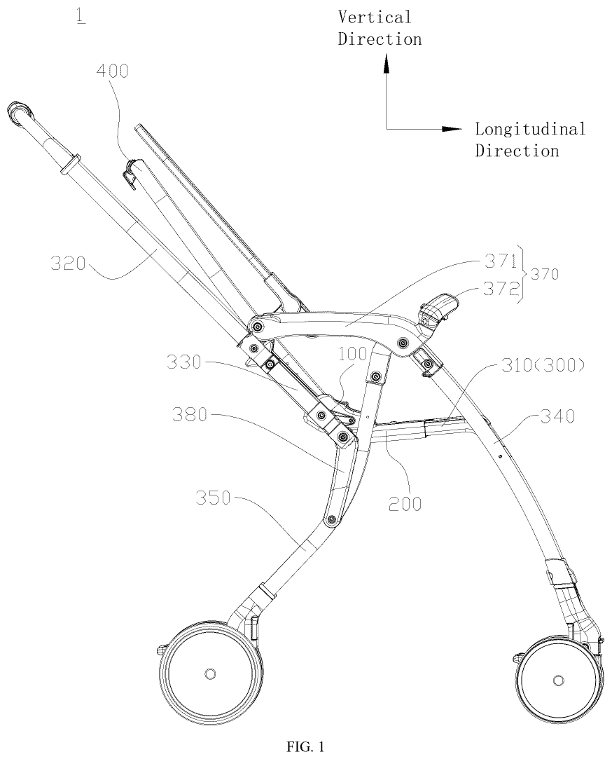

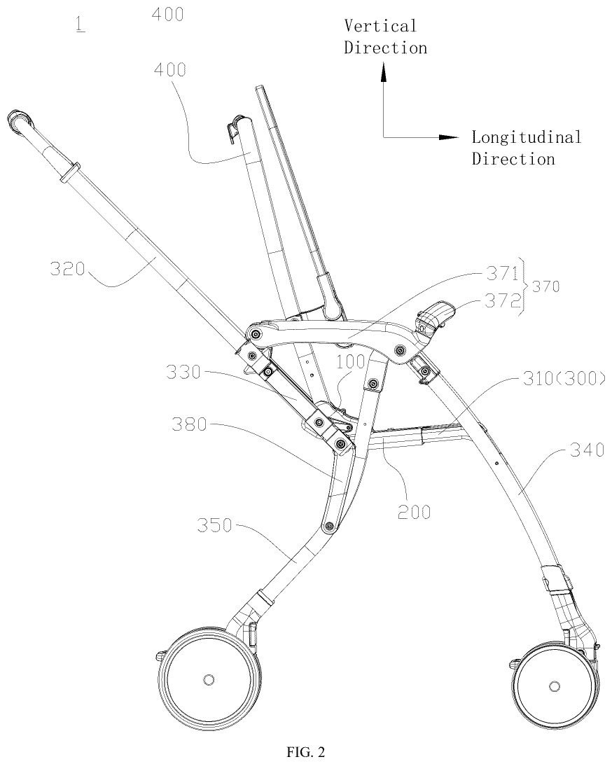

As shown in FIG. 1 and FIG. 2, an embodiment of the present disclosure provides a child carrier 1. The child carrier 1 includes a limiting device 100, a seat frame 200, a vehicle frame 300, and a back frame 400.

As shown in FIG. 1 to FIG. 3, the vehicle frame 300 includes a seat tube 310, a handle frame 320, an armrest frame 370, an auxiliary frame 330, a linkage frame 380, a front leg support frame 340, and a rear leg support frame 350. In this embodiment, two seat tubes 310 are provided and arranged opposite to each other, and two seat frames 200 are also provided and respectively slidably arranged on the two seat tubes 310. A seat body 660 of the child carrier 1 may be fastened to the vehicle frame 300 through the two seat frames 200 on left and right sides thereof, so as to be used by an infant. The handle frame 320 is configured in a manner of being pivotable relative to the seat tube 310, which will be described in detail later. The vehicle frame 300 may be folded by operating the handle frame 320, and an actuation manner will be described later. In addition, in this embodiment, the handle frame 320 may be pivoted from a first position to a second position relative to the seat tube 310, so as to change a forward direction of the child carrier 1.

As shown in FIG. 1 and FIG. 2, the armrest frame 370 includes an armrest body 372 and two armrest connectors 371 on left and right sides of the seat body 660. The armrest body 372 is fastened to front ends of the two armrest connectors 371 in a detachable or non-detachable manner. The two armrest connectors 371 on left and right sides of the seat body 660 are both pivotally connected to a front leg support frame 340 and a rear leg support frame 350.

In this embodiment, the vehicle frame 300 includes two auxiliary frames 330 and two linkage frames 380, and the two auxiliary frames 330 are respectively located on left and right sides of the child carrier 1. Referring to FIG. 1 and FIG. 2, the two auxiliary frames 330 are respectively pivotally connected to opposite rear ends of the two armrest connectors 371. In addition, the two linkage frames 380 are also respectively located on the two sides of the child carrier 1. The auxiliary frame 330 and the linkage frame 380 on a same side of the child carrier 1 are pivotally connected to each other. Detailed structures of the auxiliary frame 330 and the linkage frame 380 and a connection relationship between the two will be specifically described later.

It is to be noted that the term “front” mentioned herein refers to a same direction as the forward direction of the child carrier in an unfolded state, and the term “rear” mentioned herein refers to a direction opposite to the forward direction of the child carrier 1 in the unfolded state.

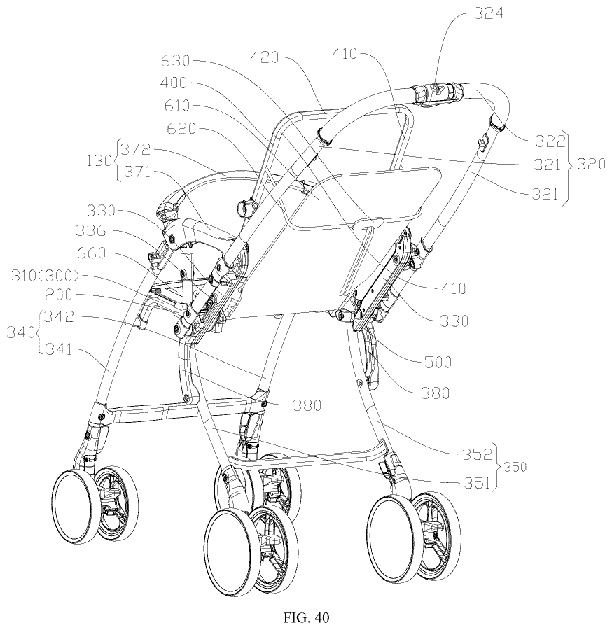

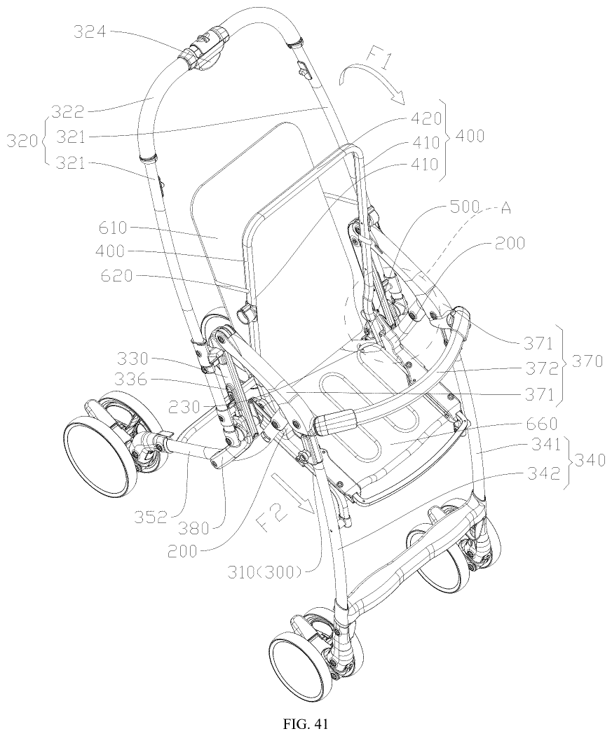

As shown in FIG. 1 to FIG. 3, the back frame 400 is joined to the seat frame 200 through the limiting device 100, extends upward from the seat frame 200, and is configured to arrange a backrest plate 610 of the child carrier 1 (e.g., see FIG. 40 and FIG. 41). The back frame 400 can pivot between a first position (e.g., a rearward leaning position, i.e., a position where an angle between the back frame 400 and the seat frame 200 ranges from 90 degrees to 180 degrees, see FIG. 1) and a second position (e.g., an approximately upright position, i.e., a position where the angle between the back frame 400 and the seat frame 200 is nearly 90 degrees, see FIG. 2) relative to the seat frame 200. When the child carrier 1 is collapsed or folded, the back frame 400 can also move beyond a forward leaning position (i.e., a position where the angle between the back frame 400 and the seat frame 200 is less than 90 degrees) and pivot to be closer to the seat frame 200. The limiting device 100 is configured to prevent pivoting of the back frame 400 beyond the forward leaning position when the child carrier 1 is in use, which will be described in detail later. It is to be understood that the limiting device 100 of the present disclosure is also applicable to other devices and configured to operably control relative rotation between two objects. Therefore, the back frame 400 may be referred to as a first object, and the seat frame 200 may be referred to as a second object.

As shown in FIG. 1 to FIG. 3, the limiting device 100 is connected between the back frame 400 and the seat frame 200, more specifically between a lower end of the back frame 400 and a rear end of the seat frame 200. Through the limiting device 100, the back frame 400 can rotate around a transverse rotation axis 101 relative to the seat frame 200, so as to adjust a pitch angle of the back frame 400. For ease of description, a forward leaning rotation direction of the back frame 400 is referred to as a first rotation direction 102, and a rearward leaning rotation direction of the back frame 400 is referred to as a second rotation direction 103.

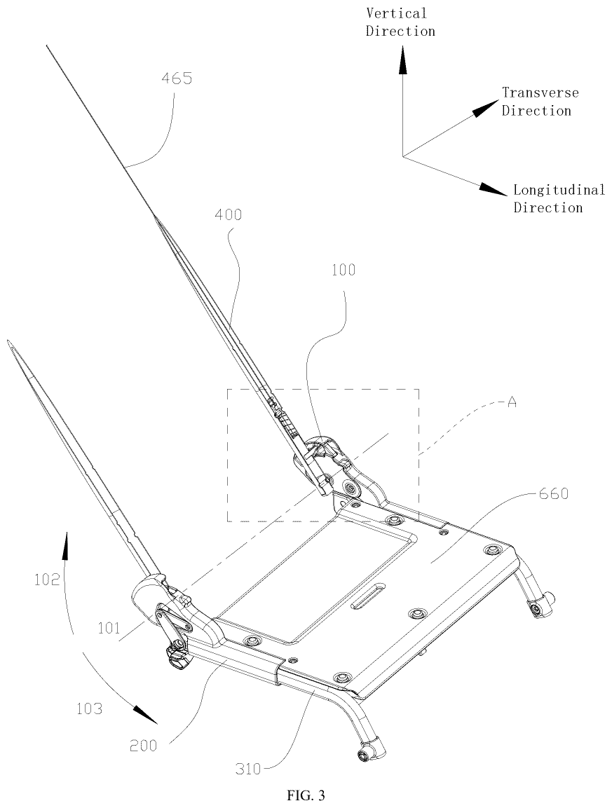

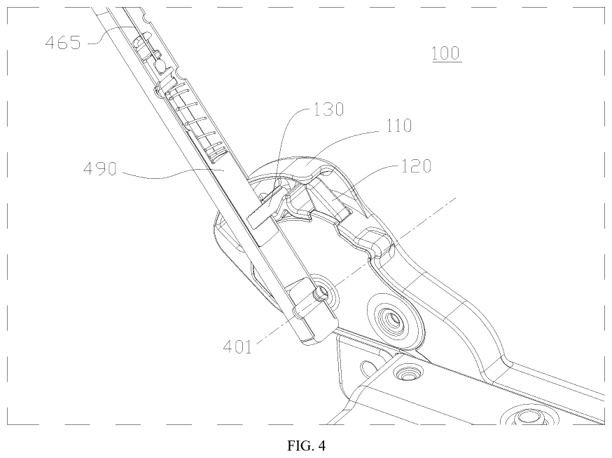

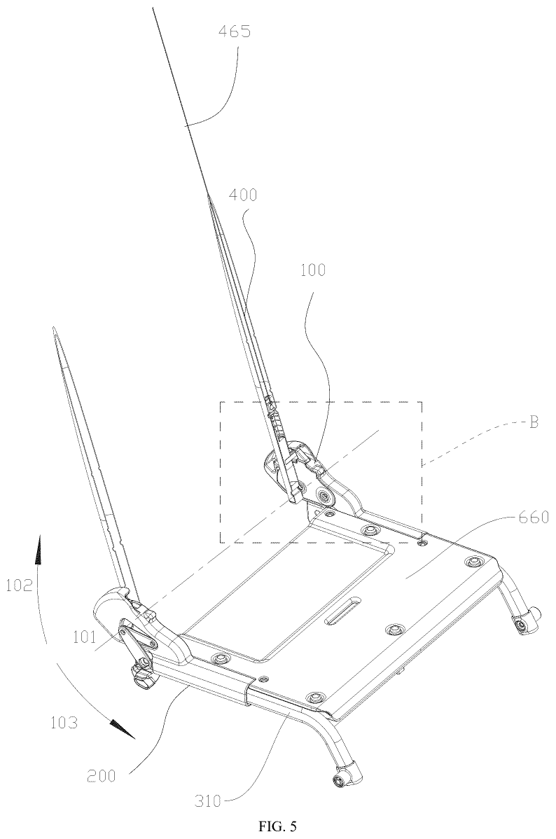

The limiting device 100 may have various structures. Referring to FIG. 3 to FIG. 7, in an embodiment, the limiting device 100 may specifically include a housing 110, a limiting member 120, an engaging pin 130, and a first traction member 191.

The housing 110 is mounted to the seat frame 200 and pivotally connected to the back frame 400. In this embodiment, the seat frame 200 can slide longitudinally along the seat tube 310, so that the limiting device 100 and the back frame 400 can slide longitudinally relative to the seat tube 310 (i.e., slide back and forth). In other embodiments, the housing 110 may alternatively be directly fastened to the seat tube 310, so that the limiting device 100 and the back frame 400 do not slide along with the seat frame 200. Alternatively, both the limiting device 100 and the seat bracket 200 can be fastened to the seat tube 310 without sliding.

The housing 110 is in a shape of a flat box, and has two opposite side surfaces substantially perpendicular to a transverse direction. The back frame 400 abuts against one side surface of the housing 110 and is connected to the housing 110 through a transverse shaft (not shown) inserted in the housing 110. In this embodiment, the back frame 400 abuts against an inner side surface of the housing 110. In other embodiments, the back frame 400 may alternatively abut against an outer side surface of the housing 110.

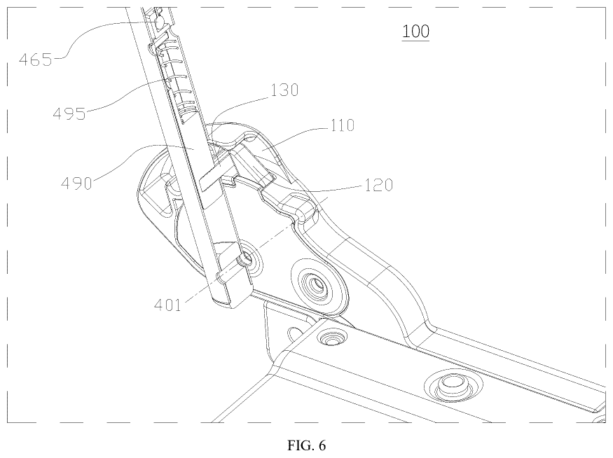

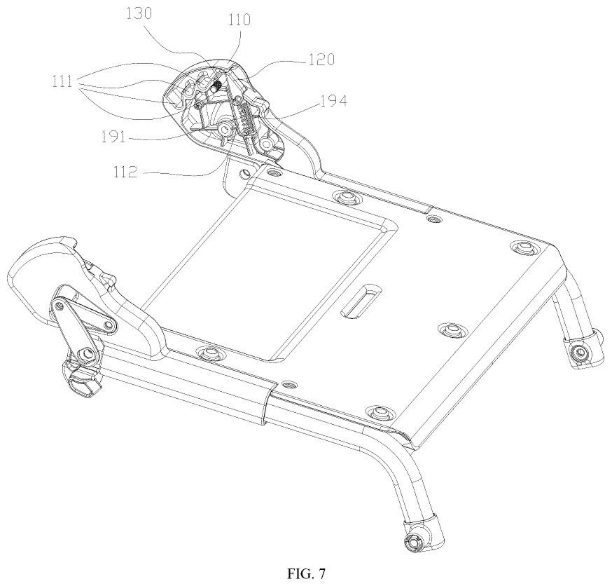

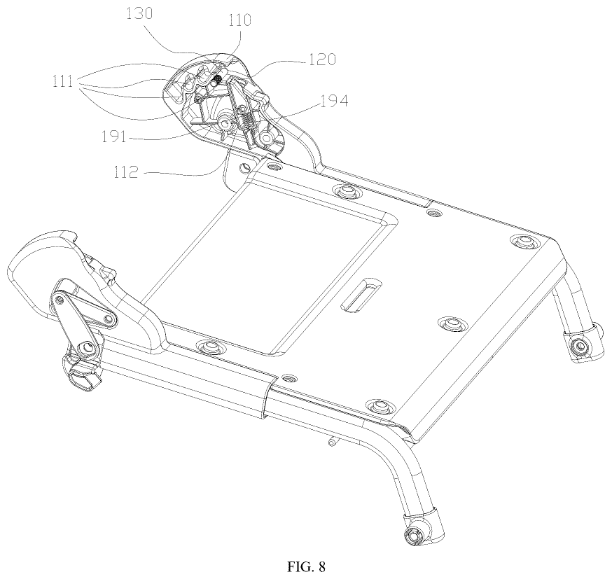

As shown in FIG. 7 and FIG. 8, at least one limiting groove 111 is arranged on a side surface of the housing 110 adjacent to the back frame 400. Specifically, the housing 110 may be provided with only one limiting groove 111, or may be provided continuously with a plurality of limiting grooves 111 around a back frame pivot axis 401 (see FIG. 6) along a pivot direction of the back frame 400. In this embodiment, the limiting grooves 111 have arc-shaped walls extending along a direction of the back frame pivot axis 401. The arc-shaped walls are connected to each other in an approximately wavy shape, and open toward the engaging pin 130 and radially outward (i.e., substantially upward). When only one limiting groove 111 is provided, there is an unadjustable pitch angle between the back frame 400 and the seat frame 200 in a use state. When a plurality of limiting grooves 111 are provided, there is an adjustable pitch angle between the back frame 400 and the seat frame 200 in the use state. The situation where a plurality of limiting grooves 111 are provided is mainly described below.

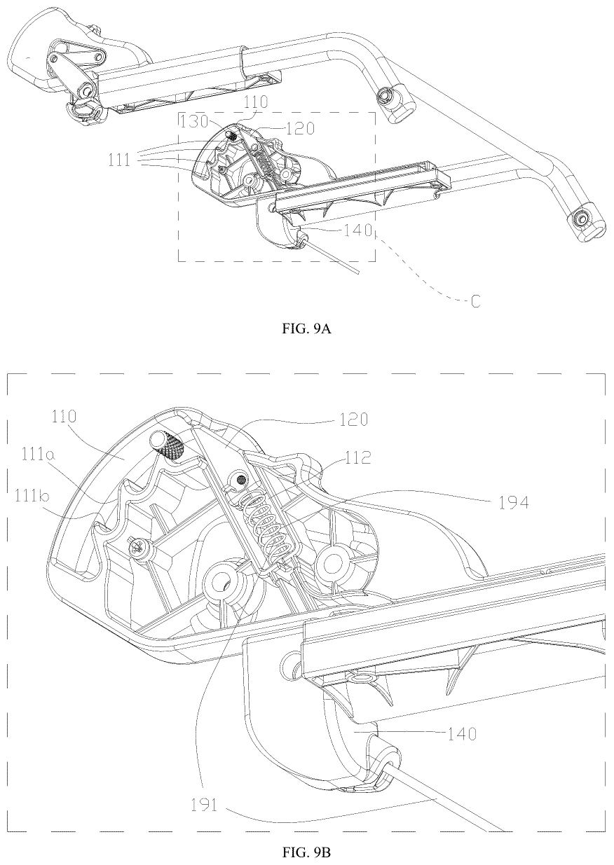

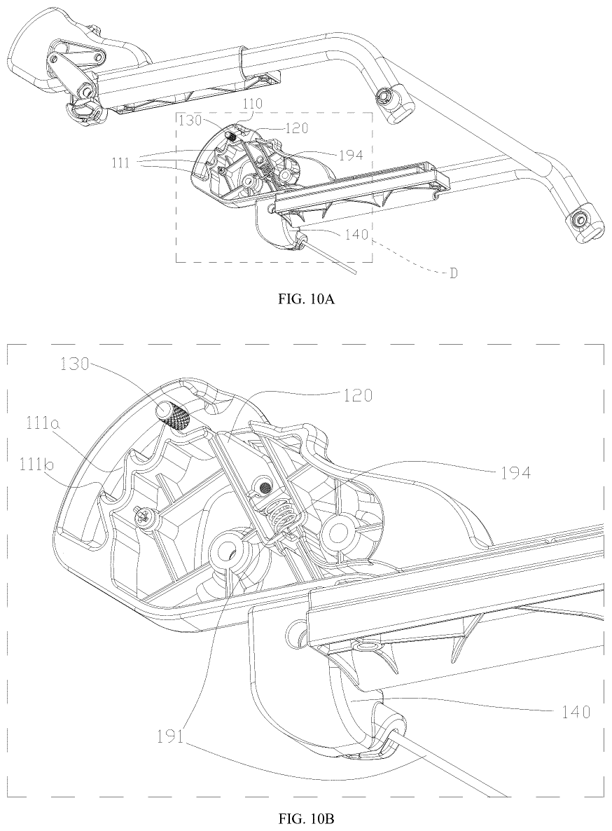

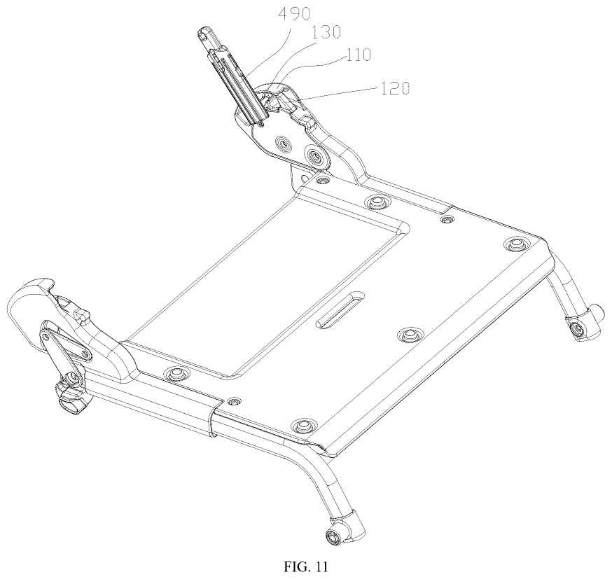

More specifically, as shown in FIG. 9B and FIG. 10B, each limiting groove 111 has a forward surface 111a toward a forward leaning direction (close to the limiting member 120) and a rearward surface 111b toward a rearward leaning direction (away from the limiting member 120). The forward surface 111a is a slope or a convex arc surface, and the rearward surface 111b is a concave arc surface. In this way, when the back frame 400 moves toward the forward leaning direction, the engaging pin 130 can automatically move beyond the limiting groove 111, but when the back frame 400 moves toward the rearward leaning direction, the engaging pin 130 cannot automatically move beyond the limiting groove 111.

In other embodiments, the limiting groove 111 may alternatively be in another shape, such as a square, a triangle, or a trapezoid. The limiting grooves 111 do not have to be connected to each other, but may be arranged to have a certain distance from each other.

As shown in FIG. 9B and FIG. 10B, the engaging pin 130 has an end inserted into the plurality of limiting grooves 111 from a side surface of the housing 110 and another end inserted into the back frame 200. The engaging pin 130 can move between a low position where the engaging pin is locked in one of the plurality of limiting grooves 111 and a high position where the engaging pin is positioned beyond the one of the plurality of limiting grooves 111 relative to the housing 110.

When the limiting groove 111 is provided with the forward surface 111a with an inclined surface or a convex arc surface, the engaging pin 130 can move to the high position along the forward surface 111a. Moreover, the engaging pin 130 may move between the high position and the low position by operating a slider 490 (as shown in FIG. 11), which will be described in detail later.

As shown in FIG. 9B and FIG. 10B, the limiting member 120 is arranged on a side of the plurality of limiting grooves 111 along the pivot direction, and can move between a limit position that limits the engaging pin 130 close to the side and a non-limit position that avoids the engaging pin 130 close to the side. More specifically, the limiting member 120 is arranged on a forward side of the limiting groove 111 and is adjacent to the limiting groove 111 closest to the forward side. When the limiting member 120 is at the limit position (FIG. 9A and FIG. 9B), the engaging pin 130 at the low position or the high position cannot move beyond the limiting member 120. When the limiting member 120 is at the non-limit position (FIG. 10A and FIG. 10B), the engaging pin 130 at the low position or the high position can move beyond the limiting member 120.

In this embodiment, the engaging pin 130 extends parallel to the pivot axis (i.e., extends transversely).

Arrangement and operation of the limiting member 120 are described with reference to FIG. 7 to FIG. 10B.

The limiting member 120 is arranged in an accommodating groove 112 in the housing 110, so as to slide between the limit position (see FIG. 7, FIG. 9A, and FIG. 9B) and the non-limit position (see FIG. 8, FIG. 10A, and FIG. 10B) along the accommodating groove 112. The accommodating groove 112 is formed between two side walls of the housing 110. In this embodiment, the accommodating groove 112 substantially extends vertically, but the accommodating groove 112 may alternatively extend along another direction, such as extend approximately longitudinally.

As shown in FIG. 9B and FIG. 10B, the first traction member 191 has an end connected to the limiting member 120 and another end connected to an actuating device (the auxiliary frame 330 in a first embodiment) outside the limiting device 100. The actuating device is configured to be capable of pulling the limiting member 120 to the non-limit position through the first traction member 191. The actuating device will be described in detail later.

A first reset member 194 is arranged between the bottom of the limiting member 120 and a bottom wall of the accommodating groove 112 to press the limiting member 120 to the limit position.

In this way, when the child carrier 1 is in use, the limiting member 120 is at the limit position, so that the engaging pin 130 cannot move beyond the limiting member 120, preventing excessive forward leaning of the back frame 400. When the child carrier 1 is required to be collapsed or folded, the limiting member 120 is pulled to the non-limit position through the actuating device, allowing the engaging pin 130 to move beyond the limiting member 120, thereby allowing the back frame 400 to approach or fit the seat frame 200.

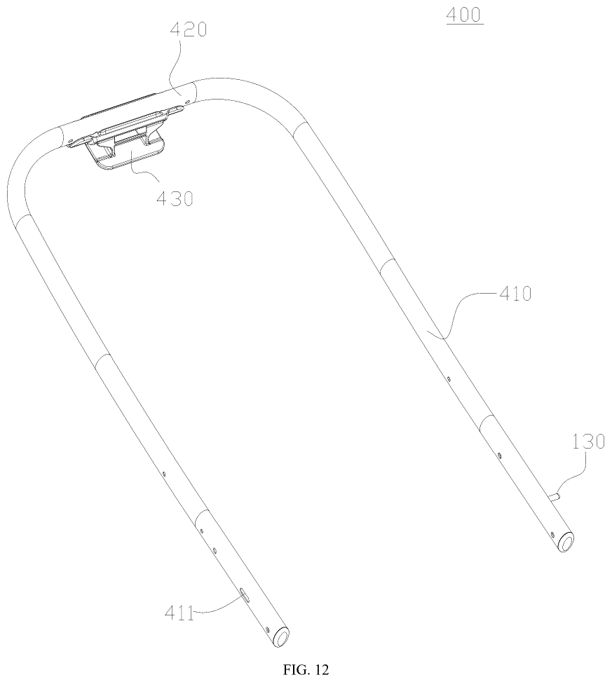

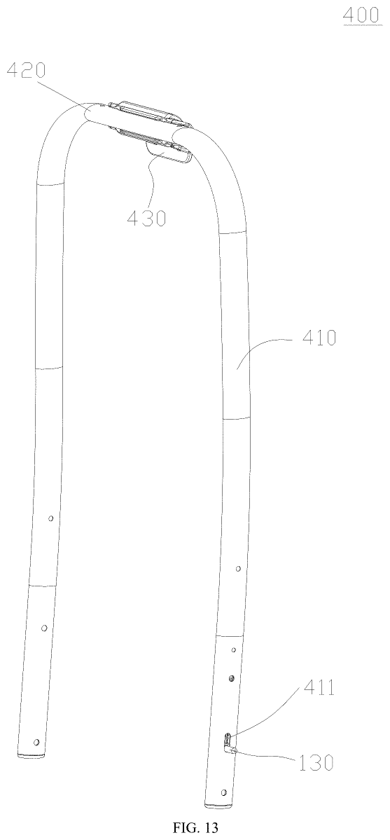

A specific structure of the back frame 400 according to the present disclosure is described with reference to FIG. 12 to FIG. 17. The back frame 400 includes a back frame vertical portion 410, a back frame transverse portion 420, a back frame operating member 430, a linkage member 440, a second traction member 465, a second reset member 495, and an end portion member 470.

As shown in FIG. 12 to FIG. 14, the back frame 400 is a substantially U-shaped member formed by two back frame vertical portions 410 and the back frame transverse portion 420 connected between upper ends of the two back frame vertical portions 410. Lower ends of the two back frame vertical portions 410 are respectively joined to the seat frame 200 (or joined to the seat tube 310) through one limiting device 100. The end portion member 470 is configured to close the lower end of the back frame vertical portion 410.

The back frame operating member 430 is arranged in the middle of the back frame transverse portion 420, which may alternatively be arranged at another position of the back frame 400 in other embodiments, such as on the back frame vertical portion 410.

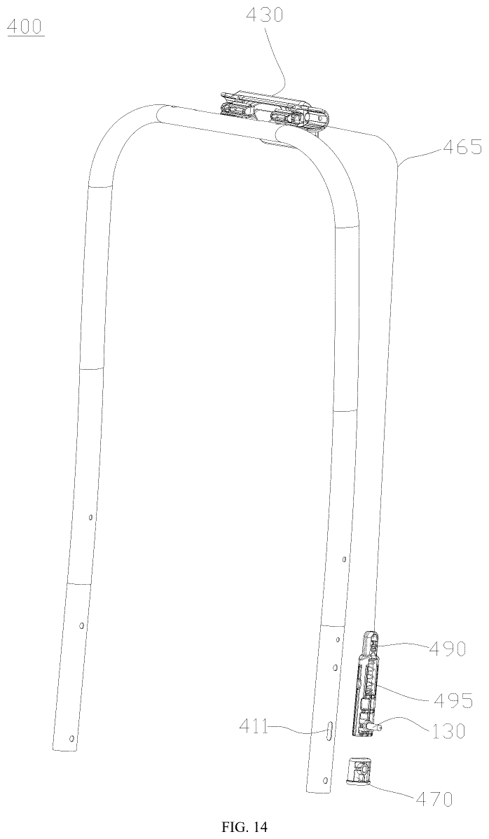

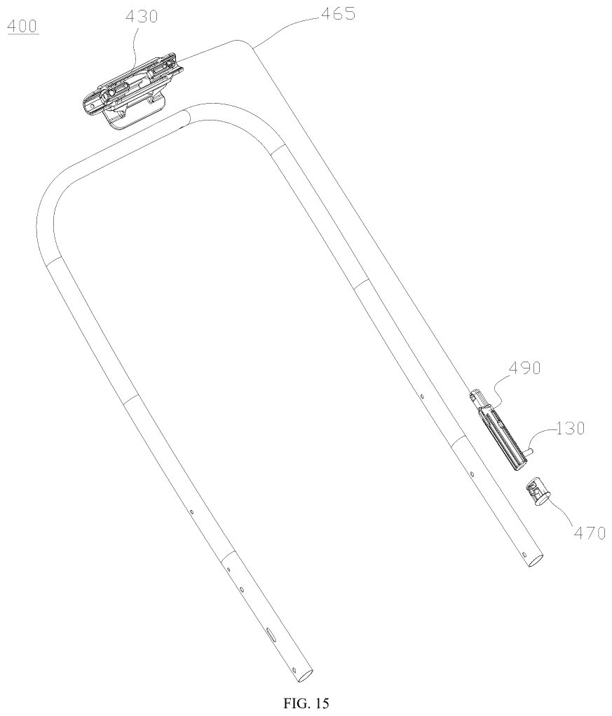

As shown in FIG. 14 and FIG. 15, the slider 490 is located at the lower end of the back frame vertical portion 410, and is slidably arranged in the back frame vertical portion 410 which is hollow. The engaging pin 130 has an end fastened to the slider 490 and the other end passing through an elongated groove 411 at the lower end of the back frame vertical portion 410 to the outside of the back frame 400 and inserted into the limiting device 100. The elongated groove 411 extends longitudinally for a certain distance, thereby allowing the engaging pin 130 to move together with the slider 490. The second reset member 495 is arranged in the back frame vertical portion 410 and biases the slider 490 to drive the engaging pin 130 to the low position (a lock position).

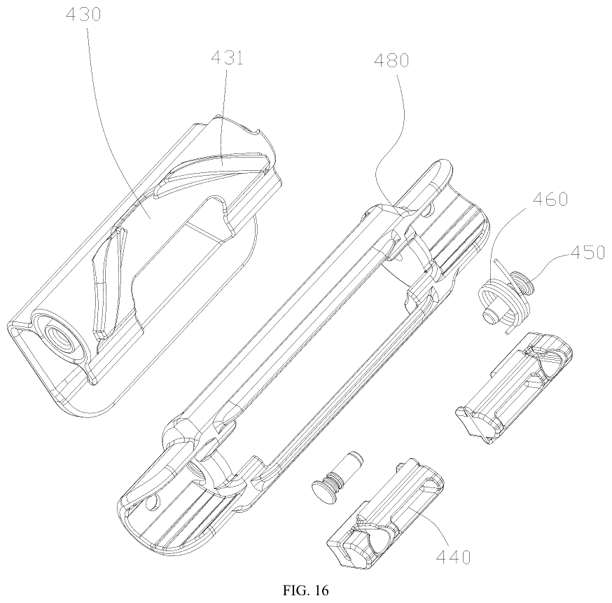

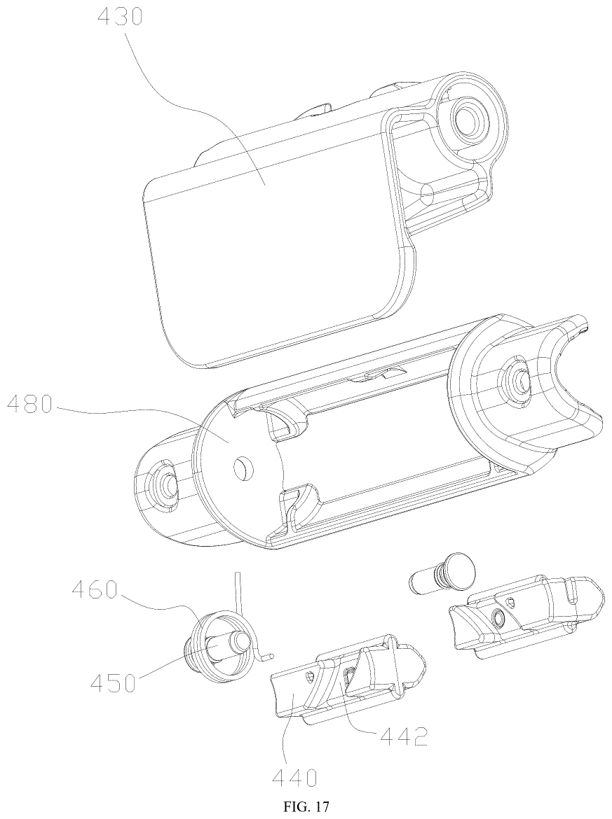

As shown in FIG. 14 and FIG. 15, the second traction member 465 has an end connected to the slider 490 and another end connected to the linkage member 440 (see FIG. 16 and FIG. 17) arranged on the back frame 400. The linkage member 440 is then joined to the back frame operating member 430. The back frame operating member 430 is operable to drive, through the second traction member 465 and the slider 490, the engaging pin 130 to the high position (i.e., an unlock position). More specifically, the back frame operating member 430 is connected to the back frame transverse portion 420 through an operating member housing 480. The operating member housing 480 is fastened to the back frame transverse portion 420 and extends along the back frame transverse portion 420. The back frame operating member 430 rotates around the operating member housing 480 through an operating member shaft 450. The linkage member 440 is arranged in the operating member housing 480, and can slide along the operating member housing 480. Another end of the second traction member 465 is fastened to the linkage member 440. The back frame operating member 430 abuts against the linkage member 440, and is provided with an obliquely extending lug 431 facing the linkage member 440. The lug 431 is inserted into an obliquely extending recess 442 at a corresponding position of the linkage member 440. In this way, when the back frame operating member 430 is operated to rotate around the operating member housing 480, the linkage member 440 relatively slides along the back frame transverse portion 420 through an abutment relationship between the lug 431 and the recess 442, thereby pulling the second traction member 465. A third reset member 460 may be arranged between the back frame operating member 430 and the operating member housing 480, which presses the back frame operating member 430 to a position where the second traction member 465 is not pulled.

In another embodiment, the back frame operating member 430 may have different forms, such as a pulling handle, provided that the slider 490 can be pulled according to a user operation. Alternatively, the slider 490 may be configured to be operable from the outside, such as have a part exposed outside the back frame 400 for pulling. In this way, the back frame operating member 430 can be omitted.

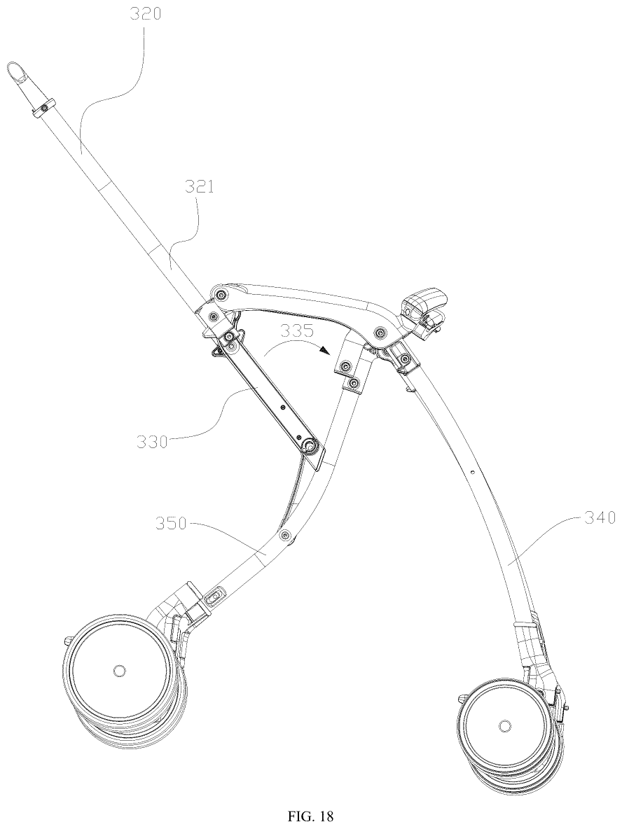

The actuating device may be in a variety of forms. As shown in FIG. 18 to FIG. 21, in the first embodiment, the actuating device may be the auxiliary frame 330, and has a specific structure as follows. In the embodiment, the auxiliary frame 330 is pivotally mounted on an outer side of the seat frame 200, and the handle frame 320 is pivotally mounted on an outer side of the auxiliary frame 330. In other embodiments, an order of the seat frame 200, the auxiliary frame 330, and the handle frame 320 from inside to outside may be exchanged. In this embodiment, the auxiliary frame 330 and the handle frame 320 rotate around a same handle pivot axis 325 relative to the seat frame 200. However, this is not necessary. In other embodiments, the auxiliary frame 330 and the handle frame 320 may have different pivot axes.

The limiting device 100 is mounted above an inner side of the seat frame 200. As described above, the limiting device 100 may be connected to the seat frame 200, so as to be slidable relative to the seat tube 310 through the seat frame 200 (i.e., longitudinally slide back and forth) or directly fastened to the seat tube 310. In order to clearly show the arrangement of the first traction member 191, the back frame 400 is not shown in FIG. 18 to FIG. 21. However, it should be understood that the back frame 400 is pivotally connected to the limiting device 100, so the pivot axis of the back frame 400 is not required to overlap with the handle pivot axis 325.

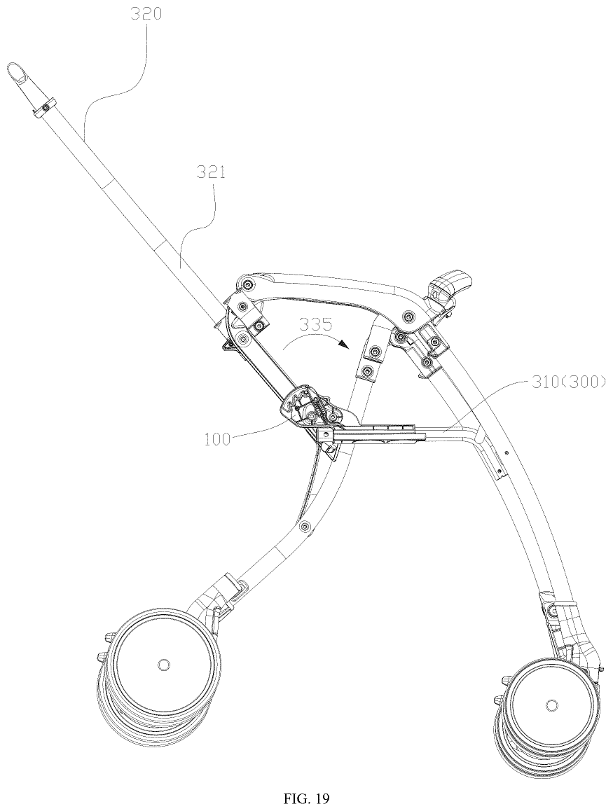

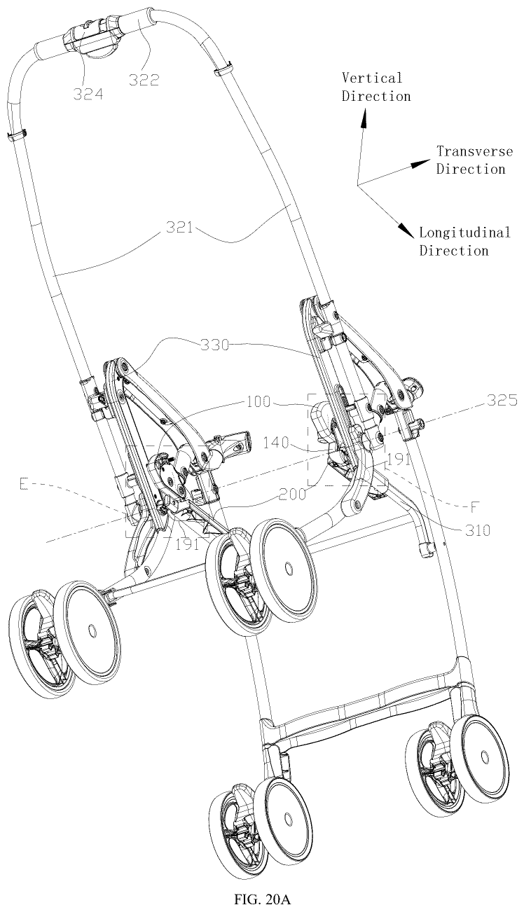

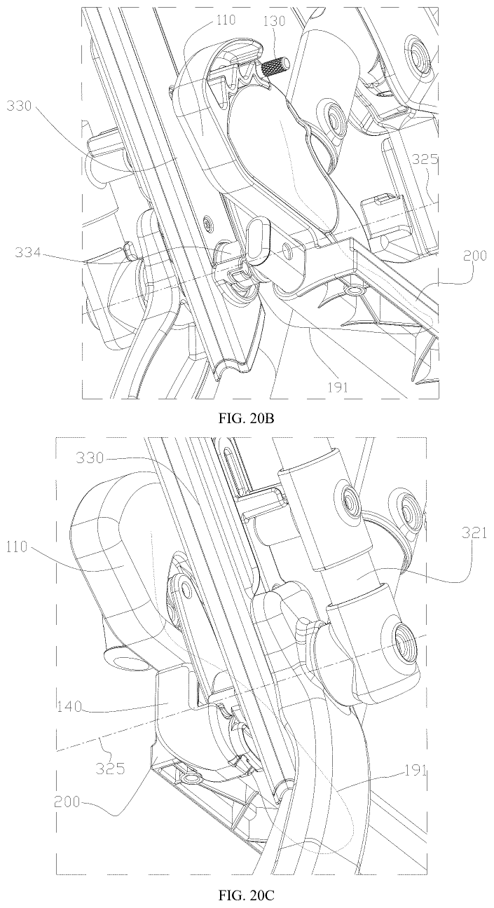

When the child carrier 1 is collapsed or folded, the auxiliary frame 330 rotates forward relative to the seat frame 200, as shown by an arrow 335 in FIG. 18 and FIG. 19. Therefore, the auxiliary frame 330 can pivot between an unfold position and a collapse position relative to the seat frame 200. Only the unfold position of the auxiliary frame 330 is shown in the figure. It should be understood that the auxiliary frame 330 is closer to the seat frame 200 at the collapse position.

As shown in FIG. 20A to FIG. 20C, two ends of the first traction member 191 are respectively connected to the limiting member 120 and the auxiliary frame 330. More specifically, the first traction member 191 extends from the limiting member 120 through the housing 110 to the outside of the limiting device 100, passes through a gap of the seat frame 200 or bypasses the seat frame 200, passes through a connecting seat 140 mounted behind the seat frame 200, and finally enters the interior of the auxiliary frame 330 through a cable fixing portion 334.

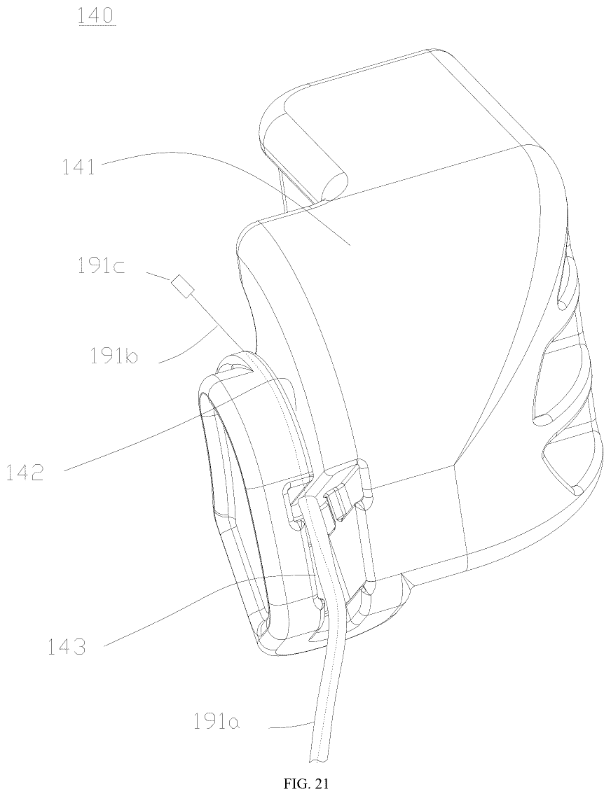

The connecting seat 140 is fastened to a rear end of the seat tube 310 (i.e., an end portion close to the back frame 400). As shown in FIG. 21, the connecting seat 140 includes a connecting seat body 141, a traction member groove 142, and a traction member sleeve accommodating portion 143. The connecting seat body 141 is planar on a side facing the seat tube 310, and has an arc-shaped finishing surface on a side facing away from the seat tube 310. The connecting seat body 141 may alternatively be in another shape without affecting the function thereof. The traction member groove 142 is arranged on a side of the connecting seat body 141, for example, a side close to the auxiliary frame 330 (i.e., a side facing away from the seat tube 310). The traction member sleeve accommodating portion 143 is arranged at an end of the traction member groove 142. The first traction member 191 passes through the traction member groove 142 and is connected to the auxiliary frame 330.

Specifically, the first traction member 191 includes a cable sleeve 191a and a cable 191b slidably threaded in the cable sleeve 191a, two ends of the cable 191b are respectively connected to the limiting member 120 and the auxiliary frame 330 via the connecting seat 140, and two ends of the cable sleeve 191a are respectively connected to the housing 110 and the connecting seat 140. The auxiliary frame 330, when pivoting from the unfold position to the collapse position, drives the limiting member 120 to the non-limit position through the first traction member 191.

More specifically, the first traction member 191 includes a cable sleeve 191a, a cable 191b, and a fixed head 191c. The cable 191b is slidably arranged in the cable sleeve 191a, and the fixed head 191c is arranged on an end portion of the cable 191b. A width of the traction member groove 142 is arranged to allow insertion of the cable 191b, but not to allow insertion of the cable sleeve 191a. A width of the traction member sleeve accommodating portion 143 is greater than that of the traction member groove 142, so that an end of the cable sleeve 191a is engaged with the traction member sleeve accommodating portion 143 of the connecting seat 140. The cable 191b is joined to the cable fixing portion 334 of the auxiliary frame 330 through the fixed head 191c.

In this way, when the child carrier 1 is collapsed or folded, the auxiliary frame 330 pivots forward relative to the seat frame 200, the cable fixing portion 334 of the auxiliary frame 330 pulls the cable 191b, and the cable 191b slides in the cable sleeve 191a, so as to drive the limiting member 120 to move to the non-limit position, allowing the back frame 400 to pivot beyond the limiting member 120.

When the child carrier 1 is collapsed or folded, the seat tube 310 may also pivot upward relative to the auxiliary frame 330 (or relative to the entire child carrier 1). Similarly, the cable fixing portion 334 of the auxiliary frame 330 pulls the cable 191b, and the cable 191b slides in the cable sleeve 191a, so as to drive the limiting member 120 to move to the non-limit position, allowing the back frame 400 to pivot beyond the limiting member 120. Therefore, when the child carrier 1 is collapsed or folded, the engaging pin 130 can move beyond the limiting member 120 to allow forward leaning collapse of the back frame 400.

In addition, the cable cover 191a is neither pulled along with the pivoting of the auxiliary frame 330, nor configured to pull the limiting member 120. In other words, the cable cover 191a is substantially immovable when the auxiliary frame 330 pivots. Moreover, when the limiting device 100 moves longitudinally relative to the seat frame 200, an end of the cable sleeve 191a fastened to the housing 110 of the limiting device 100 moves longitudinally with the limiting device 100. In this way, the cable cover 191a can automatically adjust an extension path of the cable 191b, so that the two ends of the cable 191b maintain a roughly constant tractive force.

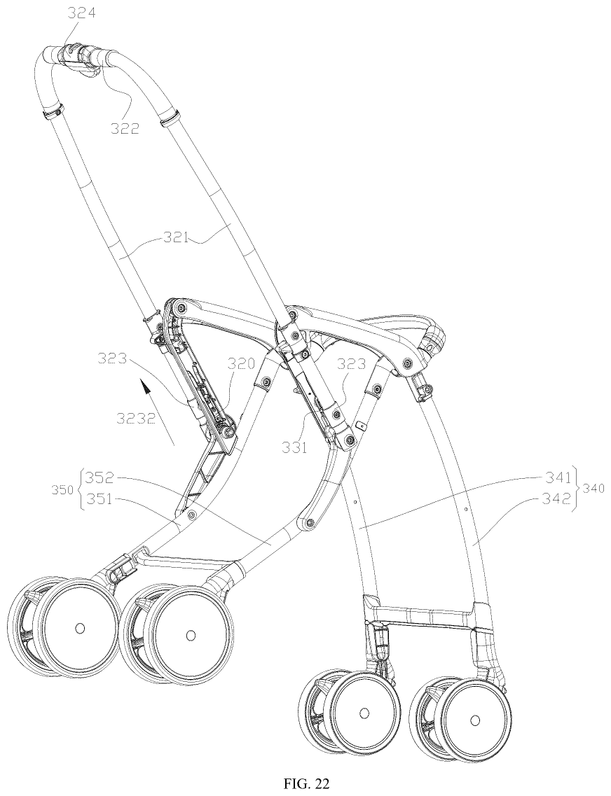

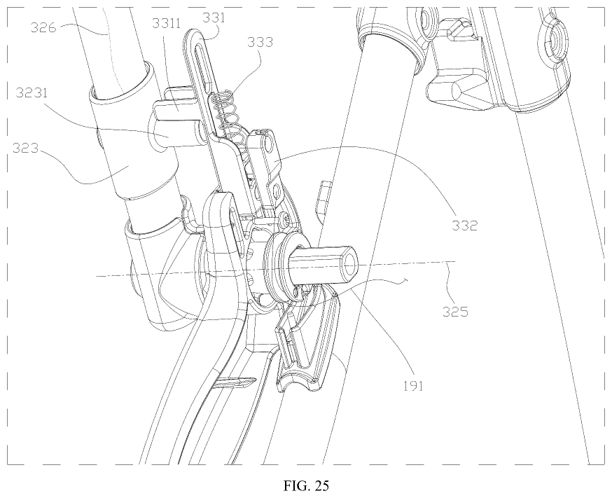

In a second embodiment, as shown in FIG. 22 and FIG. 25, the actuating device may alternatively be a linkage member 331. The linkage member 331 is arranged on a side of the auxiliary frame 330, and can slide relative to the auxiliary frame 330.

A first sliding sleeve 323 is sleeved on a lower end of the handle frame 320, and a position of the first sliding sleeve 323 is close to the handle pivot axis 325 (see FIG. 25). The handle frame 320 is further provided with a handle operating member 324 (see FIG. 22). The handle operating member 324 is operatively connected to the first sliding sleeve 323, and can pull the first sliding sleeve 323 to slide away from the handle pivot axis 325 (i.e., slide upward) through a third traction member 326. A specific structure of the handle operating member 324 may be similar to the back frame operating member 430 of the back frame 400, and may alternatively have different forms.

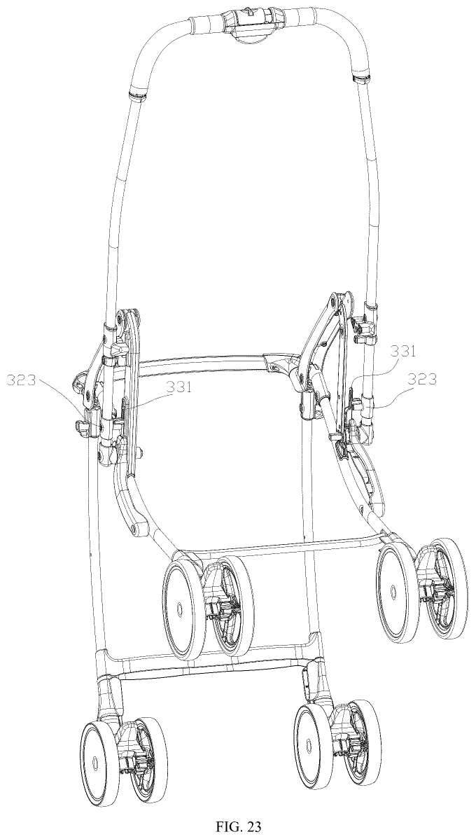

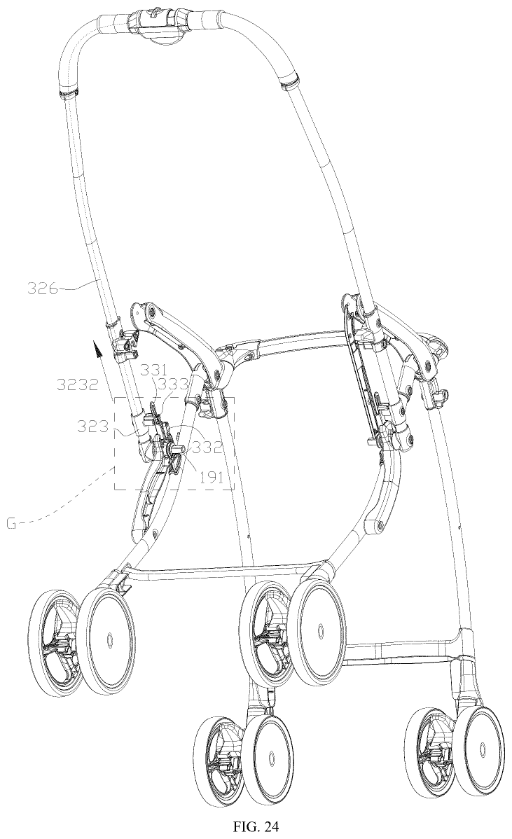

The first sliding sleeve 323 of the handle frame 320 drives, through the first traction member 191, the limiting member 120 to move to the non-limit position. More specifically, as shown in FIG. 25, the first sliding sleeve 323 is joined to the linkage member 331, and the sliding of the first sliding sleeve 323 away from the handle pivot axis 325 can drive the linkage member 331 to slide, thereby pulling the first traction member 191 to bring the limiting member 120 to the non-limit position. In this embodiment, the first sliding sleeve 323 includes a first sliding sleeve protrusion 3231 extending toward the auxiliary frame 330, the linkage member 331 includes a linkage member protrusion 3311 extending toward the handle frame 320, the linkage member protrusion 3311 at least partially protrudes out of the auxiliary frame 330, and the first sliding sleeve protrusion 3231 abuts against a lower part of the linkage member protrusion 3311. In this way, when the handle frame 320 moves around the handle pivot axis 325 to a rearward position shown in FIG. 22 to FIG. 25, the first sliding sleeve 323 can abut against the linkage member 331, and when the handle frame 320 leaves the rearward position, the first sliding sleeve 323 can be separated from the linkage member 331 without hindering movement of the handle frame 320.

In other embodiments, the first sliding sleeve 323 and the linkage member 331 may be joined in different forms. For example, the first sliding sleeve 323 may be inserted into the linkage member 331.

In this embodiment, the linkage member 331 is connected to the first traction member 191 through a connector 332. The connector 332 is fastened to the linkage member 331, and is inserted in the auxiliary frame 330 and can slide relative to the auxiliary frame 330. The linkage member 331 is located on a side of the auxiliary frame 330 facing the handle frame 320, and the connector 332 is located on a side of the auxiliary frame 330 facing the seat tube 310. In other words, the linkage member 331 and the connector 332 are located on two sides of the auxiliary frame 330 respectively, so as to be joined to the first sliding sleeve 323 of the handle frame 320 and the first traction member 191 respectively. The linkage member protrusion 3311 extends from the connector 332 toward the handle frame 320, and a fourth reset member 333 is arranged between the connector 332 and the auxiliary frame 330, so that the linkage member protrusion 3311 always keeps pressing against the first sliding sleeve protrusion 3231.

The first sliding sleeve 323 is joined to the linkage member 331, and the sliding of the first sliding sleeve 323 away from the handle pivot axis 325 can drive the linkage member 331 to slide, thereby pulling the first traction member 191 to bring the limiting member 120 to the non-limit position. More specifically, when a user needs to pivot the back frame 400 forward for collapse, the first sliding sleeve 323 is pulled by the handle operating member 324 via the third traction member 326, so that the first sliding sleeve 323 drives the linkage member 331 and the connecting member 332 to move upward, thereby pulling the first traction member 191, so that the limiting member 120 moves to the non-limit position, enabling the engaging pin 130 to move beyond the limiting member 120.

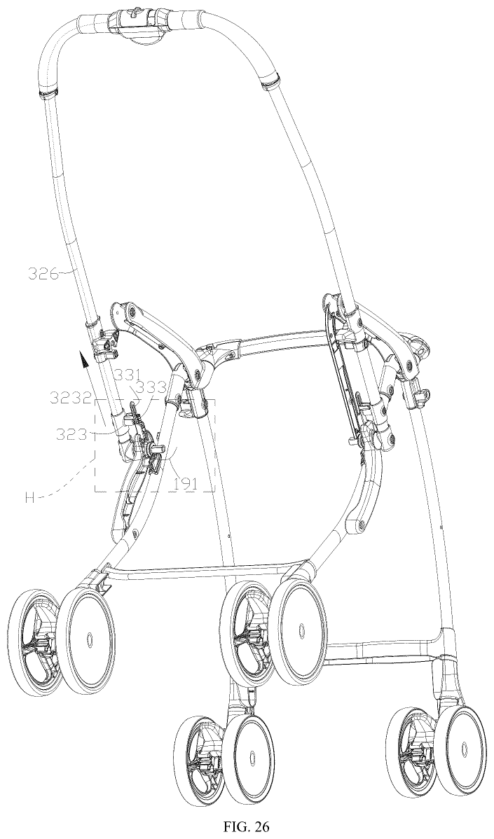

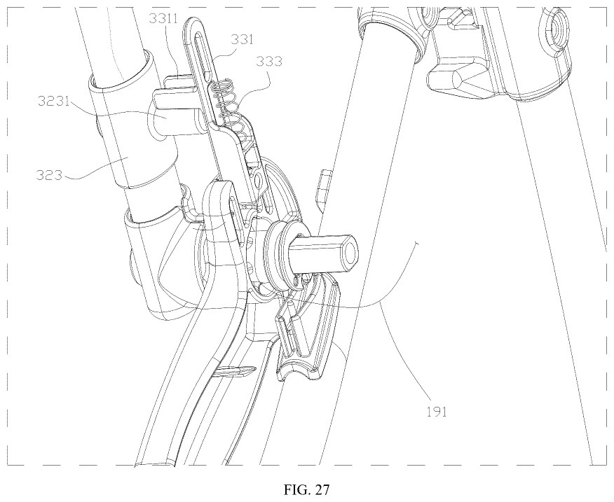

Referring to FIG. 26 to FIG. 27, in a third embodiment, the actuating device is similar to the actuating device in the second embodiment. A difference between the two is that, in the third embodiment, the connector 332 is omitted (see FIG. 25), and the first traction member 191 is directly connected to the linkage member 331. In this way, a structure of the actuating device can be simplified.

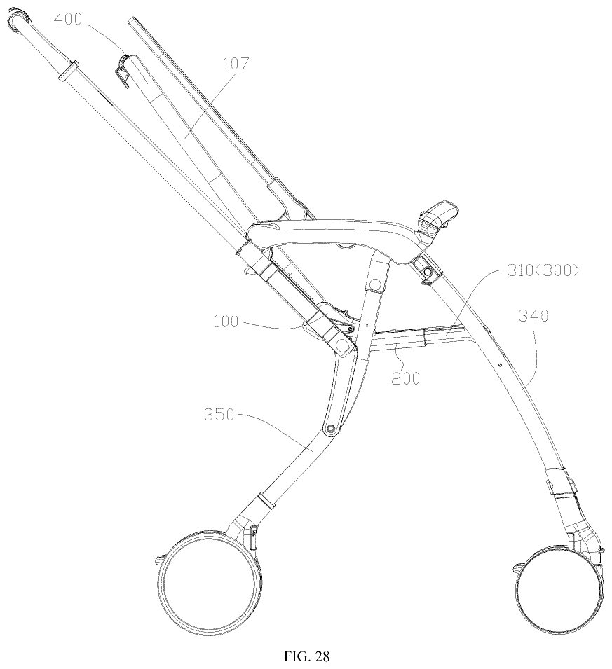

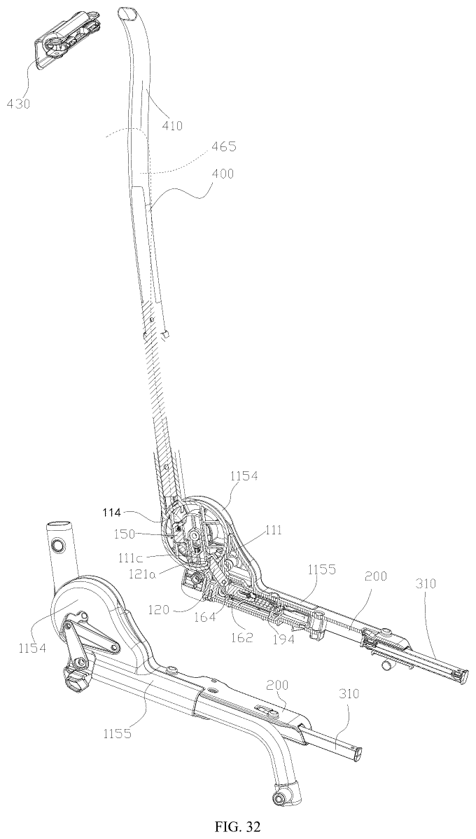

In another embodiment, as shown in FIG. 28 to FIG. 30, the limiting device 100 includes a housing 110 and a limiting member 120 (see FIG. 32). The housing 110 includes a first housing 114 and a second housing 115. The first housing 114 is fastened to the back frame 400, the second housing 115 is fastened to the seat frame 200 and arranged opposite to the first housing 114 along a rotation axis 101, and the first housing 114 can rotate around the rotation axis 101 relative to the second housing 115. In this way, the limiting device 100 realizes relative rotation between the seat frame 200 and the back frame 400.

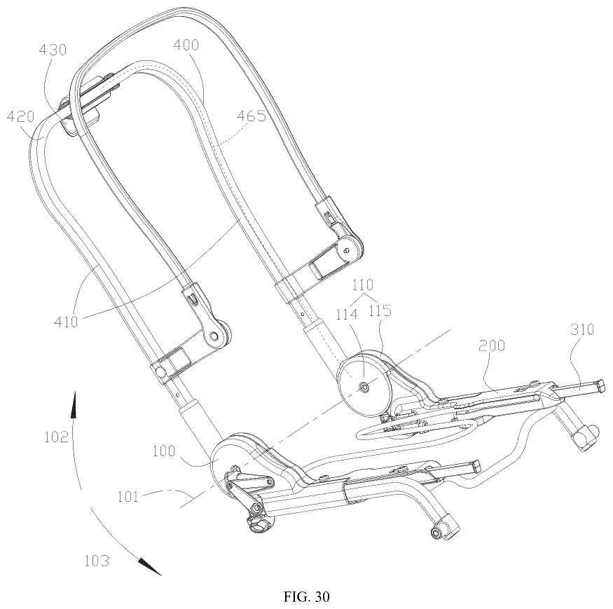

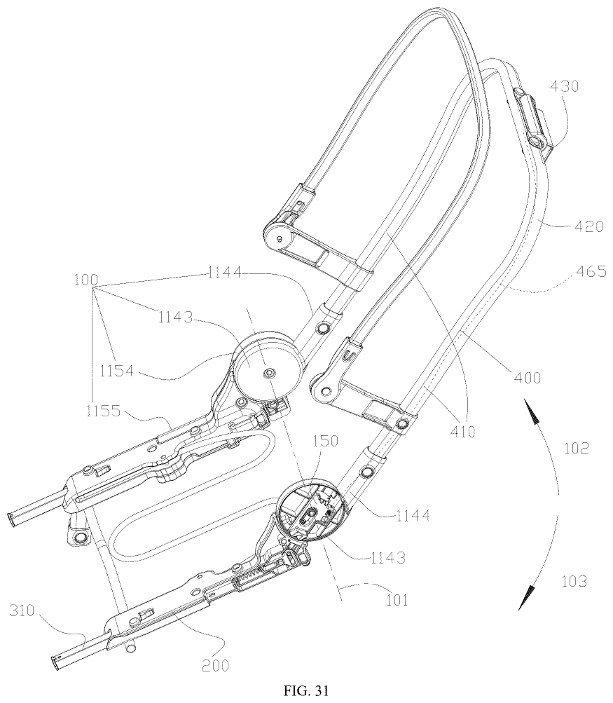

FIG. 30 and FIG. 31 further illustrate two back frame vertical portions 410, a back frame transverse portion 420 connected between top ends of the two back frame vertical portions 410, and a back frame operating member 430 arranged in the middle of the back frame transverse portion 420 that form the back frame 400. FIG. 31 further illustrates a locking member 150 arranged between the first housing 114 and the second housing 115, and the back frame operating member 430 pulls the locking member 150 through the second traction member 465. Structures and operations of the back frame operating member 430 and the locking member 150 will be described in detail later.

A specific structure of the limiting member 120 in this embodiment is described with reference to FIG. 32 to FIG. 34.

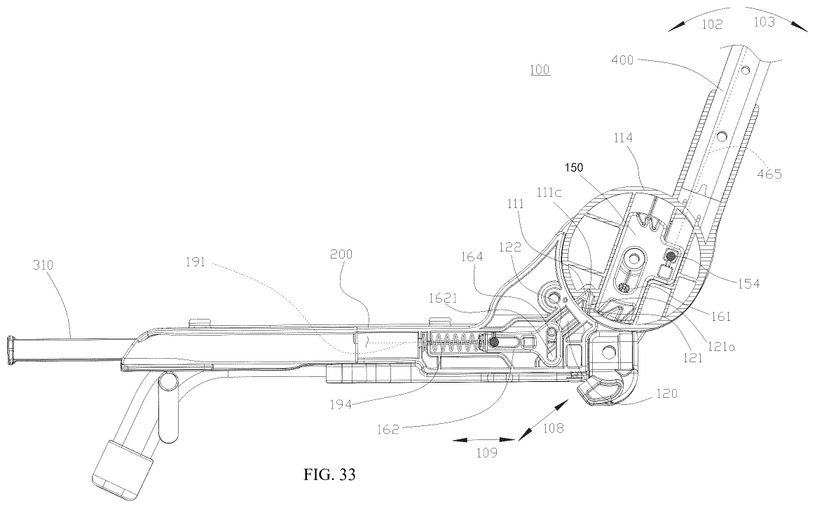

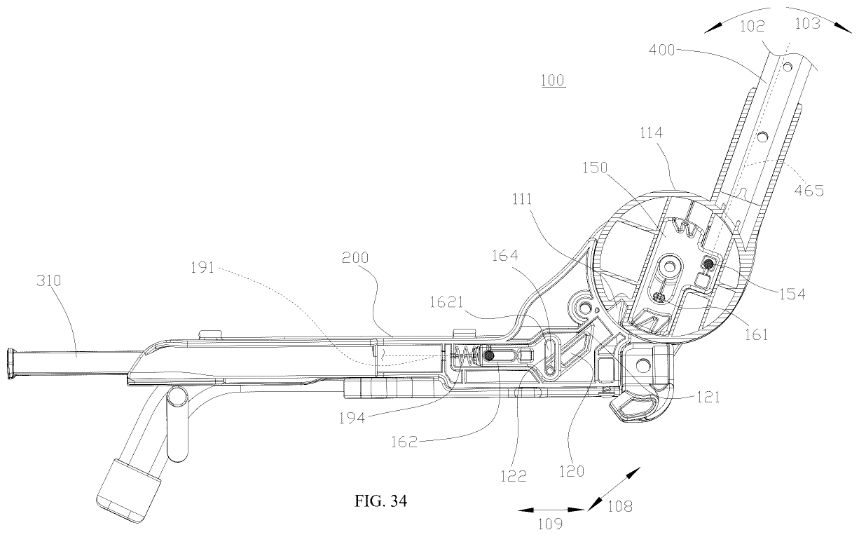

The limiting member 120 is arranged in the second housing 115, and can move between a limit position shown in FIG. 33 and a non-limit position shown in FIG. 34 relative to the second housing 115.

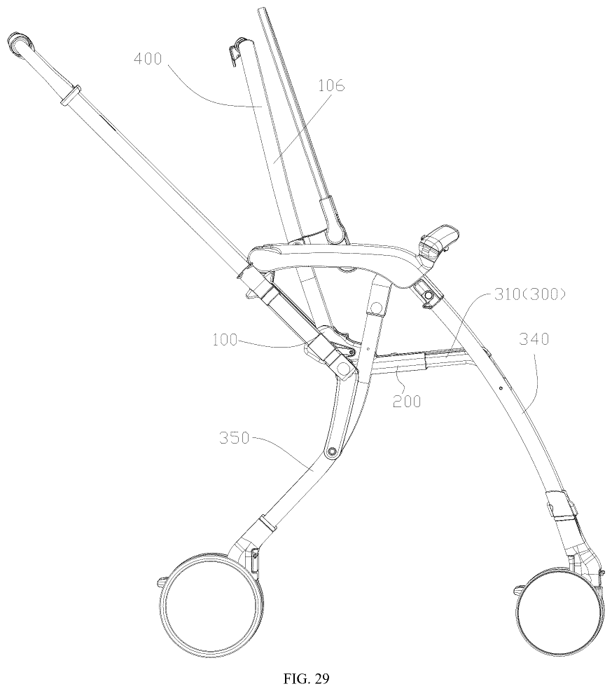

Referring to FIG. 28 and FIG. 29 together, the first housing 114 is provided with a limiting groove 111. When the back frame 400 is at a first rotation position 106 shown in FIG. 29 relative to the seat frame 200, the limiting groove 111 is aligned with the limiting member 120 (as shown in FIG. 33). The limiting member 120 extends into the limiting groove 111 to enter the limit position, and then is engaged with the first housing 114. When the back frame 400 is not at the first rotation position 106 relative to the seat frame 200, for example, at a second rotation position 107 or at any rearward leaning position rotated in a rearward leaning direction beyond the first rotation position 106, the limiting groove 111 is not aligned with the limiting member 120. Therefore, the limiting member 120 abuts against a periphery of the first housing 114, not allowing the limiting member 120 to extend into the limiting groove 111 and enter the limit position.

In an embodiment, the limiting groove 111 is formed radially inward from a circumferential side wall of the first housing 114 and has a radially outward opening.

The limiting member 120 is arranged such that the limiting member 120, when being at the limit position, prevents rotation of the back frame 400 toward the first rotation direction 102 (i.e., the forward leaning rotation direction), but allows rotation of the back frame 400 toward the second rotation direction 103 (i.e., the rearward leaning rotation direction) opposite to the first rotation direction 102.

More specifically, as shown in FIG. 33 and FIG. 34, the limiting member 120 includes a first limiting member end 121 and a second limiting member end 122. The first limiting member end 121 faces the first housing 114 and has a limiting head forward surface 121a inclined rearward relative to the first rotation direction 102. The second limiting member end 122 is opposite to the first limiting member end 121 and away from the first housing 114.

As shown in FIG. 33, when the limiting member 120 has extended to the limiting groove 111, if the back frame 400 rotates toward the second rotation direction 103 (the rearward leaning rotation direction), the first housing 114 abuts against the limiting head forward surface 121a, thereby pushing the limiting member 120 to the non-limit position. In other words, when the user rotates the back frame 400 toward the second rotation direction 103, the limiting member 120 withdraws from the limiting groove 111, and rotation of the back frame 400 is unlocked (certainly, the user further needs to unlock the locking member 150 to rotate the back frame 400, which will be described in detail later). Conversely, when the limiting member 120 has extended to the limiting slot 111, if the user is intended to rotate the back frame 400 toward the first rotation direction 102 (the forward leaning rotation direction), it is not feasible. A reason is that the first housing 114 cannot push the limiting member 120 to the non-limit position, so the limiting member 120 may not unlock the rotation of the back frame 400. More specifically, as shown in FIG. 33, the limiting head forward surface 121a of the limiting member 120 is an inclined surface, and the limiting groove 111 has a corresponding limiting groove slope 111c. The limiting groove slope 111c and the limiting head forward surface 121a have a substantially same inclination angle. When the back frame 400 rotates toward the second rotation direction 103, the limiting groove slope 111c and the limiting head forward surface 121a abut against each other, so that the limiting member 120 automatically withdraws from the limiting groove 111.

In order to unlock the rotation of the back frame 400, the limiting device 100 further includes a driving member 162, a first reset member 194, and an actuating device (not shown).

As shown in FIG. 33 and FIG. 34, the driving member 162 is joined to the second limiting member end 122 of the limiting member 120 away from the first housing 114, and can move along a second sliding direction 109 in the seat frame 200 or the second housing 115, so as to drive the limiting member 120 to the limit position or the non-limit position.

More specifically, the limiting member 120 moves linearly along a first sliding direction 108 perpendicular to the rotation axis 101 (see FIG. 31), and the second sliding direction 109 is perpendicular to the rotation axis 101 and forms an angle with the first sliding direction 108. The driving member 162 includes a driving groove 1621, and the driving groove 1621 is arranged at an end of the driving member 162 close to the limiting member 120 and extends perpendicular to the second sliding direction 109. The limiting device 100 further includes a driving pin 164, and the driving pin 164 is fastened to the second limiting member end 122, extends parallel to the rotation axis 101, and is slidably inserted into the driving groove 1621. In this way, the driving member 162, when moving linearly along the second sliding direction 109, drives, through the driving pin 164, the limiting member 120 to move linearly along the first sliding direction 108.

In order to move the driving member 162, a first reset member 194 is further arranged between the driving member 162 and the second housing 115 to bias the driving member 162 to actuate the limiting member 120 to the limit position.

The actuating device may be arranged on the vehicle frame 300, which is connected to the driving member 162 through the first traction member 191. The actuating device can be configured to actuate the limiting member 120 to the non-limit position via the first traction member 191 and the driving member 162. The actuating device may adopt an existing form in the art, which, for example, may actuate the driving member 162 according to the user's operation (such as an operation of collapsing the vehicle frame 300). An embodiment of the actuating device may be obtained with reference to the actuating device in the previous embodiment. Details are not described herein again.

In addition, in other embodiments, the driving member 162 may alternatively be omitted, and the limiting member 120 is directly actuated through the first traction member 191. In such embodiments, the limiting device 100 further includes a limiting elastic member, and the limiting elastic member is arranged between the limiting member 120 and the second housing 115 to bias the limiting member 120 to the limit position. The actuating device is connected to the limiting member 120 through the first traction member 191. The actuating device can be operated by the user (such as an operation of collapsing the vehicle frame 300) to actuate the limiting member 120 to the non-limit position via the first traction member 191.

Specific structures of the locking member 150, the first housing 114, and the second housing 115 according to the present disclosure are described with reference to FIG. 33 to FIG. 37.

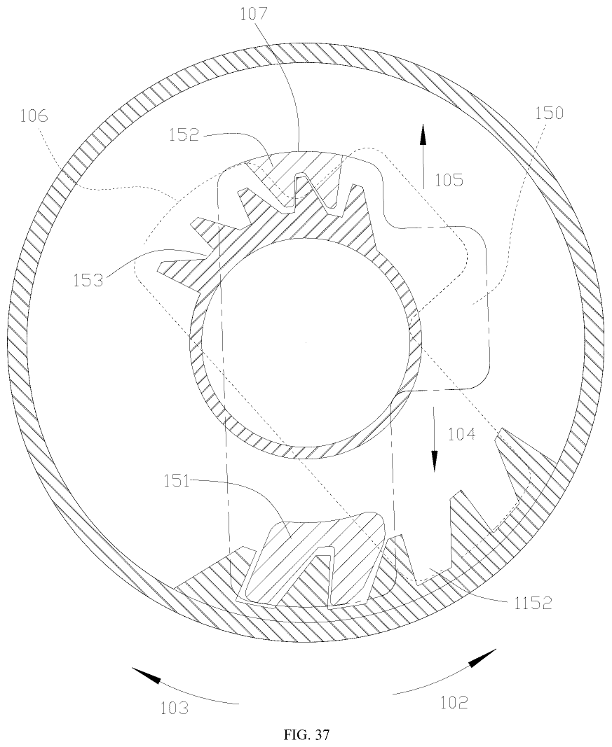

As shown in FIG. 33 and FIG. 34, the locking member 150 is arranged between the first housing 114 and the second housing 115, and can move radially between a lock position and an unlock position. FIG. 37 schematically illustrates a lock direction 104 of the locking member 150 moving toward the lock position and an unlock direction 105 moving toward the unlock position. When the locking member 150 is at the lock position, the locking member 150 prevents relative rotation between the first housing 114 and the second housing 115. When the locking member 150 is at the unlock position, the locking member 150 allows relative rotation between the first housing 114 and the second housing 115.

As shown in FIG. 33 and FIG. 34, a locking reset member 161 is arranged between the first housing 114 and the locking member 150, and the locking reset member 161 biases the locking member 150 to the lock position.

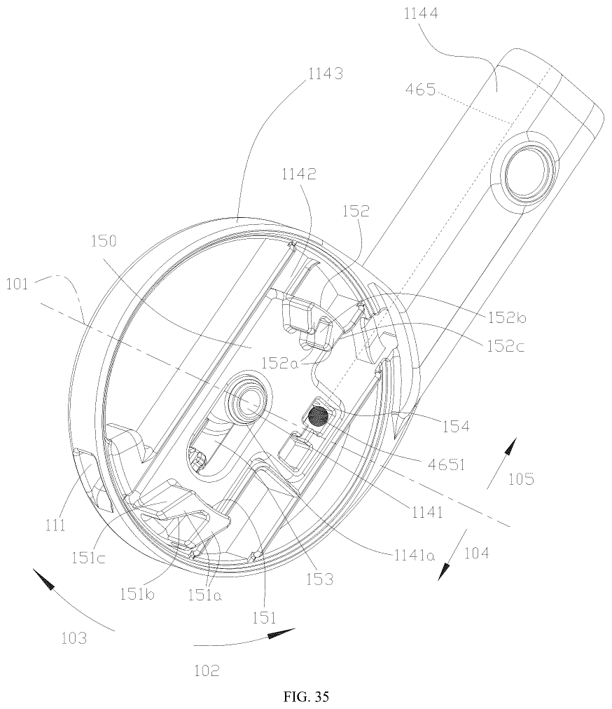

Referring to FIG. 35, the first housing 114 includes a first disc portion 1143, a first rod portion 1144, a limiting groove 111, a first shaft hole 1141, and a sliding groove 1142. The first disc portion 1143 is formed in a shape of a disc with an axial end closed. The first rod portion 1144 extends from a periphery of the first disc portion 1143 and is fastened to the first object.

The sliding groove 1142 is formed on an axial inner side of the first housing 114 and extends radially. The locking member 150 is located in the sliding groove 1142, and rotates around the rotation axis 101 together with the first housing 114. In this embodiment, the sliding groove 1142 is, for example, a key groove. In other embodiments, the sliding groove 1142 may alternatively be formed in another appropriate shape according to a shape of the locking member 150, for example, formed as one or more linear tracks.

More specifically, the first shaft hole 1141 is arranged in the sliding groove 1142, and the first shaft hole 1141 penetrates the first housing 114 along the rotation axis 101. A first shaft hole wall 1141a rises inward from the axial inner side of the first housing 114 and is a columnar wall.

The locking member 150 includes an elongated hole 153, the elongated hole 153 is arranged in a radial middle of the locking member 150 and extends radially, and the elongated hole 153 arranged around the first shaft hole wall 1141a.

As shown in FIG. 33 and FIG. 34, the limiting device 100 further includes a locking reset member 161. The locking reset member 161 is arranged in the elongated hole 153, with two ends respectively abutting against the first shaft hole wall 1141a and an end of the elongated hole 153 to bias the locking member 150 to the lock position. Since the locking reset member 161 is arranged in the locking member 150, the limiting device 100 is allowed to have a compact structure.

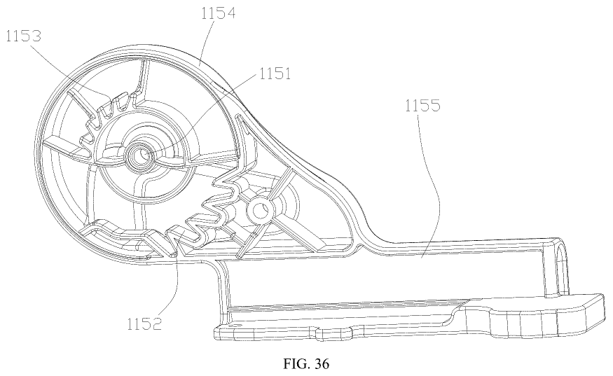

The specific structure of the second housing 115 is described with reference to FIG. 36. The second housing 115 includes a second disc portion 1154, a second rod portion 1155, a second shaft hole 1151, at least one first locking groove 1152, and at least one second locking groove 1153.

The second disc portion 1154 is formed in a shape of a disc with an axial end closed. The second rod portion 1155 extends from a periphery of the second disc portion 1154 and is fastened to the second object. The first disc portion 1143 and the second disc portion 1154 are rotatably fastened to each other around the rotation axis 101 to form a cylindrical box-shaped structure with two closed axial ends. The cylindrical box-shaped structure with two ends closed is conducive to a tidy appearance of the limiting device 100. However, this is not necessary, and the limiting device 100 may alternatively include a closed or non-closed structure in another shape.

The second shaft hole 1151 is provided at a center of the second disc portion 1154. The first locking groove 1152 is close to an inner side of a periphery of the second disc portion 1154. The second locking groove 1153 is located between the periphery of the second disc portion 1154 and the second shaft hole 1151, and is substantially radially opposite to the first locking groove 1152.

In order to lock a plurality of rotation positions between the first housing 114 and the second housing 115 (including the first rotation position 106 and the second rotation position 107), the second housing 115 is provided with a plurality of first locking grooves 1152 arranged circumferentially and a plurality of second locking grooves 1153 arranged circumferentially.

Positions of the first locking groove 1152 and the second locking groove 1153 are arranged such that, when the back frame 400 is at the first rotation position 106 and when the back frame 400 is at at least one second rotation position 107 in the second rotation direction 103, a first locking portion 151 and a second locking portion 152 of the locking member 150 can be respectively engaged with the first locking groove 1152 and the second locking groove 1153 that are different (as shown in FIG. 37).

Referring to FIG. 35, the locking member 150 includes a first locking portion 151, a second locking portion 152, an elongated hole 153, and a fixed portion 154 at a first end of the second traction member.

The first locking portion 151 is located at a first end of the locking member 150. The second locking portion 152 is located at a second end of the locking member 150 opposite to the first end. When the locking member 150 is at the lock position, the first locking portion 151 and the second locking portion 152 are respectively engaged with the first locking groove 1152 and the second locking groove 1153 of the second housing 115, so as to lock relative rotation between the first housing 114 and the second housing 115.

More specifically, the first locking portion 151 includes at least one first locking tooth 151a rising axially inward from the first end and extending toward the lock direction 104. The second locking portion 152 includes at least one second locking tooth 152a rising axially inward from the second end and extending toward the lock direction 104. When the locking member 150 is at the lock position, the first locking tooth 151a is inserted into the at least one first locking groove 1152, and the second locking tooth 152a is inserted into the at least one second locking groove 1153.

In this embodiment, the locking member 150 has two first locking teeth 151a and two second locking teeth 152a, so that the locking member 150 can be stably engaged with the second housing 115. However, this is not necessary, and the locking member 150 may have only one first locking tooth 151a and one second locking tooth 152a.

The first locking tooth 151a and the second locking tooth 152a respectively formed as ratchet teeth. More specifically, each first locking tooth 151a includes a first forward surface 151b and a first rearward surface 151c, and each second locking tooth 152a includes a second forward surface 152b and a second rearward surface 152c. Both the first forward surface 151b and the first rearward surface 151c are inclined rearward along the first rotation direction 102. When the locking member 150 rotates toward the first rotation direction 102 (i.e., the forward leaning rotation direction) with the first housing 114, since the first forward surface 151b and the second forward surface 152b that are inclined abut against the first locking groove 1152 and the second locking groove 1153, the locking member 150 automatically slides toward the unlock direction 105 to the unlock position. When the locking member 150 tends to rotate toward the second rotation direction 103 (i.e., the rearward leaning rotation direction), since the first rearward surface 151c and the second rearward surface 152c are not inclined, the locking member 150 may not automatically slide to the unlock position.

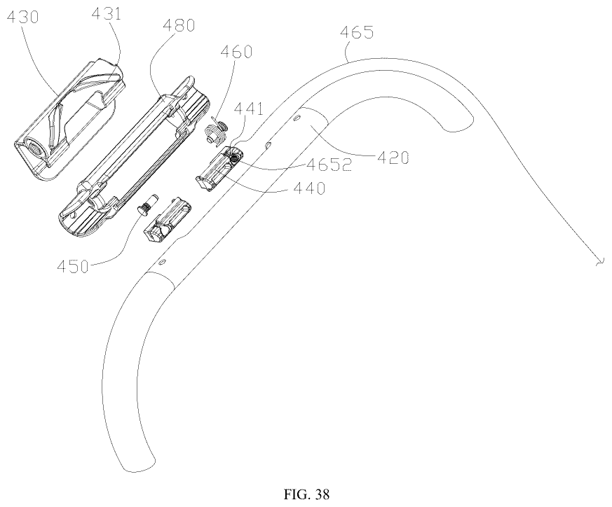

The locking member 150 may move to the unlock position according to the user's operation. Specifically, the back frame 400 is provided with, for example, a second traction member 465 which is a cable, and the second traction member 465 is fixedly connected to the locking member 150. The second traction member 465 includes a second traction member first end 4651 and a second traction member second end 4652 (as shown in FIG. 38) respectively connected to the fixed portion 154 of the locking member 150 and a fixed portion 441 (see FIG. 38) of the second traction member second end arranged on the back frame transverse portion 420 of the back frame 400. The user may control movement of the locking member 150 through the back frame operating member 430 via the second traction member 465.

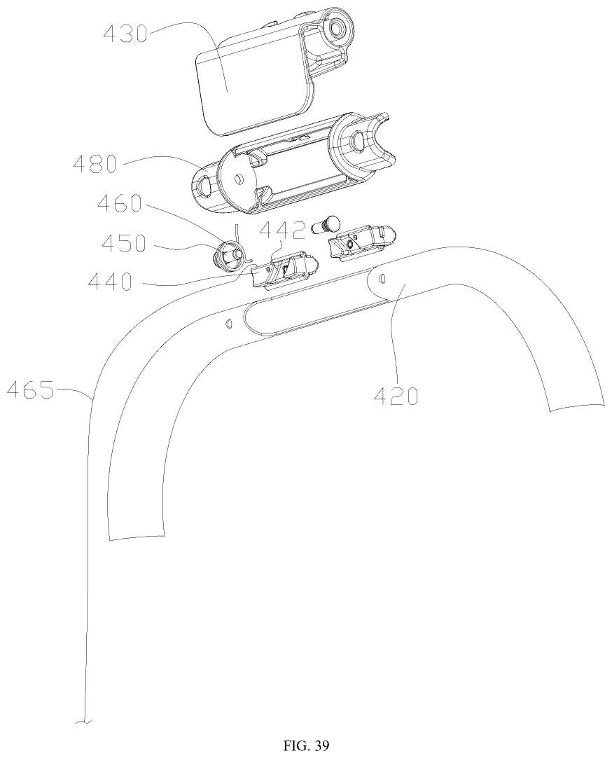

Referring to FIG. 38 and FIG. 39, specific structures of the back frame operating member 430 and related components thereof are substantially the same as that of the back frame operating member 430 in the previous embodiment. Details are not described herein again.

The above limiting device 100 has at least the following technical effect.

In the above limiting device 100, the limiting device 100 includes the housing 110 and the limiting member 120 that are arranged between the first object and the second object. Through the at least one limiting groove 111 arranged on the housing 110, the limiting member 120 can move between the limit position and the non-limit position. The limiting member 120, when being at the limit position, can limit unidirectional rotation of the first object relative to the second object, thereby limiting an angle of rotation of the first object relative to the second object, so as to prevent excessive forward leaning of the back frame 400.

As shown in FIG. 40 to FIG. 42, in yet another embodiment, the child carrier 1 further includes a limiting block 500.

In the following, structures and action principles of the limiting block 500 and related components are specifically described by taking a side of the child carrier 1 as an example.

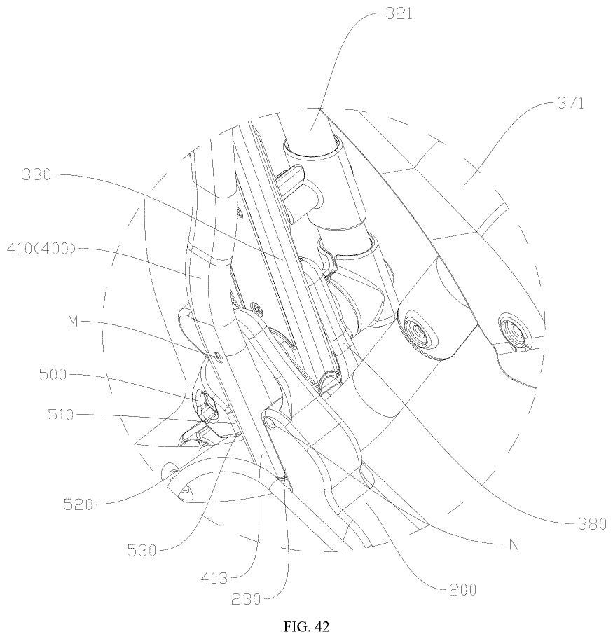

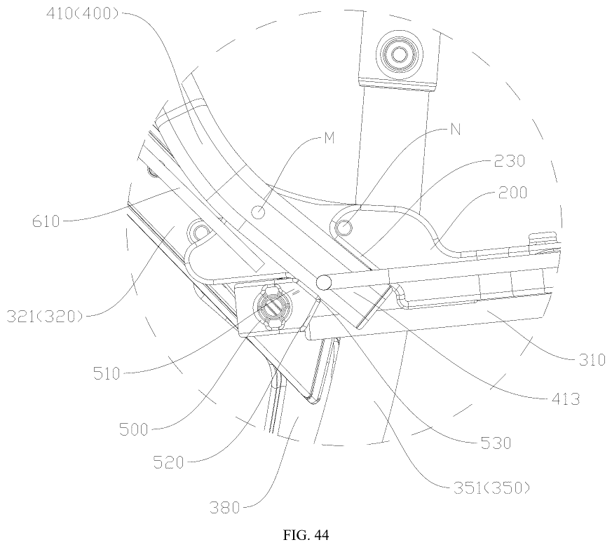

As shown in FIG. 42 to FIG. 44, the limiting block 500 is fastened to the vehicle frame 300. In this embodiment, the limiting block 500 is fastened to an opposite rear end of the seat tube 310. As shown in FIG. 44, the limiting block 500 has a first end face 510 and a second end face 520 that face a front end of the vehicle frame 300. In this embodiment, the first end face 510 and the second end face 520 are respectively two slopes with different extension directions, and a side of the first end face 510 and a side of the second end face 520 meet to form a bulge 530. In other words, the limiting block 500 has the bulge 530 extending toward a movable end 413 (see details later) of the back frame 400, and the bulge 530 may have an acute angle, an obtuse angle, or a rounded chamfer. A shape of the bulge 530 is not limited in the present disclosure.

Certainly, in other embodiments, only one of the first end face 510 and the second end face 520 of the limiting block 500 may be a slope. In detail, in an embodiment, the first end face 510 may be a vertical surface substantially perpendicular to the seat tube 310. That is, an extension direction of the first end face 510 is substantially perpendicular to that of the seat tube 310. The second end face 520 is an inclined surface, and is inclined at a specific angle relative to the first end face 510 (the vertical surface). In another embodiment, at least one of the first end face 510 and the second end face 520 may alternatively be an arc-shaped surface. In another embodiment, a side of the limiting block 500 facing the seat frame 200 may alternatively not have the first end face 510 and the second end face 520, but directly form an entire arc-shaped surface. Accordingly, in the present disclosure, the shape of the limiting block 500 is not limited, provided that the movable end 413 can be pushed.

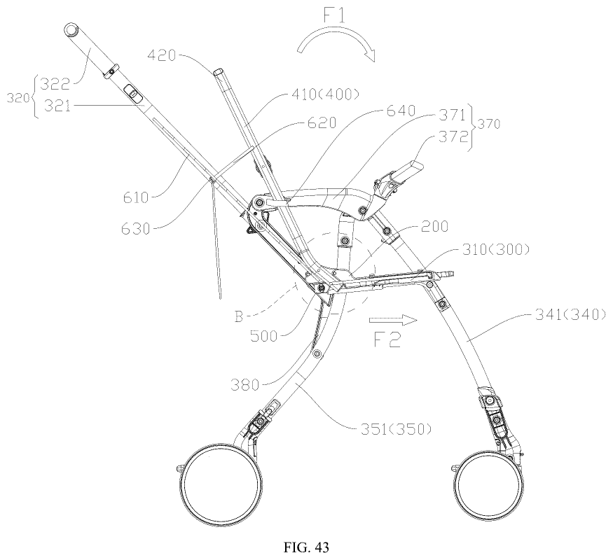

Specifically, as shown in FIG. 43 and FIG. 44, the seat frame 200 is movably sleeved on the seat tube 310, and may move relative to the limiting block 500 along the seat tube 310. In detail, when the handle frame 320 pivots relative to the seat tube 310, the seat frame 200 may be linked to move away from or close to the limiting block 500. In this embodiment, the seat frame 200 has a clamping portion 230 arranged opposite to the limiting block 500.

Referring to FIG. 40 and FIG. 41 again, as described above, the back frame 400 includes two back frame vertical portions 410 and a back frame transverse portion 420 connected between top ends of the two back frame vertical portions 410. The back frame 400 is pivotably mounted on the vehicle frame 300, so as to be rotatable relative to the vehicle frame 300. Specifically, as shown in FIG. 42 to FIG. 44, the back frame vertical portion 410 is pivotally connected to the seat frame 200 on the corresponding side through a first rotating shaft M. Accordingly, the back frame vertical portion 410 may pivot around the first rotating shaft M in a direction F1 or in an opposite direction relative to the vehicle frame 300 (or relative to the seat body 660).

Further, as shown in FIG. 43 and FIG. 44, an end of the back frame vertical portion 410 away from the back frame transverse portion 420 is the movable end 413, and the movable end 413 is located between the limiting block 500 and the clamping portion 230 of the seat frame 200. When the vehicle frame 300 is in the unfolded state, two sides of the movable end 413 respectively abut against the limiting block 500 (specifically the first end face 510) and the clamping portion 230. In this way, the back frame 400 may be inclined relative to a vertical reference plane passing through the first rotating shaft M, and an inclination angle between an extension direction of the back frame 400 and the vertical reference plane may be fixed through the limiting block 500 and the clamping portion 230, thereby preventing a potential safety hazard caused by forward leaning of the back frame 400 due to failure of fixed limiting. Accordingly, through the arrangement of the limiting block 500 and cooperation with the seat frame 200, the back frame 400 of the child carrier 1 can be obliquely fixed and limited when the vehicle frame 300 is in the unfolded state.

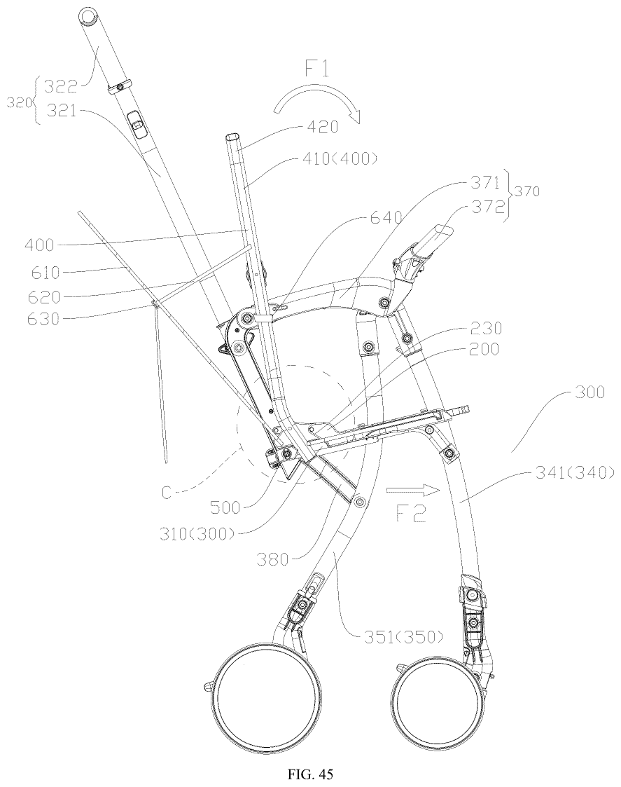

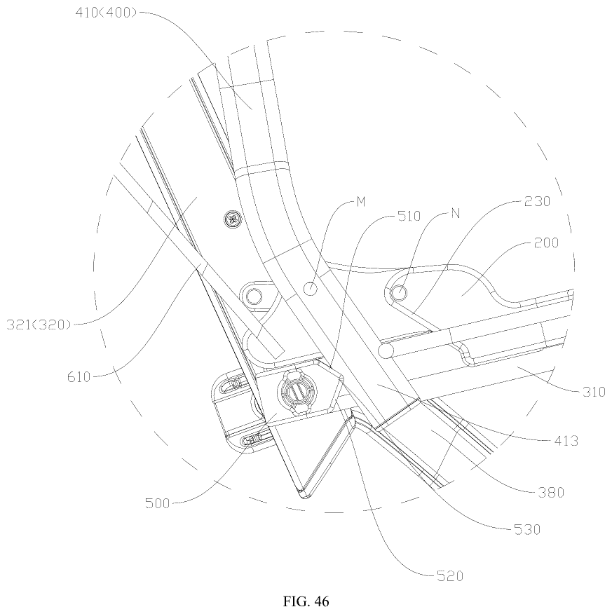

In addition, when the vehicle frame 300 is collapsed, the back frame 400 may be linked with rotation of the handle frame 320 of the vehicle frame 300 to approach the handle frame 320 so as to facilitate the folding of the vehicle frame 300. As shown in FIG. 45 and FIG. 46, during switching of the vehicle frame 300 from the unfolded state to the folded state, the handle frame 320 pivots in the direction F1, which may move the seat frame 200 along the seat tube 310 in a direction F2 to be away from the limiting block 500. A detailed structure and actuation for linking the handle frame 320 with the seat frame 300 will be described later.

As shown in FIG. 45 and FIG. 46, when the vehicle frame 300 is collapsed, since the seat frame 200 moves along the seat tube 310 in the direction F2, the clamping portion 230 is separated from the movable end 413. In other words, the clamping portion 230 no longer abuts against the movable end 413, thereby no longer having a limiting effect on the movable end 413. On the other hand, the rotation of the handle frame 320 may also drive the seat tube 310 to pivot toward the handle frame 320 (toward the back). Rotation of the seat tube 310 may drive the limiting block 500 to rotate. Since the limiting block 500 is arranged adjacent to the movable end 413, during the collapse of the vehicle frame 300, the bulge 530 of the limiting block 500 may continuously push the movable end 413 to pivot relative to the seat frame 200, and assist the back frame 400 to pivot relative to the vehicle frame 300 and be collapsed. Specifically, during the collapse of the vehicle frame 300, the limiting block 500 may continuously push against the movable end 413, so that the back frame transverse portion 420 rotates, together with the back frame vertical portion 410, around the first rotating shaft M toward the handle frame 320 to move closer to the handle frame 320, which is convenient for the collapse of the vehicle frame 300.

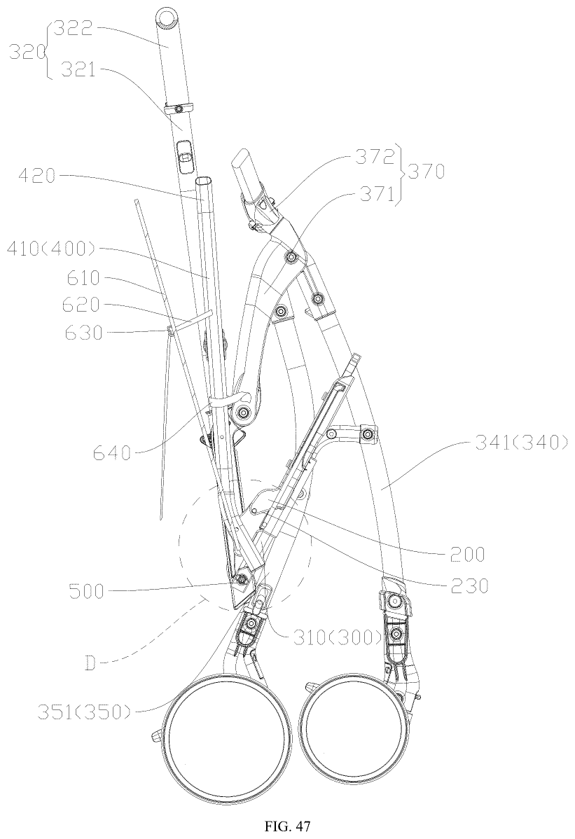

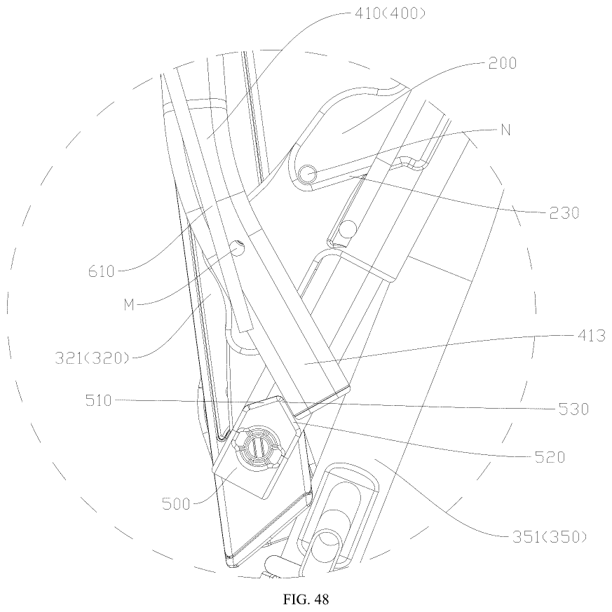

Referring to FIG. 47 and FIG. 48, when the vehicle frame 300 is in the folded state, the second end face 520 of the limiting block 500 abuts against the movable end 413. It is worth mentioning that, when the vehicle frame 300 is in the folded state, the limiting block 500 can also limit the pivoting of the movable end 413, thereby preventing movement of the back frame 400 (or the back frame transverse portion 420) away from the handle frame 320. Accordingly, when the vehicle frame 300 is collapsed, the limiting block 500 may limit the rotation of the back frame 400, preventing interference with the armrest frame 370 due to the rotation of the back frame 400 toward the direction of the armrest frame 370 (i.e., the direction F1, see FIG. 45).

In other words, when the vehicle frame 300 is in the unfolded state and the folded state, the movable end 413 abuts against different parts of the limiting block 500 respectively. The movable end 413 abuts against an upper half part (the first end face 510) of the limiting block 500 when the vehicle frame 300 is in the unfolded state, while the movable end 413 abuts against a lower half part (the second end face 520) of the limiting block 500 when the vehicle frame 300 is in the folded state.

In addition, as described above, the handle frame 320, after being unlocked, may rotate toward the direction F1 to drive the seat frame 200 to move in the direction F2 to be separated from the movable end 413, so as to fold the vehicle frame 300 or change the forward direction of the child carrier 1. However, if the handle frame 320 is misoperated and unlocked, the movable end 413 of the back frame 400 cannot be clamped between the limiting block 500 and the seat frame 200 and be fixed and limited.

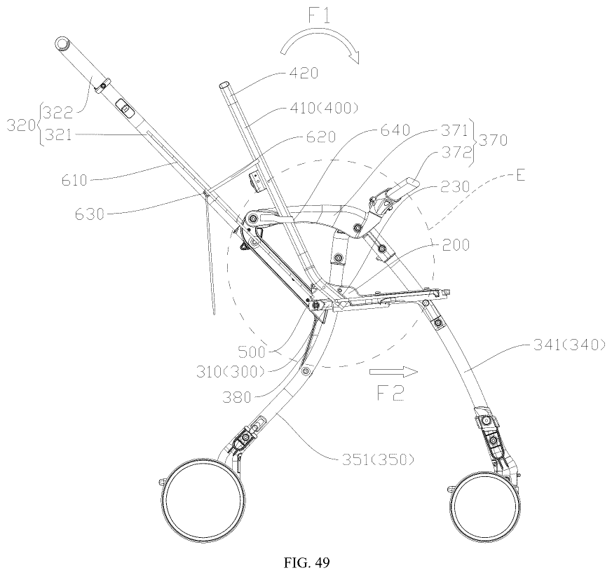

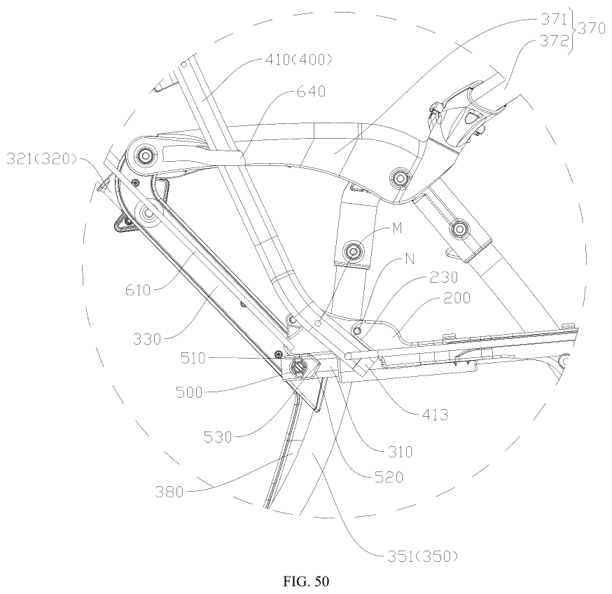

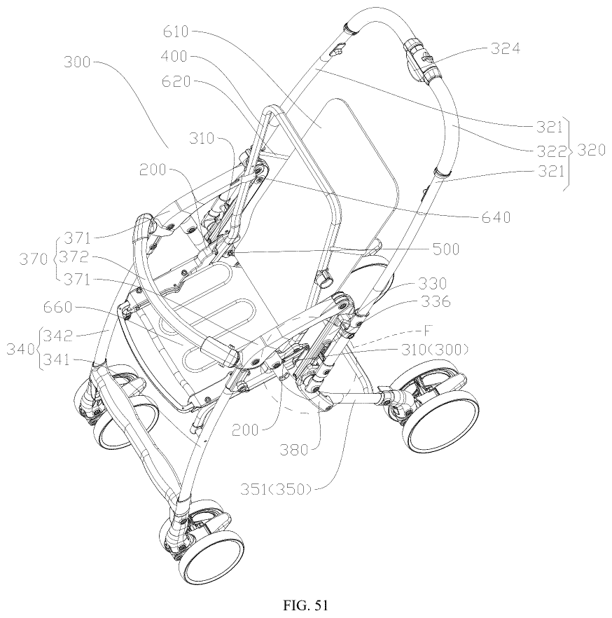

Referring to FIG. 49 and FIG. 50, the child carrier 1 further includes a backrest plate 610. The backrest plate 610 is arranged in a manner of being rotatable relative to the back frame 400, so that an inclination angle of the backrest plate 610 can be adjusted properly. Specifically, the seat frame 200 may be covered with a flexible layer of seat cloth (not shown in the figure), and the backrest plate 610 and the seat cloth may be integrated by sleeving. Since the backrest plate 610 is plate-shaped and has a certain thickness, the backrest plate 610 can rotate relative to the back frame 400. The backrest plate 610 in this embodiment is not pivotally connected to the seat frame 200 or the seat tube 310, but configured in another manner.

Referring to FIG. 49 together with FIG. 40, further, the child carrier 1 may also include an adjustment harness 620. An end of the adjustment harness 620 is fastened to one back frame vertical portion 410, and another end of the adjustment harness 620 bypasses the backrest portion 610 and is fastened to the other back frame vertical portion 410. A length of the adjustment harness 620 is adjustable, and an inclination angle of the backrest plate 610 relative to the back frame 400 can be adjusted by adjusting the length of the adjustment harness 620.

Further, in this embodiment, the child carrier 1 may further include an adjustment buckle 630, and the adjustment buckle 630 has two buttonholes (not shown in the figure). A roughly middle part of the adjustment harness 620 is threaded through the two buttonholes. By pulling out part of the length of the adjustment harness 620 from the two buttonholes, a length from two ends of the adjustment harness 620 to the adjustment buckle 630 can be shortened, and a degree of inclination of the backrest plate 610 can be reduced. Conversely, by moving the adjustment buckle 630 away from the backrest plate 610, the length from the two ends of the adjustment harness 620 to the adjustment buckle 630 can be extended, and the degree of inclination of the backrest plate 610 can be increased. Certainly, in other embodiments, the length of the adjustment harness 620 may alternatively be adjusted in other manners. For example, the roughly middle part of the adjustment harness 620 may be provided with a plurality of Velcro loops and Velcro hooks, and the length of the adjustment harness 620 can be adjusted by fitting different Velcro loops and Velcro hooks.

As shown in FIG. 49 and FIG. 50, the child carrier 1 of this embodiment may further include a tie-down member 640, and two ends of the tie-down member 640 are respectively connected to the armrest frame 370 and the back frame 400, to prevent an influence on safety of an infant still riding on the child carrier 1 due to rotation of the back frame 400 around the first rotating shaft M in the direction F1 to a vertical or forward leaning state. In detail, the tie-down member 640 of this embodiment is connected to an armrest connector 371 and the back frame vertical portion 410.

When the handle frame 320 is reversed or the handle frame 320 is accidentally unlocked and rotated, the seat frame 200 may move along the direction F2, and drive the movable end 413 to move forward at the same time. The seat frame 200 moves forward to be separated from the limiting block 500, thereby creating a space to enable the movable end 413 to pivot, and the limiting block 500 may no longer abut against the movable end 413, so the movable end 413 may pivot. In this case, the tie-down member 640 connected between the armrest connector 371 and the back frame vertical portion 410 can tie down and limit the armrest connector 371 to prevent pivoting of the movable end 413, thereby preventing a potential safety hazard caused by the pivoting of the back frame 400 to the vertical or forward leaning state. In this embodiment, the tie-down member 640 is a webbing. The webbing is light in weight, cheap, and easily available. At the same time, since the webbing has a flexible structure, it is easy to bend and fold with the folding of the entire vehicle frame 300. Certainly, in other embodiments, the tie-down member 640 may alternatively be made of a material such as a steel wire or a belt.

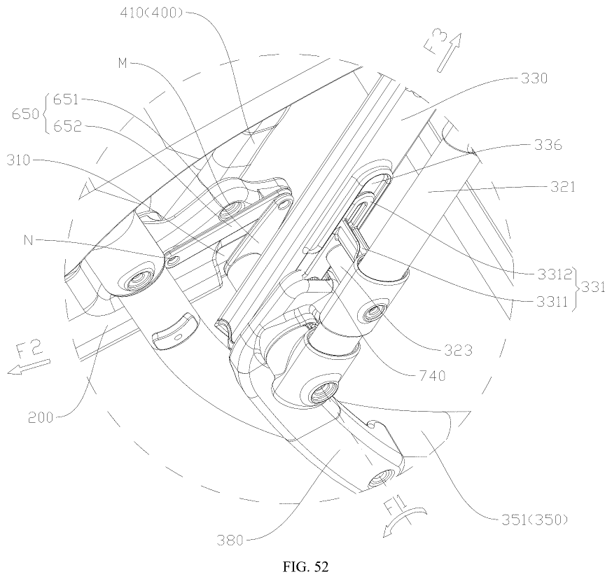

Referring to FIG. 51 and FIG. 52, a linkage mechanism between the handle frame 320 and the seat frame 200 is further described below. Specifically, as shown in FIG. 52, the child carrier 1 of this embodiment further includes a linkage assembly 650 connected to the handle frame 320 and the seat frame 200, thereby driving the seat frame 200 to move when the handle frame 320 rotates. The linkage assembly 650 includes a first connecting rod 651 and a second connecting rod 652 pivotally connected to each other. An end of the first connecting rod 651 away from the second connecting rod 652 is pivotally connected to the seat tube 310. An end of the second connecting rod 652 away from the second connecting rod 651 is pivotally connected to the seat tube 200 through a second rotating shaft N.

In addition, as shown in FIG. 51 to FIG. 52, the handle frame 320 is a substantially U-shaped member formed by two handle vertical frames 321 and a handle transverse frame 322 connected between upper ends of the two handle vertical frames 321. The handle frame 320 is configured in a manner of being pivotable relative to the seat tube 310. In detail, ends of the two handle vertical frames 321 of the handle frame 320 away from the handle transverse frame 322 are respectively pivotally connected to two seat tubes 310. The handle frame 320 is operable to drive overall folding of the vehicle frame 300. In addition, in this embodiment, the handle frame 320 may be pivoted from a first position to a second position relative to the seat tube 310, so as to change the forward direction of the child carrier 1.

Further, rotation of the handle vertical frame 321 of the handle frame 320 may drive the first connecting rod 651 to rotate. Specifically, when the handle frame 320 rotates toward the direction F1, the first connecting rod 651 is driven to rotate in the direction F1 along with the handle vertical frame 321, so that the first connecting rod 651 pushes the seat frame 200 to move in the direction F2 through the second connecting rod 652, that is, move toward a front side of the vehicle frame 300, so as to adjust a position of the seat frame 200. Referring to FIG. 51 and FIG. 52, in this embodiment, an auxiliary frame 330 and a linkage frame 380 are further arranged between the armrest frame 320 and the first connecting rod 651. The auxiliary frame 330 is roughly in a shape of a rod, and the auxiliary frame 330 has an end portion connected between the linkage frame 380 and the seat tube 310 and the other end portion pivotally connected to the armrest connector 371 of the armrest frame 370.

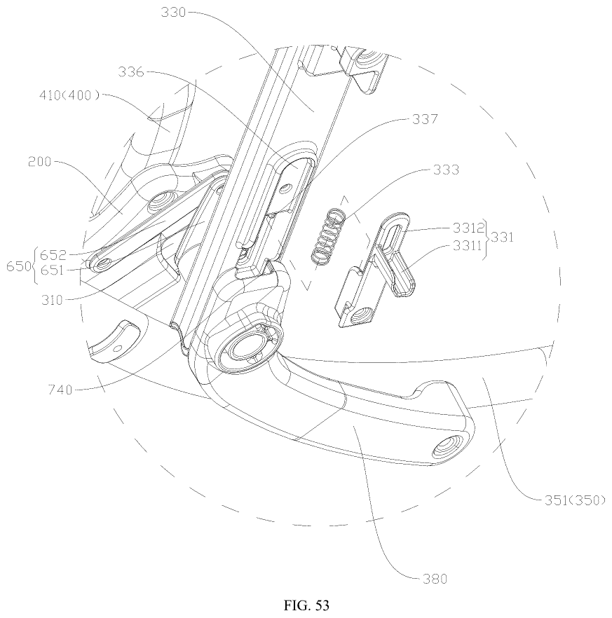

Referring to FIG. 52 and FIG. 53, the linkage frame 380 has a roughly L-shaped rod structure, and the linkage frame 380 has an end pivotally connected to the end portion of the auxiliary frame 330 away from the armrest connector 371 and another end pivotally connected to a first rear leg support rod 351 (see details later). The handle frame 320 is pivotally connected to the linkage frame 380. Referring to FIG. 53, in this embodiment, the handle vertical frame 321, the linkage frame 380, and the auxiliary frame 330 are pivotally connected to an opposite rear end of the seat tube 310.

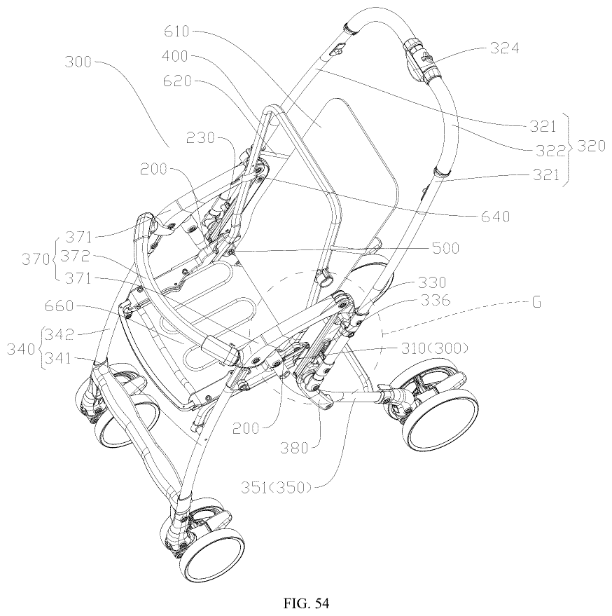

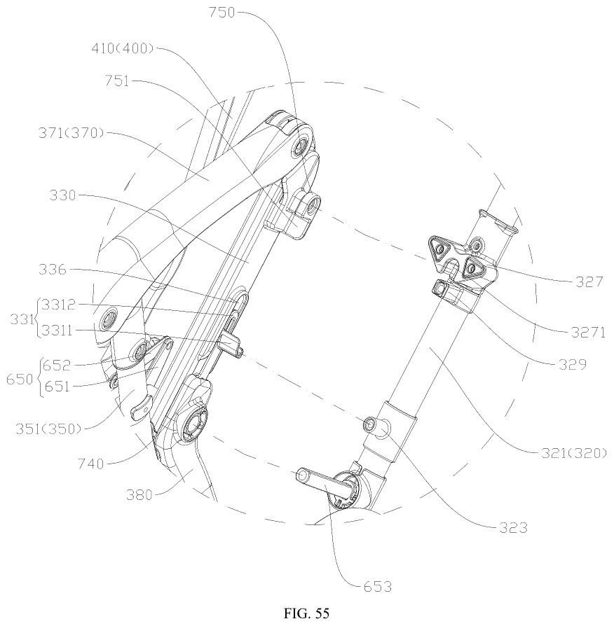

Referring to FIG. 54 and FIG. 55, the linkage assembly 650 of this embodiment further includes a pivot pin 653. Specifically, an end of the pivot pin 653 is fastened to an end of the handle vertical frame 321 away from the handle transverse frame 322 (i.e., a lower end of the handle vertical frame 321), and another end of the pivot pin 653 sequentially passes through the linkage frame 380, the auxiliary frame 330, and an end of the first connecting rod 651 away from the second connecting rod 652. Moreover, the linkage frame 380, the auxiliary frame 330, and the first connecting rod 651 are all fastened to the pivot pin 653. The pivot pin 653 may be arranged through a roughly middle part of the limiting block 500. Certainly, in other embodiments, the pivot pin 653 may alternatively not pass through the limiting block 500. In addition, the handle vertical frame 321 may be pivotally connected to the seat tube 310 through the pivot pin 653. During the folding of the vehicle frame 300, the linkage frame 380, the auxiliary frame 330, the first connecting rod 651, and the seat tube 310 can be driven with the rotation of the handle vertical frame 321.

As shown in FIG. 55, in this embodiment, the pivot pin 653 is a square pin with a rectangular cross section. Certainly, in other embodiments, the pivot pin 653 may alternatively be a pin shaft with a cross section in other shapes. In this way, the handle vertical frame 321 of the handle frame 320 is pivotally connected to the seat tube 310 through the pivot pin 653, and may drive the linkage frame 380, the auxiliary frame 330, and the first connecting rod 651 to rotate.

In detail, when the handle frame 320 is unlocked to fold the vehicle frame 300, the handle vertical frame 321 rotates in a direction close to the seat body 660, and the handle vertical frame 321 drives the linkage frame 380 and the auxiliary frame 330 through the pivot pin 653, thereby driving the folding of the seat tube 310 and the armrest frame 370. In addition, the handle vertical frame 321 further drives the first connecting rod 651 through the pivot pin 653, so that the first connecting rod 651 pushes, through the second connecting rod 652, the seat frame 200 to move along the seat tube 310, thereby adjusting the position of the seat frame 200 during the folding.

In addition, when the handle frame 320 is only unlocked to be pushed to switch from the rearward leaning state in FIG. 54 to the forward leaning state (not shown in the figure), the child carrier 1 realizes reversing of the handle frame 320. That is, a traveling direction of the child carrier 1 in this case is opposite to that before the switching. When the child carrier 1 travels, the first rear leg support rod 351 (see details later) is located in front of a first front leg support rod 341 (see details later). Certainly, unless otherwise specified, “front” and “rear” described below in the present disclosure refer to a traveling direction prior to handle reversing shown in FIG. 51.

Referring to FIG. 54, the front leg support frame 340 includes a first front leg support rod 341 and a second front leg support rod 342 on left and right sides of the seat body 660. The rear leg support frame 350 also includes a first rear leg support rod 351 and a second rear leg support rod 352 (see FIG. 22) on the left and right sides of the seat body 660. The first front leg support rod 341 and the first rear leg support rod 351 are arranged at an angle. Taking a side of the child carrier 1 as an example, an end of the first front leg support rod 341 and an end of the first rear leg support rod 351 are both pivotally connected to an opposite front end of the armrest connector 371. In addition, the other ends of the first front leg support rod 341 and the first rear leg support rod 351 away from the armrest connector 371 are both connected to a wheel.

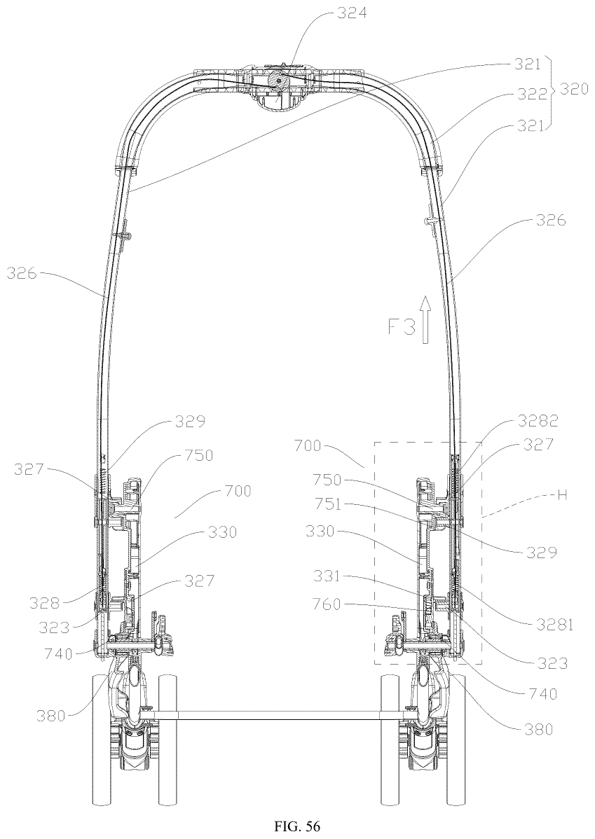

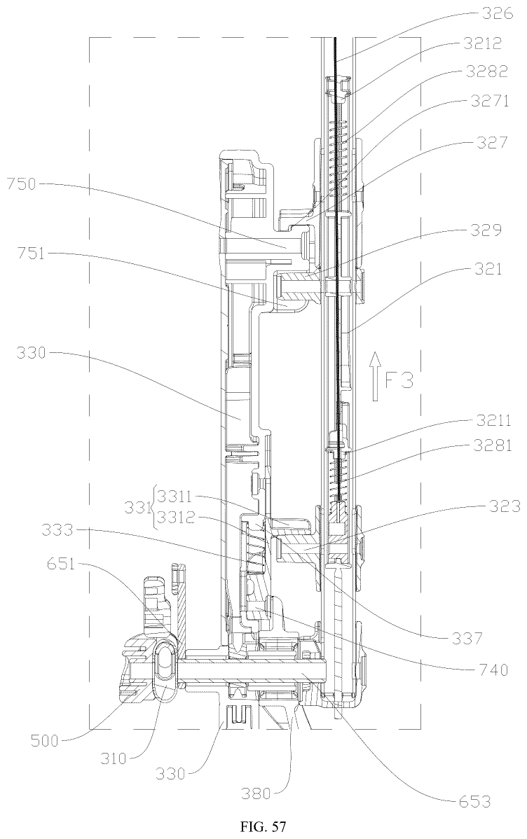

Referring to FIG. 55 together with FIG. 56 and FIG. 57, the child carrier 1 further includes a locking mechanism 700. The locking mechanism 700 includes the first sliding sleeve 323 and the linkage member 331 mentioned above, a second sliding sleeve 327, an engaging block 750, and a fourth reset member 333. As shown in FIG. 55 and FIG. 56, both the first sliding sleeve 323 and the second sliding sleeve 327 are slidably arranged on the handle vertical frame 321, and the second sliding sleeve 327 is located on a side of the first sliding sleeve 323 close to the handle transverse frame 322.

As shown in FIG. 53 and FIG. 55, the linkage member 331 is slidably arranged on the auxiliary frame 330. Specifically, the linkage member 331 may include a linkage member sliding portion 3312 and a linkage member protrusion 3311 connected to each other and arranged at an angle. In other words, the linkage member protrusion 3311 protrudes from a side end face of the linkage member sliding portion 3312. In this embodiment, the linkage member sliding portion 3312 and the linkage member protrusion 3311 are perpendicular to each other. That is, the angle between the linkage member sliding portion 3312 and the linkage member protrusion 3311 is 90 degrees. Certainly, in other embodiments, the angle between the linkage member sliding portion 3312 and the linkage member protrusion 3311 may alternatively be greater than 90 degrees or less than 90 degrees. In this embodiment, the linkage member 331 has an integrally formed structure. Certainly, in other embodiments, the linkage member 331 may alternatively be formed by connecting the linkage member sliding portion 3312 and the linkage member protrusion 3311 in a manner such as welding or riveting.

As shown in FIG. 53 and FIG. 55, the auxiliary frame 330 is provided with a sliding groove 336 extending along a length direction thereof, and the linkage member sliding portion 3312 is at least partially located in the sliding groove 336 and can slide along the sliding groove 336. A locking groove 740 is formed at a junction of the auxiliary frame 330 and the linkage frame 380, and the linkage member sliding portion 3312 can move along the sliding groove 336 to be inserted into the locking groove 740, so as to realize locking and fixing of the auxiliary frame 330 and the linkage frame 380. As shown in FIG. 53 and described above, the fourth reset member 333 is arranged in the auxiliary frame 330, with two ends respectively abutting against an abutment portion 337 and the linkage member 331 in the auxiliary frame 330, and the fourth reset member 333 constantly keeps the linkage member 331 moving in a direction close to the locking groove 740.

Further, as shown in FIG. 56 and FIG. 57, the first sliding sleeve 323 abuts against a side of the linkage member protrusion 3311 away from the handle transverse frame 322. When the first sliding sleeve 323 moves in a direction F3 along the handle vertical frame 321, that is, moves in a direction close to the handle transverse frame 322, the first sliding sleeve 323 can drive the linkage member protrusion 3311 to move in the direction F3 together, that is, drive the linkage member 331 to move in the direction F3.

Referring to FIG. 55 again, the vehicle frame 300 may further include a pivot shaft (not shown in the figure), and the pivot shaft has an end fastened to the auxiliary frame 330 and another end pivotally connected to the armrest connector 371. The engaging block 750 is fastened to a side of the auxiliary frame 330 facing the armrest connector 371. In this embodiment, the engaging block 750 is arranged apart from the pivot shaft, or the engaging block 750 is connected to the pivot shaft, or an end of the pivot shaft passes through the auxiliary frame 330 to form the engaging block 750. In addition, the second sliding sleeve 327 has an engaging groove 3271, and the engaging block 750 located on the auxiliary frame 330 may be engaged with the engaging groove 3271, so that the armrest connector 371 is locked and fixed relative to the auxiliary frame 330 and the handle vertical frame 321. Referring to FIG. 56 and FIG. 57 together, the handle vertical frame 321 is further provided with a limiting boss 329. The limiting boss 329 protrudes in a direction close to the auxiliary frame 330, a limiting stopping sheet 751 is arranged below the engaging block 750, and the limiting boss 329 can abut against the limiting stopping sheet 751 to limit a pivot direction of the handle vertical frame 321 (or the handle frame 320). In this embodiment, the limiting boss 329 can abut against the limiting stopping sheet 751 to prevent pivoting of the handle vertical frame 321 (or the handle frame 320) in a direction opposite to the direction F1 (see FIG. 52).

Specifically, as shown in FIG. 56, in addition to being operatively connected to the first sliding sleeve 323, the handle operating member 324 described above is also operatively connected to the second sliding sleeve 327, and thus can pull the first sliding sleeve 323 and the second sliding sleeve 327 to slide away from the handle pivot axis 325 (i.e., slide upward) through the third traction member 326.

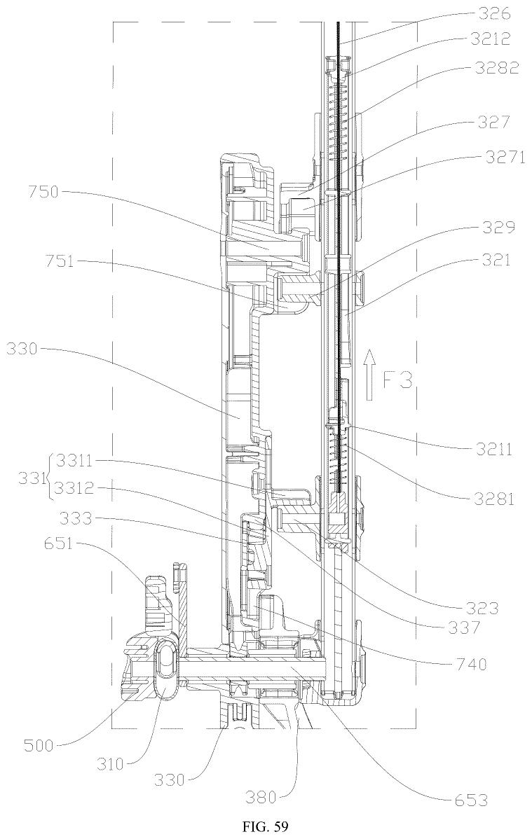

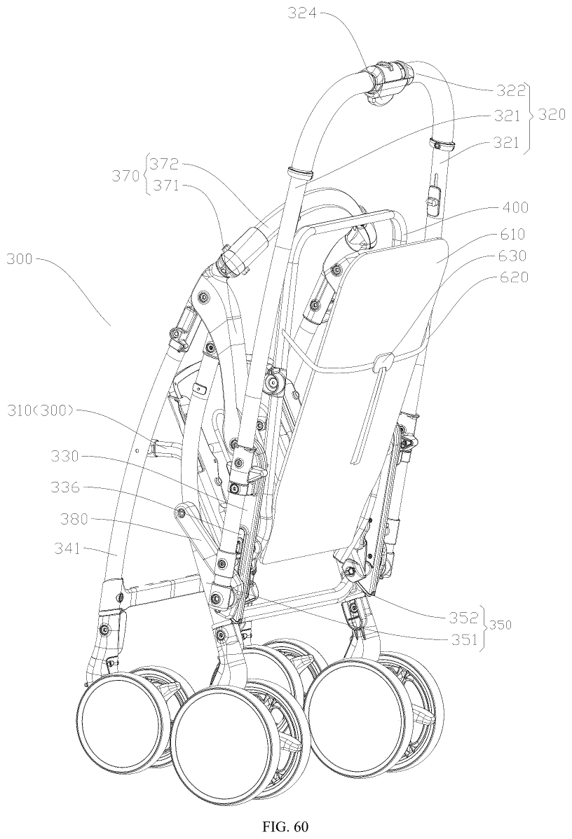

As shown in FIG. 59, when the third traction member 326 is pulled, the first sliding sleeve 323 may push the linkage member 331 to also move along the direction F3 to cause the linkage member 331 to be disengaged from the locking groove 740, and the second sliding sleeve 327 moves along the direction F3 to cause the engaging block 750 to be disengaged from the engaging groove 3271, thereby releasing the locking between the auxiliary frame 330 and the linkage frame 380 and releasing the locking between the armrest connector 371 and the auxiliary frame 330, so that the vehicle frame 300 is unlocked as a whole. In this case, the handle vertical frame 321 is pushed in a direction close to the seat body 660, and the vehicle frame 300 can be folded as a whole, as shown in FIG. 60.

Further, taking the handle operating member 324 of one handle vertical frame 321 as an example, as shown in FIG. 56 to FIG. 59, the handle vertical frame 321 is provided with a first sliding sleeve reset member 3281 and a second sliding sleeve reset member 3282. A first pushing portion 3211 and a second pushing portion 3212 are fixedly arranged in the handle vertical frame 321, and the second pushing portion 3212 is located on a side of the first pushing portion 3211 close to the handle transverse frame 322. Two ends of the first sliding sleeve reset member 3281 respectively abut against the first pushing portion 3211 and the first sliding sleeve 323 to constantly cause the first sliding sleeve 323 to move in a direction opposite to F3, that is, a direction away from the handle transverse frame 322.

Two ends of the second sliding sleeve reset member 3282 respectively abut against the second pushing portion 3212 and the second sliding sleeve 327 to constantly cause the second sliding sleeve 327 to move in the direction opposite to F3, that is, a direction away from the armrest body 372. In this way, when the handle operating member 324 is no longer pressed and the vehicle frame 300 is unfolded to the unfolded state, the first sliding sleeve 323 and the second sliding sleeve 327 may be reset under the action of the first sliding sleeve reset member 3281 and the second sliding sleeve reset member 3282 respectively, so that the linkage member 331 is engaged with the locking groove 740 again under the action of the fourth reset part 333, the engaging block 750 is engaged with the engaging groove 3271 again, and the child carrier 1 is locked in the unfolded state.

Further, the first front leg support rod 341 and the second front leg support rod 342 may also be correspondingly provided with similar engaging blocks 750 respectively, so that the child carrier 1 can be engaged with the engaging groove 3271 on the second sliding sleeve 327 when in reverse use.

The folding process of the above child carrier is specifically described in detail below by taking a structure on a side of the seat body 660 of the child carrier as an example.

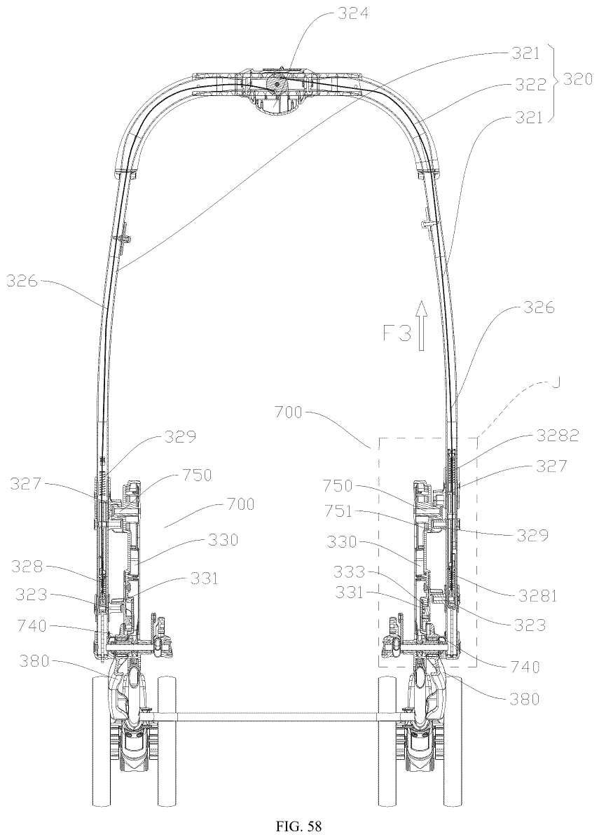

When the child carrier is required to be folded, as shown in FIG. 56 and FIG. 57, the handle operating part 324 is pressed first, and the handle operating part 324 drives both the first sliding sleeve 323 and the second sliding sleeve 327 to move in the direction F3 through the third traction member 326, so that the first sliding sleeve 323 pushes the linkage member 331 to move in the direction F3 until disengagement from the locking groove 740, and the second sliding sleeve 327 moves along the direction F3 until the engaging block 750 is disengaged from the engaging groove 3271, as shown in FIG. 58 and FIG. 59. In this way, the locking between the auxiliary frame 330 and the linkage frame 380 is released, and the locking between the armrest connector 371 and the auxiliary frame 330 is released, so that the vehicle frame 300 is unlocked as a whole. In this case, the handle frame 320 moves in a direction close to the seat tube 310, and drives, through the auxiliary frame 330 and the linkage frame 380, the armrest connector 371, the first front leg support rod 341, and the first rear leg support rod 351 to also move in the direction close to the seat tube 310.

Meanwhile, the handle vertical frame 321 also drives the first connecting rod 651 to rotate in the direction F1 and links the second connecting rod 652, thereby pushing the seat frame 200 to move in the direction F2 (see FIG. 52). Then, during the folding of the vehicle frame 300, the clamping portion 230 on the seat frame 200 no longer abuts against the movable end 413 (see FIG. 46), and the movable end 413 may drive, under continuous pushing of the bulge 530, the back frame vertical portion 410 (or the back frame 400) to approach the handle frame 320. When the child carrier 1 is in the folded state, the limiting block 500 abuts against the movable end 413 with the second end face 520, as shown in FIG. 47 and FIG. 49. In this way, the back frame vertical portion 410 (or the back frame 400) can be folded with the linkage of the vehicle frame 300. A folding process of a structure on the other side of the seat body 660 of the child carrier 1 is basically the same as the above process, and thus is not described in detail again.

The child carrier 1 in this embodiment has at least the following technical effects.

In the above child carrier 1, the back frame 400 is pivotally connected to the seat frame 200, the seat frame 200 is arranged on the vehicle frame 300 and may move relative to the limiting block 500, and the limiting block 500 is fastened to the vehicle frame 300. The movable end 413 is located between the seat frame 200 and the limiting block 500 to cause the movable end 413 to be limited and fixed when the vehicle frame 300 is in the unfolded state, so that the back frame 400 is limited to a certain inclination angle, thereby preventing a potential safety hazard caused by forward leaning of the back frame 400 due to failure of fixed limiting. During the switching of the vehicle frame 300 from the unfolded state to the folded state, the limiting block 500 may also drive the movable end 413 to collapse together with the vehicle frame 300, thereby realizing a function of folding the back frame 400 together with the vehicle frame 300. When the vehicle frame 300 is in the folded state, the limiting block 500 may continuously push against the movable end 413, thereby limiting a rotation angle of the back frame 400, which can prevent interference of the back frame 400 with the armrest frame 370.

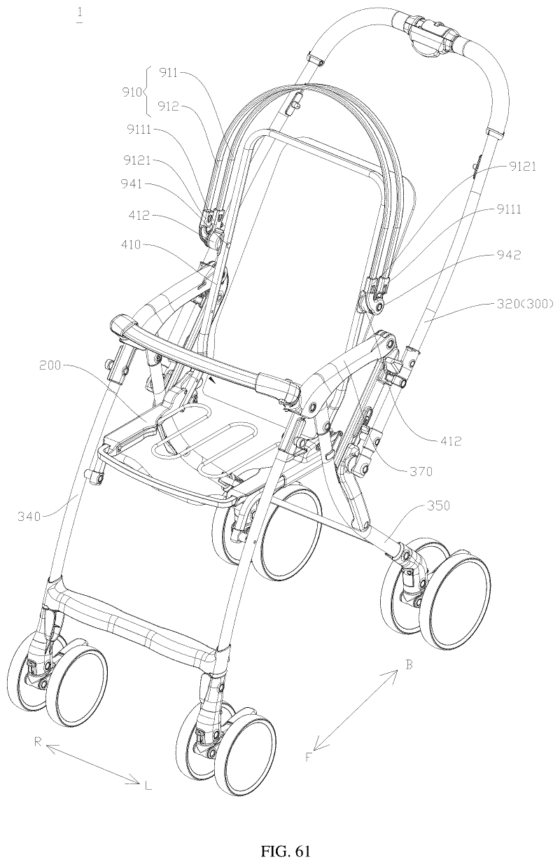

As shown in FIG. 61, in yet another embodiment, the child carrier 1 further includes a canopy 910 and a canopy mounting structure. Certainly, a type of the child carrier 1 using the canopy mounting structure is not limited to strollers. In other embodiments, the child carrier 1 may be, for example, a child safety seat, a children tricycle, a crib, a game bed, a sleeping box, or the like.

Referring to FIG. 61, in some embodiments, the back frame 400 may serve as a carrier. The carrier is, for example, a U-shaped tube, and tube bodies on left and right sides of the carrier both have mounting seats 412, and the mounting seats 412 are configured to mount the canopy 910. In this embodiment, the vehicle frame 300 is foldable, so that the child carrier 1 has a smaller volume when not in use. In some alternative embodiments, the vehicle frame 300 is not foldable.

Referring to FIG. 61, the canopy 910 is mounted on the carrier, and a structure of the canopy 910 is roughly symmetrical from left to right. In some embodiments, the canopy 910 includes, for example, a main canopy frame 911, one or more auxiliary canopy frames 912, and awning cloth (not shown in the figure). The main canopy frame 911 and the auxiliary canopy frames 912 all have, for example, a U-shaped structure. The U-shaped structure may be made from, for example, a solid rib or a hollow tube. The U-shaped structure may include arm segments on left and right sides and arc-shaped segments connected to upper ends of the arm segments on the left and right sides, and lower ends of the arm segments on the left and right sides form two end portions of the U-shaped structure.

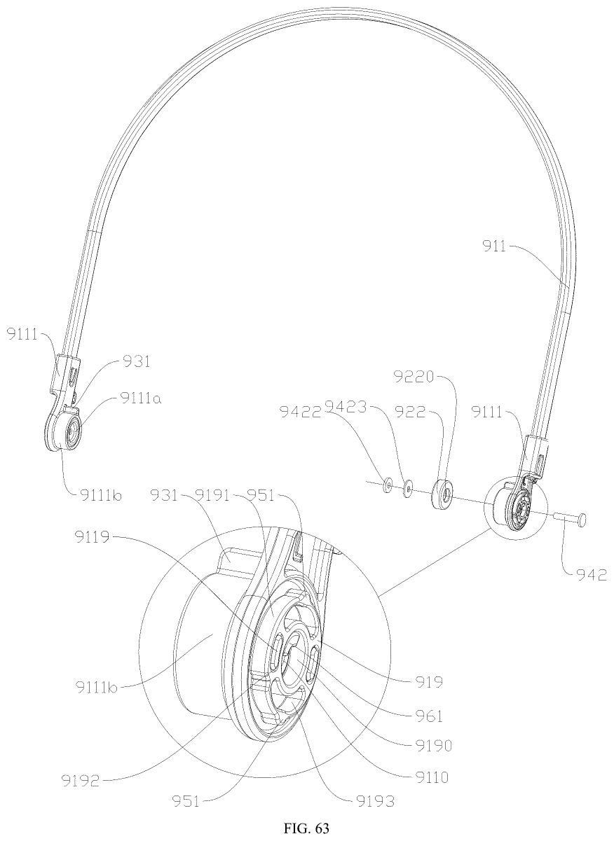

Referring to FIG. 61 and FIG. 63, the main canopy frame 911 is provided with connecting seats 9111 at two ends respectively, and each connecting seat 9111 is detachably connected to the corresponding mounting seat 412 on the carrier by magnetic attachment, so as to mount the canopy 910 on the carrier. In some embodiments, when the canopy 910 is mounted on the carrier, each mounting seat 412 is located on a side of the corresponding connecting seat 9111, for example, an inner side. It is to be noted that the connecting seat 9111 is arranged on, but not limited to, two end portions of the main canopy frame 911, and the connecting seat 9111 may be arranged at other suitable positions of the main canopy frame 911 as required. For example, in some alternative embodiment, the connecting seats 9111 may be arranged in the middle of the arm segments on the two sides of the main canopy frame 911.

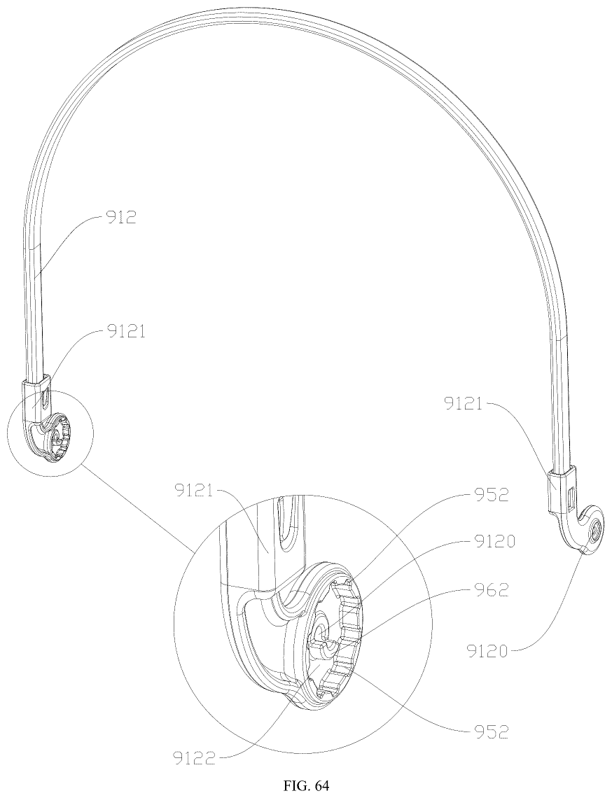

Referring to FIG. 61 and FIG. 64, each auxiliary canopy frame 912 is provided with pivot seats 9121 at two ends respectively, each pivot seat 9121 is pivotally connected to the connecting seat 9111 of the main canopy frame 911, and each pivot seat 9121 is located on, for example, the other side of the corresponding connecting seat 9111, such as an outer side. The awning cloth covers the main canopy frame 911 and each auxiliary canopy frame 912. By unfolding or folding the one or more auxiliary canopy frames 912, the awning cloth can be unfolded or collapsed. It is to be noted that the pivot seat 9121 is arranged on, but not limited to, two end portions of the auxiliary canopy frame 912, and the pivot seat 9121 may be arranged at other suitable positions of the auxiliary canopy frame 912 as required. For example, in some alternative embodiment, the pivot seats 9121 may be arranged in the middle of the arm segments on the two sides of the auxiliary canopy frame 912.

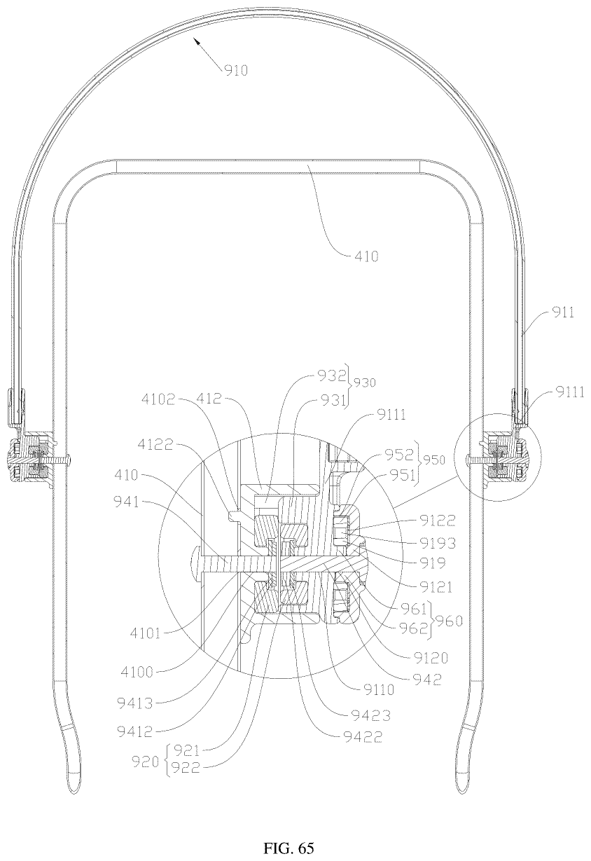

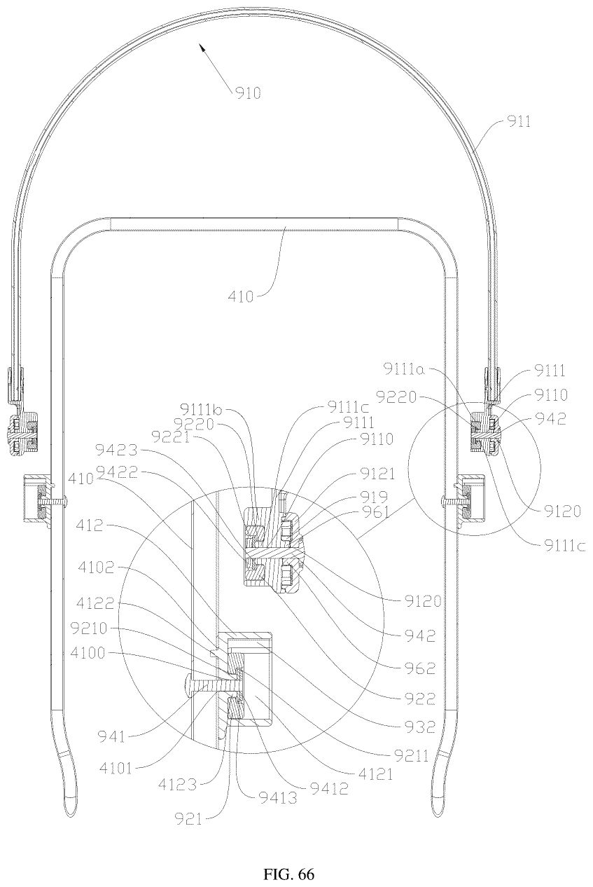

The canopy mounting structure according to the embodiments of the present disclosure includes the mounting seat 412 and the connecting seat 9111 detachably connected by magnetic attachment. Referring to FIG. 65, when the connecting seat 9111 of the main canopy frame 911 and the mounting seat 412 of the carrier are magnetically adsorbed together, the canopy 910 is in a mounted state. Referring to FIG. 65 and FIG. 66, a disassembly direction of the connecting seat 9111 and the mounting seat 412 is a left-right direction (also called a transverse direction). Referring to FIG. 66, when the canopy 910 is required to be removed, two ends of the main canopy frame 911 are opened outwards along the left-right direction, and the connecting seats 9111 located at the two ends of the main canopy frame 911 can overcome a magnetic attachment force and move outwards in the left-right direction until they are disengaged from the corresponding mounting seats 412. Then, the main canopy frame 911 can be easily removed, and the canopy 910 is in a disassembled state. When the canopy 910 is required to be mounted again, the two ends of the main canopy frame 911 are opened again, the connecting seats 9111 located at the two ends of the main canopy frame 911 are aligned with the corresponding mounting seats 412 in the left-right direction, an opening force applied to the two ends of the main canopy frame 911 is then released, the connecting seats 9111 at the two ends of the main canopy frame 911 automatically move toward each other in the left-right direction until they are butted with the corresponding mounting seats 412 and remain engaged with the corresponding mounting seats 412 under the action of the magnetic attachment force, and the canopy 910 returns to the mounted state.

It is to be noted that, in some alternative embodiments, the disassembly direction of the connecting seat 9111 of the main canopy frame 911 and the mounting seat 412 of the carrier may be an up-down direction. More specifically, when the connecting seat 9111 is required to be mounted on the mounting seat 412, there is no need to open the two ends of the main canopy frame 911, and the connecting seat 9111 may directly move from top to bottom to a position engaged with the mounting seat 412, and remain engaged with the mounting seat 412 under the action of the magnetic attachment force. When the connecting seat 9111 is required to be removed from the mounting seat 412, there is no need to open the two ends of the main canopy frame 911, but upward thrust is directly applied to the connecting seat 9111. The thrust overcomes the magnetic attachment force between the connecting seat 9111 and the mounting seat 412, and pushes the connecting seat 9111 to move from bottom to top until it is separated from the mounting seat 412. It is to be noted that the above up-down direction is not limited to a vertical direction perpendicular to the ground, which may be inclined relative to the ground.

It is to be noted that, unless otherwise clearly specified and limited, orientation terms such as “front”, “rear”, “left”, and “right” in the embodiments of the present disclosure refer to “front”, “rear”, “left”, and “right” orientations of the child riding in the child carrier.

Moreover, in the figure, arrows F and B are used to schematically show “front” and “rear” directions, and arrows L and R are used to schematically show “left” and “right” directions. These orientation terms are intended only to make the description of the embodiments of the present disclosure clearer, and are not intended to improperly limit the protection scope of the present disclosure.

In the canopy mounting structure according to the embodiments of the present disclosure, the connecting seat 9111 of the main canopy frame 911 and the mounting seat 412 of the carrier are detachably connected by magnetic attachment, so that the canopy 910 can be easily and quickly mounted on or removed from the carrier, which brings great convenience to cleaning and replacement of the canopy 910.

Referring to FIG. 63, FIG. 64, and FIG. 66, in some embodiments, in order to facilitate alignment and mounting of each connecting seat 9111 and the corresponding mounting seat 412, the mounting seat 412 includes, for example, a first positioning portion 4121, the connecting seat 9111 includes, for example, a second position portion 9111b, and the connecting seat 9111 is joined to the first positioning portion 4121 of the mounting seat 412 through the second position portion 9111b. In the embodiment shown in FIG. 66, the first positioning portion 4121 is a recess, the second position portion 9111b is a lug, and the recess is engaged with the lug. Certainly, in some alternative embodiments, the first positioning portion 4121 may be, for example, a lug, and the second position portion 9111b may be, for example, a recess.

Still referring to FIG. 66, the disassembly direction of the connecting seat 9111 of the main canopy frame 911 and the mounting seat 412 of the carrier is the left-right direction, and thus both the recess and the lug extend along the left-right direction. In some embodiments, the main canopy frame 911 may pivot relative to the carrier in a front-rear direction. In this case, the recess may be a circular recess, the lug may be a circular boss, the circular boss is pivotally connected to the circular recess, and the circular boss forms a pivot shaft of the main canopy frame 911. It may be understood that, in some alternative embodiments, if the disassembly direction of the connecting seat 9111 and the mounting seat 412 is the up-down direction, both the recess and the lug extend along the up-down direction.

Referring to FIG. 64 to FIG. 66, in some embodiments, the recess serving as the first positioning portion 4121 is a circular recess, the lug serving as the second positioning portion 9111b is a circular boss, and a rotation limiting structure 930 is arranged between the recess and the lug to cause the mounting seat 412 and the connecting seat 9111 to be connected without relative rotation, so that the main canopy frame 911 cannot pivot relative to the carrier in the up-down direction.

In the embodiment shown in FIG. 65, the rotation limiting structure 930 includes a guide rib 931 and a guide groove 932, the guide rib 931 is arranged on an outer peripheral wall of the circular boss, and the guide groove 932 is arranged on an inner peripheral wall of the circular recess. Both the guide rib 931 and the guide groove 932 extend in the left-right direction and can fit each other. The rotation limiting structure 930 has a relatively simple structure. Certainly, in some alternative embodiments, positions of the guide rib 931 and the guide groove 932 can be interchanged. That is, the guide rib 931 may protrude from the inner peripheral wall of the circular recess, and the guide groove 932 may be arranged on the outer peripheral wall of the circular boss.

It may be understood that implementations of the rotation limiting structure 930 are not limited to the above examples, provided that relative rotation between the mounting seat 412 and the connecting seat 9111 can be limited. For example, in some alternative embodiments, the recess serving as the first positioning portion 4121 and the lug serving as the second positioning portion 9111b may be non-circular, and a surface where the recess and the lug fit each other may include, for example, a section.

FIG. 65 and FIG. 66 show an exemplary implementation for realizing magnetic attachment between the connecting seat 9111 and the mounting seat 412. The canopy mounting structure may be provided with a magnetic device 920. The magnetic device 920 includes, for example, a first magnetic member 921 and a second magnetic member 922. The first magnetic member 921 may be fastened to the mounting seat 412, more specifically to the first positioning portion 4121. The second magnetic member 922 may be fastened to the connecting seat 9111, more specifically to the second positioning portion 9111b. At least one of the first magnetic member 921 and the second magnetic member 922 may be a magnet, and the other may be a magnet with opposite polarity or may be made of any material capable of being adsorbed by a magnet. When the first positioning portion 4121 and the second positioning portion 9111b are joined, the first magnetic member 921 and the second magnetic member 922 are attached to each other, and the first positioning portion 4121 and the second positioning portion 9111b remain joined, so that the canopy 910 is stably kept in the mounted state. Certainly, in some embodiments, the above magnetic device 920 may not be provided, the connecting seat 9111 and the mounting seat 412 may be made of a magnetic material, and the second positioning portion 9111b and the first positioning portion 4121 are attached to each other while being joined.

The first magnetic member 921 and the second magnetic member 922 may have any suitable shape and size, and may be fastened to the mounting seat 412 and the connecting seat 9111 in any suitable manner. For example, in some unshown embodiments, the first magnetic member 921 and the mounting seat 412 are joined together by overmolding, and the second magnetic member 922 and the connecting seat 9111 are joined together by overmolding. In some unshown embodiments, the first magnetic member 921 and the mounting seat 412 are attached together by gluing, and the second magnetic member 922 and the connecting seat 9111 are attached together by gluing.

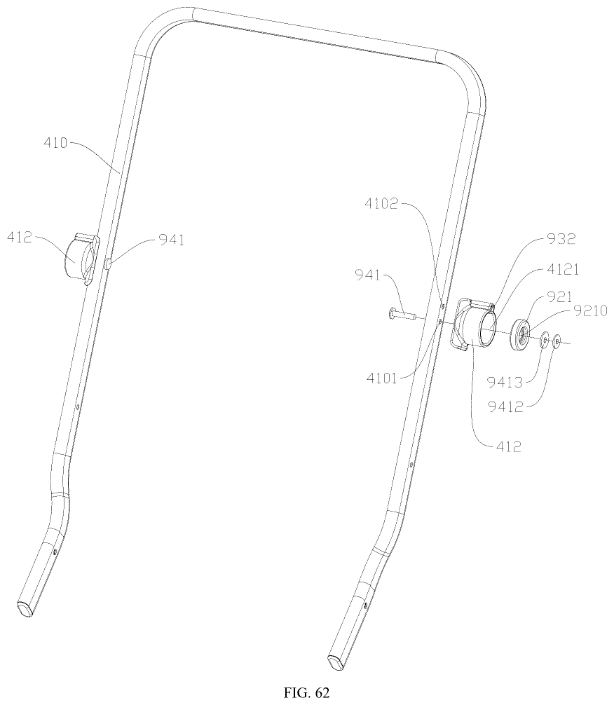

Referring to FIG. 62, FIG. 63, FIG. 65, and FIG. 66, an exemplary attachment manner of the first magnetic member 921 and the mounting seat 412 and an exemplary attachment manner of the second magnetic member 922 and the connecting seat 9111 are shown.

Specifically, referring to FIG. 62 and FIG. 66, the first magnetic member 921 is, for example, an annular structure and is sleeved on the recess serving as the first positioning portion 4121. The mounting seat 412 has a central hole 4100 communicated with the recess, and the carrier has a mounting hole 4101. A first fastener 941 is mounted in the mounting hole 4101, the central hole 4100, and the central hole 9210 of the first magnetic member 921, and the first fastener 941 fixes the mounting seat 412 to the carrier, and at the same time fixes the first magnetic member 921 in the recess. In some embodiments, the first fastener 941 may be a bolt, an end of the bolt close to the first magnetic member 921 is connected to a retaining ring 9413 and a nut 9412, and the retaining ring 9413 limits an axial position of the first magnetic member 921. In addition, an end portion of the first magnetic member 921 may be provided with a first concave portion 9211, and the first concave portion 9211 is configured to accommodate the retaining ring 9413 and the nut 9412, preventing protrusion of the nut 9412 relative to the first magnetic member 921, which helps to reduce an axial dimension. Certainly, the first fastener 941 is not limited to the bolt. In some alternative embodiments, the first fastener 941 may be, for example, a rivet.

Referring to FIG. 66, in some embodiments, a bottom wall of the recess serving as the first positioning portion 4121 is provided with a first annular protrusion 4123, and an inner hole of the first annular protrusion 4123 is part of the central bore 4100. The first magnetic member 921 is sleeved on the first annular protrusion 4123 through the central hole 9210 thereof to be indirectly mounted on the first fastener 941. In addition, the retaining ring 9413 abuts against the first annular protrusion 4123 instead of directly abutting against the first magnetic member 921. Thus, during tightening of the first fastener 941, the first magnetic member 921 can be protected from external force.

Referring to FIG. 63 and FIG. 66, an end face of the lug serving as the second positioning portion 9111b is provided with an accommodating cavity 9111a. The second magnetic member 922 has, for example, an annular structure and is nested in the accommodating cavity 9111a, so that the second magnetic member 922 does not protrude relative to the end face of the lug, which helps to reduce the axial dimension. In addition, the second magnetic member 922 does not protrude relative to the end face of the lug, which helps to form a certain gap between the first magnetic member 921 and the second magnetic member 922. During magnetic fit of the first magnetic member 921 and the second magnetic member 922, the gap can prevent a large collision impact due to direct abutment of the second magnetic member 922 against the first magnetic member 921, thereby helping to prolong an overall service life of the magnetic device 920.

Referring to FIG. 66, the connecting seat 9111 has a through hole 9110, and the through hole 9110 is located in the center of the lug. The pivot seat 9121 of the auxiliary canopy frame 912 has a through hole 9120. A second fastener 942 is mounted in the through hole 9120, the through hole 9110, and the central hole 9220 of the second magnetic member 922. The pivot seat 9121 is pivotally connected to the connecting seat 9111 through the second fastener 942. The second magnetic member 922 is fastened to the lug through the second fastener 942. In some embodiments, the second fastener 942 may be a bolt, an end of the bolt close to the second magnetic member 922 is connected to a retaining ring 9423 and a nut 9422, and the retaining ring 9423 limits an axial position of the second magnetic member 922. In addition, an end portion of the second magnetic member 922 may be provided with a second concave portion 9221, and the second concave portion 9221 is configured to accommodate the retaining ring 9423 and the nut 9422, preventing protrusion of the nut 9422 relative to the second magnetic member 922, which helps to reduce the axial dimension. Certainly, the second fastener 942 is not limited to the bolt. In some alternative embodiments, the second fastener 942 may be, for example, a rivet.

Referring to FIG. 66, in some embodiments, a bottom wall of the accommodating cavity 9111a is provided with a second annular protrusion 9111c, and an inner hole of the second annular protrusion 9111c is part of the through hole 9110. The second magnetic member 922 is sleeved on the second annular protrusion 9111c through the central hole 9220 thereof to be indirectly mounted on the second fastener 942. In addition, the retaining ring 9423 abuts against the second annular protrusion 9111c instead of directly abutting against the second magnetic member 922. Thus, during tightening of the second fastener 942, the second magnetic member 922 can be protected from external force.

Referring to FIG. 62, FIG. 65, and FIG. 66, in some embodiments, the carrier is further provided with a positioning hole 4102, and the positioning hole 4102 is parallel to a mounting hole 4101. The mounting seat 412 is provided with a cam follower 4122, and the cam follower 4122 is inserted into the positioning hole 4102, which can prevent rotation of the mounting seat 412 around the first fastener 941.

Referring to FIG. 65, in some embodiments, a pivot adjustment structure 950 may be arranged between the connecting seat 9111 and the pivot seat 9121. The pivot adjustment structure 950 is configured to adjust a relative position between the main canopy frame 911 and the auxiliary canopy frame 912, so that the canopy 910 can have various states of use, such as a folded state, a half-open state, a fully-open state, and the like.

FIG. 63 and FIG. 64 show an exemplary implementation of the pivot adjustment structure 950. The pivot seat 9121 is provided with an annular groove 9122, the connecting seat 9111 is provided with an annular wall 9191, and a side wall of the annular groove 9122 is opposite to the annular wall 9191. The pivot adjustment structure 950 includes one or more slots 952 and one or more protrusions 951. The one or more slots 952 are arranged on the side wall of the annular groove 9122, and the one or more protrusions 951 are arranged on the annular wall 9191. The one or more slots 952 are selectively engaged with the one or more protrusions 951, to allow lock and adjust the relative position between the main canopy frame 911 and the auxiliary canopy frame 912.

It may be understood that a contact surface between the slot 952 and the protrusion 951 may be a slope, and an engagement depth of the two may be designed as required, so as to apply a moderate circumferential force to the main canopy frame 911 and/or the auxiliary canopy frame 912 when the relative position between the main canopy frame 911 and the auxiliary canopy frame 912 is required to be adjusted. That is, a position of engagement between the protrusion 951 and the slot 952 may be changed, thereby changing the relative position between the main canopy frame 911 and the auxiliary canopy frame 912. In addition, numbers of the protrusion 951 and the slot 952 may be the same or different, and the numbers of the protrusion 951 and the slot 952 may both be two or more. When a plurality of protrusions 951 and a plurality of slots 952 are provided, the plurality of protrusions 951 and the plurality of slots 952 are evenly distributed in a circumferential direction.

It may be understood that implementations of the pivot adjustment structure 950 are not limited to the above examples. For example, one or more slots 952 may be arranged on the annular wall 9191, and one or more protrusions 951 may be arranged on the side wall of the annular groove 9122. In addition, in some alternative embodiments, positions of the annular groove 9122 and the annular wall 9191 on the pivot seat 9121 and the connecting seat 9111 may be interchanged.

Referring to FIG. 63, in some embodiments, the annular wall 9191 is arranged on a lock ring 919 detachably joined to the connecting seat 9111, and the annular wall 9191 is, for example, an outer peripheral wall of the lock ring 919. The lock ring 919 is connected to the connecting seat 9111 without relative rotation therebetween. For example, the lock ring 919 may be provided with one or more holes 9192, the connecting seat 9111 has one or more stoppers 9119, and the holes 9192 are joined to the stoppers 9119, so that the lock ring 919 and the connecting seat 9111 cannot rotate relative to each other. In some embodiments, the lock ring 919 may also be provided with a plurality of lightening holes 9193. The annular wall 9191 is arranged on the lock ring 919, which helps to reduce machining difficulty of the connecting seat 9111. Certainly, in some alternative embodiments, the above annular wall 9191 may be integrally formed with the connecting seat 9111.

Referring to FIG. 65, in some embodiments, a swing limiting structure 960 may be arranged between the connecting seat 9111 and the pivot seat 9121. The swing limiting structure 960 is configured to limit a pivot angle between the main canopy frame 911 and the auxiliary canopy frame 912, preventing damages to the awning cloth caused by excessive unfolding or excessive folding of the auxiliary canopy frame 912.

FIG. 63 and FIG. 64 show an exemplary implementation of the swing limiting structure 960. The swing limiting structure 960 includes a first arc-shaped block 961 and a second arc-shaped block 962. The first arc-shaped block 961 is arranged on the connecting seat 9111, and the second arc-shaped block 962 is arranged on the pivot seat 9121. A sum of an angle formed by two end portions of the first arc-shaped block 961 and an angle formed by two end portions of the second arc-shaped block 962 is less than 360°. When the auxiliary canopy frame 912 rotates relative to the main canopy frame 911, the two end portions of the first arc-shaped block 961 selectively abut against the two end portions of the second arc-shaped block 962, limiting maximum angles of forward pivoting and rearward pivoting of the auxiliary canopy frame 912.

As can be seen from FIG. 63, FIG. 64, and FIG. 66, in some embodiments, the first arc-shaped block 961 is integrally formed with the connecting seat 9111, the second arc-shaped block 962 is integrally formed with the pivot seat 9121, and both the first arc-shaped block 961 and the second arc-shaped block 962 are sandwiched between a hole wall of the central hole 9190 of the lock ring 919 and the second fastener 942 in a radial direction. This design helps to improve structural compactness and structural strength, and helps to reduce an axial dimension of the connecting seat 9111 and the pivot seat 9121 after assembly.

In the above embodiments, the description is based on an example in which the child carrier 1 is a stroller, and the back frame 400 of the stroller serves as a carrier provided with a mounting seat 412. It may be understood that the component serving as the carrier is not limited to the back frame 400. For example, in some embodiments, the handle frame 320 of the vehicle frame 300 may serve as the carrier. In addition, when the type of the child carrier 1 changes, the component serving as the carrier may change accordingly, and a manner in which the mounting seat 412 and the carrier are connected may also be changed adaptively. For example, when the child carrier 1 is a child safety seat, the seat body 660 of the child safety seat may serve as the carrier. In this case, the two mounting seats 412 are fastened to back surfaces on two sides of the child safety seat respectively by, for example, screwing. In addition, the structure of the canopy 190 is not limited to the above example. For example, in some alternative embodiments, the canopy 190 may not be provided with the auxiliary canopy frame 912.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A limiting device for operably limiting an angle of rotation of a first object relative to a second object, the limiting device comprising:
a housing arranged between the first object and the second object and comprising at least one limiting groove; and
a limiting member arranged between the first object and the second object and capable of moving, through the at least one limiting groove, between a limit position and a non-limit position relative to the housing,
wherein when the limiting member is at the limit position, the limiting member is capable of preventing the first object from rotating relative to the second object in a first rotation direction, and allowing the first object to rotate relative to the second object in a second rotation direction opposite to the first rotation direction.

2. The limiting device according to claim 1, wherein an actuating device is further arranged between the first object and the second object, and the limiting device further comprises:
a first reset member configured to bias the limiting member toward the limit position,
wherein the limiting member is drivably connected to the actuating device, and the actuating device is operable to actuate the limiting member to the non-limit position.

3. The limiting device according to claim 2, wherein the limiting device further comprises:
a first traction member having an end connected to the limiting member and another end connected to the actuating device,
wherein the actuating device is operable to actuate the limiting member to the non-limit position through the first traction member.

4. The limiting device according to claim 1, wherein the limiting device further comprises:
an engaging pin arranged on the first object, the engaging pin being pivotable with the first object and lockable in the at least one limiting groove,
wherein the limiting member is arranged on a side of the at least one limiting groove, and the limiting member, when being at the limit position, is capable of preventing disengagement of the engaging pin from the at least one limiting groove.

5. The limiting device according to claim 4, wherein the housing is mounted to the second object and is pivotally connected to the first object,
on a side surface of the housing adjacent to the first object, a plurality of limiting grooves are continuously provided around a pivot axis of the first object along a pivot direction thereof,
the engaging pin has an end inserted into the plurality of limiting grooves from the side surface of the housing and another end inserted into the first object, and
the engaging pin is movable between a low position where the engaging pin is locked in one of the plurality of limiting grooves and a high position where the engaging pin is positioned beyond the one of the plurality of limiting grooves relative to the housing.

6. The limiting device according to claim 5, wherein each of the plurality of limiting grooves has an arc-shaped wall, and the arc-shaped walls of the plurality of limiting grooves are connected; and
wherein each of the arc-shaped walls has a rearward surface with a concave arc surface on a side away from the limiting member, and a forward surface with an inclined surface or a convex arc surface on another side facing the limiting member.

7. (canceled)

8. The limiting device according to claim 5, wherein the first object is in a shape of a hollow tube and has an elongated groove facing the limiting device, and comprises:
a slider arranged in the first object, the engaging pin being inserted in the slider and being drivable by the slider to move between the low position and the high position;
a second traction member having an end connected to the slider and another end connected to a back frame operating member arranged on the first object, the back frame operating member being operable to drive, through the second traction member and the slider, the engaging pin to move to the high position; and
a second reset member arranged in the first object and biasing the slider to drive the engaging pin to the low position.

9. The limiting device according to claim 1, wherein the housing comprises:
a first housing fastened to the first object and provided with the at least one limiting groove; and
a second housing fastened to the second object and arranged opposite to the first housing along a rotation axis, the first housing being rotatable around the rotation axis relative to the second housing,
wherein the limiting member is arranged in the second housing.

10. The limiting device according to claim 1, wherein an actuating device is further arranged between the first object and the second object, and the limiting device further comprises:
a driving member joined to the limiting member and capable of driving the limiting member to the limit position or the non-limit position; and
a first reset member biasing the driving member to actuate the limiting member to the limit position,
wherein the limiting member is drivably connected to the driving member, and the actuating device is operable to actuate the limiting member to the non-limit position through the driving member.

11. The limiting device according to claim 10, wherein the limiting device further comprises:
a first traction member, the actuating device being connected to the driving member through the first traction member.

12. The limiting device according to claim 10, wherein the driving member comprises a driving groove; and
wherein the limiting device further comprises a driving pin fastened to the limiting member and slidably inserted into the driving groove, and the limiting member is movable between the limit position and the non-limit position through the sliding of the driving pin.

13. The limiting device according to claim 9, wherein the limiting groove is formed radially inward from a circumferential side wall of the first housing and has a radially outward opening.

14. The limiting device according to claim 9, wherein the limiting member comprises:
a first limiting member end facing the first housing and having a limiting head forward surface inclined rearward relative to the first rotation direction; and
a second limiting member end opposite to the first limiting member end and away from the first housing.

15. The limiting device according to claim 9, wherein the limiting device further comprises:
a locking member arranged between the first housing and the second housing and movable between a lock position and an unlock position,
wherein the locking member prevents relative rotation between the first housing and the second housing when the locking member is at the lock position, and the locking member allows relative rotation between the first housing and the second housing when the locking member is at the unlock position.

16. The limiting device according to claim 15, wherein the first housing comprises a sliding groove formed on an inner side of the first housing and extending radially, and the locking member is located in the sliding groove and rotates around rotation axis together with the first housing.

17. (canceled)

18. The limiting device according to claim 15, wherein the second housing comprises:
a second disc portion;
a second shaft hole arranged in the second disc portion;
at least one first locking groove arranged on an inner side of a periphery of the second disc portion; and
at least one second locking groove located between the periphery of the second disc portion and the second shaft hole;
wherein the locking member comprises:
a first locking portion located at a first end of the locking member; and
a second locking portion located at a second end of the locking member, positions of the first end and the second end being different; and
wherein when the locking member is at the lock position, the first locking portion and the second locking portion are respectively engaged with the first locking groove and the second locking groove.

19-23. (canceled)

24. The limiting device according to claim 9, wherein the first housing further comprises:
a first disc portion formed in a shape of a disc with an axial end closed; and
a first rod portion extending from a periphery of the first disc portion and connected to the first object;
wherein the second housing comprises:
a second disc portion formed in a shape of a disc with an axial end closed; and
a second rod portion extending from a periphery of the second disc portion and connected to the second object; and
wherein the first disc portion and the second disc portion are rotatably fastened to each other around the rotation axis to form a cylindrical box-shaped structure with two closed axial ends.

25. The limiting device according to claim 9, wherein the first housing is provided with the limiting groove, and when the first object is at a first rotation position relative to the second object, the limiting groove is aligned with the limiting member, so as to allow the limiting member to extend into the limiting groove to enter the limit position and then be engaged with the first housing.

26-29. (canceled)

30. A child carrier, comprising:
a vehicle frame;
a seat frame arranged on the vehicle frame;
a back frame joined to a rear end of the seat frame; and
the limiting device according to claim 1, the limiting device being joined between the seat frame and the back frame, wherein the first object is the back frame, and the second object is the seat frame.

31-45. (canceled)

46. A child carrier, comprising:
a vehicle frame;
a limiting block fastened to the vehicle frame;
a seat frame arranged on the vehicle frame and movable relative to the limiting block; and
a back frame pivotally connected to the seat frame and having a movable end,
wherein the movable end is located between the seat frame and the limiting block, so that the movable end is limited and fixed when the vehicle frame is in an unfolded state.

47-81. (canceled)
